(19) United States
(12) Patent Application Publication
(10) Pub. No.: US 2002/0184515 A1
(43) Pub. Date: Dec. 5, 2002

(54) Rights management unit

(76) Inventors: Masahiro Oho, Neyagawa (JP); Ryuichi Okamoto, Moriguchi (JP); Masaya Yamamoto, Hirakata (JP); Yasushi Uesaka, Sanda (JP); Katsumi Tokuda, Mino (JP); Mitsuhiro Inoue, Osaka (JP)

Correspondence Address: WENDEROTH, LIND & PONACK, L.L.P., 2033 K STREET N. W., SUITE 800, WASHINGTON, DC, 20006-1021, US

(21) Appl. No.: 10/156,050

(22) Filed: May 29, 2002

(30) Foreign Application Priority Data
May 29, 2001 (JP) 2001-160290
Jul. 25, 2001 (JP) 2001-224413
Sep. 25, 2001 (JP) 2001-291593

(51) Int. Cl. H04L 9/32

(52) U.S. Cl. 713/193

(57) ABSTRACT

A device 201 of a licensee γ generates an issue request for a permission to use content data by using a media identifier in a portable recording medium 101 of a licensee β, and forwards the resulting issue request to a rights management unit 71. The rights management unit 71 is managing rights information of the content data provided to the licensee β, and based on the rights information together with the issue request, generates permission information to allow the portable recording medium 101 to use the content data. Based on the permission information, the rights management unit 71 then generates license information with which the use of the content data in the device connected to the portable recording medium 101 is controlled, and transmits the license information to the device 201. The device 201 then processes the license information to control the use of the content data. In such a manner, provided is a license information management system with which the licensee β can use the content data with his or her own rights information on the device belonging to the licensee γ.

### BACKGROUND OF THE INVENTION

1. Field of the Invention

The present invention relates to rights management units and, more specifically, to a rights management unit with which rights to use content data can be managed.

2. Description of the Background Art

In recent years, content distribution systems have been getting popular and familiar thanks to broadband networks and connection services available at all times. To make the content distribution systems widely available, rights protection to content data is a key issue. Therefore, various rights management technologies have been so far researched and developed. Herein, any rights to content data exemplified by copyrights or marketing rights are referred to as digital rights. In the below, described is a content information distribution system into which a conventional rights management technology is incorporated.

In a conventional content distribution system, a content distribution unit and a personal computer (hereinafter, simply referred to as PC) are connected to each other for data communications therebetween over a network typified by the Internet. The content distribution unit at least stores a set of content data, a content decryption key, and usage rule data. Here, the content data is digital data representing music contents, for example, and is encrypted using a predetermined scheme. The content decryption key is used for decrypting thus encrypted content data. The usage rule data represents rules for use of the content data (hereinafter, such rules are referred to as usage rules). The usage rules are typified by the number of uses of the content data. The PC stores a computer program (hereinafter, referred to simply as a program) for retrieving the content data from the content distribution unit for its use.

In such a content distribution system, the content data is distributed as below. First, the PC executes a program which is previously stored therein, and requests the content distribution unit to distribute thereto the content data. A request for the content data is made by the PC transmitting, generally, content specific information and terminal unique information to the content distribution unit over the network. Here, with the content specific information, the content data is uniquely specified. The terminal unique information is previously stored in the PC, and used to uniquely specify from which PC the request for the content data came.

In response to the request coming from the PC, the content distribution unit encrypts the content decryption key using the currently received terminal unique information. Then, the content distribution unit forwards, to the PC, the encrypted content data, the content decryption key encrypted by the terminal unique information, and the usage rule data. The PC accordingly receives the content data, the content decryption key, and the usage rule data coming from the content distribution unit, and stores those in its internal storage.

After storing those, the PC uses the encrypted content data to be ready to output a content represented thereby. For content output, the user first instructs the PC as such. In response to the instruction, the PC operates as below. First, the PC determines whether the current use is meeting the usage rules represented by the usage rule data in the storage. Only when the determination is Yes, the PC executes the following sequence of processes. That is, the PC uses its own terminal unique information to decrypt the content decryption key, which has been encrypted and stored in the storage. The PC then uses thus decrypted content decryption key to decrypt the content data, which has been also encrypted and stored in the storage. Thereafter, the PC reproduces and outputs a content represented by the content data.

In such a content distribution system, the digital rights are protected under DRM (Digital Rights Management), which is the rights management technology. Digital rights protection under DRM is realized by the following three technologies. Under a first protection technology, the content distribution unit transmits the encrypted content data, and the content decryption key encrypted by the terminal unique information. Here, the content decryption key is decryptable only by the PC from which the request for the content data is forwarded. Thus, even if the encrypted content data is erroneously transferred to any other PCs, those cannot decrypt the content decryption key, i.e., cannot reproduce the content data. As such, in DRM, the content decryption key has a one-to-one relationship with the PC, thereby protecting digital rights.

A second protection technology is a tamper-resistant technology. Specifically, such a tamper-resistant technology prevents analysis of decryption programs, which are needed for decryption. Thus the digital rights are protected.

A third protection technology is the one described in the above. That is, in the conventional content distribution system, the PC receives and manages the usage rule data provided by the content distribution unit, and checks the usage rules represented thereby for every use of the content data to see whether or not the use is meeting the usage rules. If not meeting, the PC does not execute the processes thereafter. In such a manner, the digital rights are protected.

In recent years, consumer-electronics products other than PCs, typified by set-top boxes, television receivers, music players, and game machines are so designed as to be network connectable. This enables the consumer-electronics products to receive the content data from the content distribution unit of the above type, consequently leading to data communications among a plurality of consumer-electronics products. This necessitates incorporating the rights management technology into the consumer-electronics products. However, incorporating DRM thereinto is not considered wise because the following problems may occur as a result.

First, the one-to-one relationship established between the PC and the content decryption key takes away the possibility for the user to decrypt the content data with his or her other consumer-electronics products because the decryption key is not applicable thereto but only to the user's one specific PC. In this sense, the conventional rights management technology is not user-friendly.

Second, the tamper-resistant technology utilized under DRM requires the PC to check the content data, before reproducing it, if it is allowed to be used based on the usage rule data in its storage. Such a tamper-resistant technology places a heavy load on the PC. The issue here is the capability of the hardware. The hardware of the PC is relatively high in performance so as to be generally applicable to video and audio reproduction, game play, and others. Therefore, DRM does not cause that much trouble as long as it is incorporated into the PC. On the other hand, the hardware of the consumer-electronics product is not so capable as that of the PC. This is because the consumer-electronics products are specialized in each different application, i.e., video reproduction, audio reproduction, game play. As such, the heavy load as a result of incorporating DRM is too much for the consumer-electronics products.

### SUMMARY OF THE INVENTION

Therefore, a first object of the present invention is to provide a rights management technology with which a plurality of consumer-electronics products can share the same digital rights.

Further, a second object of the present invention is to provide a rights management technology suiting to consumer-electronics products.

To achieve the above first and second objects, the present invention has the following first and second aspects.

A first aspect of the present invention is directed to a unit for managing rights information representing a right for a plurality of devices to use content data. The unit comprises: a rights database (hereinafter, rights DB) including the rights information each assigned to the plurality of devices; a rights management section operable to generate, in response to an issue request from any one of the plurality of devices, permission information which represents a permission for the device to use the content data, by using the rights information corresponding to the device in the rights DB; a license information generation section operable to generate license information which at least includes the permission information generated by the rights management section; and a communications section operable to transmit the license information generated by the license information generation section to the device from which the issue request is forwarded.

As described above, in the first aspect, the rights information is assigned to a plurality of devices. Therefore, successfully provided is a rights protection technology with which a plurality of devices can share the same rights information.

A second aspect of the present invention is directed to a device which receives license information from a rights management unit connected thereto over a transmission path. The device comprises: an interface operable to connect a portable recording medium for data communications, which stores a media identifier for unique identification; an identifier extraction section operable to extract the media identifier from the portable recording medium connected to the interface; an issue request generation section operable to generate, using the media identifier received from the identifier extraction section, an issue request needed to receive a permission to use content data; and a first communications section operable to transmit the issue request received from the issue request generation section to the rights management unit over the transmission path. Here, the rights management unit manages rights information of the content data provided to the portable recording medium, and in response to the issue request provided from the device, generates and transmits the license information to control the use of the content data in the device to which the portable recording medium is connected. Further, the device further comprises a license information processing section operable to process the license information from the rights management unit, and control the use of the content data.

As described above, in the second aspect, the identifier extraction section extracts the media identifier from the portable recording medium attached to the device. Also, the issue request generation section can generate the issue request using thus extracted media identifier. In this manner, the user of the portable recording medium can become able to use the content data, with his or her rights information, on the device belonging to another user.

These and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is block diagram showing the entire structure of a license information management system Sa including a rights management unit 11 according to a first embodiment of the present invention.

FIG. 2 is a block diagram showing the detailed structure of the rights management unit 11 of FIG. 1.

FIG. 3 is a block diagram showing the detailed structure of a license information generation section 121 of FIG. 2.

FIG. 4 is a block diagram showing the detailed structure of devices 21a and 21b of FIG. 1.

FIG. 5 is a block diagram showing the detailed structure of a license information processing section 217 of FIG. 4.

FIGS. 6A and 6B are schematic diagrams showing, respectively, a content DB 111 and a decryption key DB 112 of FIG. 2.

FIGS. 7A and 7B are schematic diagrams showing, respectively, a user information DB 113 and a rights DB 114 of FIG. 2.

FIG. 8 is a flowchart showing the operations of the device 21a and the rights management unit 11 at the time of right setting to the content data Dcnt, and acquisition thereof.

FIGS. 9A and 9B are schematic diagrams respectively showing, by format, a setting request Drr and transmission data Dtrn, both of which are transmitted and received during the processes of FIG. 8.

FIG. 10 is a schematic diagram showing data to be stored in a content storage 215 of FIG. 4.

FIG. 11 is a first flowchart showing the operations of the device 21a and the rights management unit 11 at the time of acquisition of license information Dlca, and decryption of the content data Dcnt.

FIG. 12 is a second flowchart showing the operations of the device 21a and the rights management unit 11 at the time of acquisition of the license information Dlca, and decryption of the content data Dcnt.

FIG. 13 is a third flowchart showing the operations of the device 21a and the rights management unit 11 at the time of acquisition of the license information Dlca, and decryption of the content data Dcnt.

FIGS. 14A, 14B, and 14C are schematic diagrams respectively showing, by format, an issue request Dir, license information Dlc, and rejection information Drj, all of which are transmitted and received during the processes of FIGS. 12 and 13.

FIG. 15 is a block diagram showing the entire structure of a license information management system Sa1 including a rights management unit 11a, which is a first modified example of the rights management unit 11 of FIG. 1.

FIG. 16 is a block diagram showing the detailed structure of the rights management unit 11a of FIG. 15.

FIG. 17 is a block diagram showing the detailed structure of a device 21c of FIG. 15.

FIG. 18 is a flowchart showing the operations of the device 21c and the rights management unit 11a to register the device 21c of FIG. 15 into the user information DB 113.

FIGS. 19A, 19B, and 19C are schematic diagrams respectively showing, by format, a registration request Drsc, a registration completion notice Dscc, and a registration rejection notice Dsrc, all of which are transmitted and received during the processes of FIG. 18.

FIG. 20 is a schematic diagram showing the user information DB 113 of an update version as a result of the processes of FIG. 18.

FIG. 21 is a block diagram showing the detailed structure of a rights management unit 11b, which is a second modified example of the rights management unit 11 of FIG. 1.

FIG. 22 is a block diagram showing the detailed structure of the device 21a or 21b according to the second modified example.

FIG. 23 is a block diagram showing the detailed structure of the device 21c according to the second modified example.

FIG. 24 is a flowchart showing the operations of the device 21a and the rights management unit 11b to register a device identifier Idvc of the device 21c into the user information DB 113.

FIG. 25 is a flowchart showing the operations of the device 21c and the rights management unit 11b to register the device identifier Idvc of the device 21c into the user information DB 113.

FIGS. 26A and 26B are schematic diagrams respectively showing, by format, a provisional registration request Dprsc and a provisional registration completion notice Dpscc, both of which are transmitted and received during the processes of FIG. 24.

FIGS. 27A and 27B are schematic diagrams showing the user information DB 113 of an update version as a result of processes of FIGS. 24 and 25.

FIGS. 28A and 28B are schematic diagrams respectively showing, by format, an actual registration request Dcrsc and an actual registration completion notice Dcscc, both of which are transmitted and received during the processes of FIG. 25.

FIG. 29 is a block diagram showing the detailed structure of a rights management unit 11c, which is a third modified example of the rights management unit 11 of FIG. 1.

FIG. 30 is a block diagram showing the detailed structure of the device 21a or 21b according to the third modified example.

FIG. 31 is a block diagram showing the detailed structure of the device 21c according to the third modified example.

FIG. 32 is a flowchart showing the operations of the device 21c and the rights management unit 11c to register the device identifier Idvc of the device 21c into the user information DB 113.

FIG. 33 is a flowchart showing the operations of the device 21a and the rights management unit 11c to register the device identifier Idvc of the device 21c into the user information DB 113.

FIGS. 34A and 34B are schematic diagrams respectively showing, by format, a password request Drps and a password notice Dpss, both of which are to be transmitted and received during the processes of FIG. 32.

FIGS. 35A and 35B are schematic diagrams both showing the user information DB 113 of an update version as a result of the processes of FIGS. 32 and 33, respectively.

FIGS. 36A and 36B are schematic diagrams respectively showing, by format, the registration request Drsc and the registration completion notice Dscc, both of which are transmitted and received during the processes of FIG. 33.

FIG. 37 is a block diagram showing the detailed structure of a rights management unit lid, which is a fourth modified example of the rights management unit 11 of FIG. 1.

FIG. 38 is a block diagram showing the detailed structure of the device 21a or 21b according to the fourth modified example.

FIG. 39 is a block diagram showing the detailed structure of the device 21c according to the fourth modified example.

FIG. 40 is a flowchart showing the operations of the devices 21a and 21c, and the rights management unit 11d to register the device identifier Idvc of the device 21c into the user information DB 113.

FIGS. 41A, 41B, and 41C are schematic diagrams respectively showing, by format, a first registration request Drsc1, a second registration request Drsc, and the registration completion notice Dscc, all of which are transmitted and received during the processes of FIG. 40.

FIG. 42 is a block diagram showing the entire structure of a license information management system Sa5 including a rights management unit 11e, which is a fifth modified example of the rights management unit 11 of FIG. 1.

FIG. 43 is a block diagram showing the detailed structure of the rights management unit 11e of FIG. 42.

FIG. 44 is a block diagram showing the detailed structure of the device 21b of FIG. 42.

FIG. 45 is a flowchart showing the operations of the device 21b and the rights management unit 11e to delete the device identifier Idvb of the device 21b from both the user information DB 113 and the rights DB 114.

FIGS. 46A and 46B are schematic diagrams respectively showing, by format, a deletion request Drwb and a deletion completion notice Dswb, both of which are transmitted and received during the processes of FIG. 45.

FIGS. 47A and 47B are schematic diagrams both showing the user information DB 113 of an update version as a result of the processes of FIG. 45.

FIG. 48 is a block diagram showing the entire structure of a license information management system Sb including a rights management unit 41 according to a second embodiment of the present invention.

FIG. 49 is a block diagram showing the detailed structure of the rights management unit 41 of FIG. 48.

FIG. 50 is a block diagram showing the detailed structure of devices 51a and 51b of FIG. 48.

FIG. 51 is a flowchart showing the operations of the device 51a and the rights management unit 41 at the time of acquisition of the content data Dcnt.

FIGS. 52A and 52B are schematic diagrams both showing the rights DB 114 of FIG. 49.

FIG. 53 is a schematic diagram showing, by format, a second setting request Drr2b, which is transmitted and received during the processes of FIG. 51.

FIG. 54 is a block diagram showing the entire structure of a license information management system Sc according to a third embodiment of the present invention.

FIG. 55 is a functional block diagram showing the detailed structure of a rights management unit 71 of FIG. 54.

FIG. 56 is a diagram showing the detailed structure of a license information generation section 721 of FIG. 55.

FIG. 57 is a functional block diagram showing the detailed structure of a device 81 of FIG. 54.

FIG. 58 is a functional block diagram showing the detailed structure of a license information processing section 817 of FIG. 57.

FIGS. 59A and 59B are schematic diagrams showing, respectively, a content DB 711 of FIG. 55, and a decryption key DB 712 of FIG. 55.

FIGS. 60A and 60B are schematic diagrams showing, respectively, a user information DB 713, and a rights DB 714 of FIG. 55.

FIG. 61 is a flowchart showing the operations of the device 81 and the rights management unit 71 at the time of acquisition of the content data Dcnt.

FIGS. 62A and 62B are schematic diagrams respectively showing, by format, the setting request Drr and the transmission data Dtrn, both of which are transmitted and received during the processes of FIG. 61.

FIG. 63 is a schematic diagram showing data to be stored in a content storage 815 of FIG. 58.

FIG. 64 is a first flowchart showing the operations of the device 81 and the rights management unit 71 at the time of acquisition of the license information Dlc, and decryption of the content data Dcnt.

FIG. 65 is a second flowchart showing the operations of the device 81 and the rights management unit 71 at the time of acquisition of the license information Dlc, and decryption of the content data Dcnt.

FIG. 66 is a third flowchart showing the operations of the device 81 and the rights management unit 71 at the time of acquisition of the license information Dlc, and decryption of the content data Dcnt.

FIGS. 67A, 67B, and 67C are schematic diagrams respectively showing, by format, the issue request Dir, the license information Dlc, and the rejection information Drj, all of which are transmitted and received during the processes of FIGS. 64 to 66.

FIG. 68 is a block diagram showing the entire structure of a license information management unit Sc1, which is a modified example of the license information management system Sc of FIG. 54.

FIG. 69 is a schematic diagram showing the structure of a portable recording medium 101 of FIG. 68.

FIG. 70 is a functional block diagram showing the detailed structure of a unit 201 of FIG. 68.

FIGS. 71A and 71B are schematic diagrams showing, respectively, the user information DB 713, and the rights DB 714 of FIG. 68.

FIG. 72 is a first flowchart showing the operations of the unit 201 and the rights management unit 71 for a licensee β to acquire the content data Dcnt using the unit 201.

FIG. 73 is a second flowchart showing the operations of the unit 201 and the rights management unit 71 for the licensee β to acquire the content data Dcnt using the unit 201.

FIGS. 74A and 74B are schematic diagrams respectively showing, by format, the setting request Drr and the issue request Dir, both of which are transmitted and received during the processes of FIGS. 72 and 73.

FIG. 75 is a first flowchart showing the operations of the unit 201 and the rights management unit 71 at the time of acquisition of the license information Dlc, and decryption of the content data Dcnt.

FIG. 76 is a second flowchart showing the operations of the unit 201 and the rights management unit 71 at the time of acquisition of the license information Dlc, and decryption of the content data Dcnt.

FIG. 77 is a third flowchart showing the operations of the unit 201 and the rights management unit 71 at the time of acquisition of the license information Dlc, and decryption of the content data Dcnt.

### DESCRIPTION OF THE PREFERRED EMBODIMENTS

(First Embodiment)

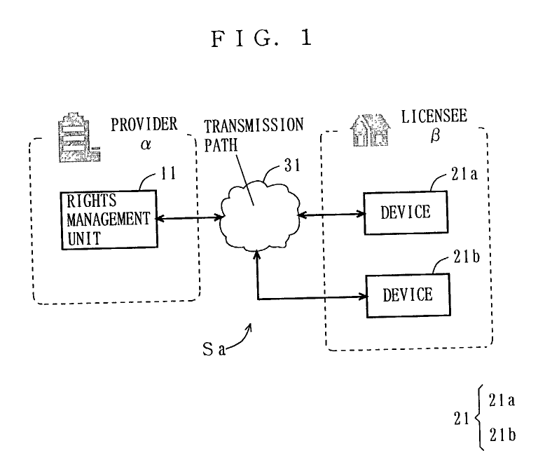

FIG. 1 is a block diagram showing the entire structure of a license information management system Sa including a rights management unit 11 according to a first embodiment of the present invention. In FIG. 1, the license information management system Sa includes the rights management unit 11, a plurality of devices 21, and a transmission path 31. Herein, the devices 21 are exemplarily provided two, i.e., devices 21a and 21b. The rights management unit 11 is placed on the side of a content distribution provider α. The devices 21a and 21b are typically used by a licensee β who is entitled to receive contents under contract with the provider α. The transmission path 31 is wired or wireless, and connects the rights management unit 11 to the device 21a or 21b for data communications therebetween.

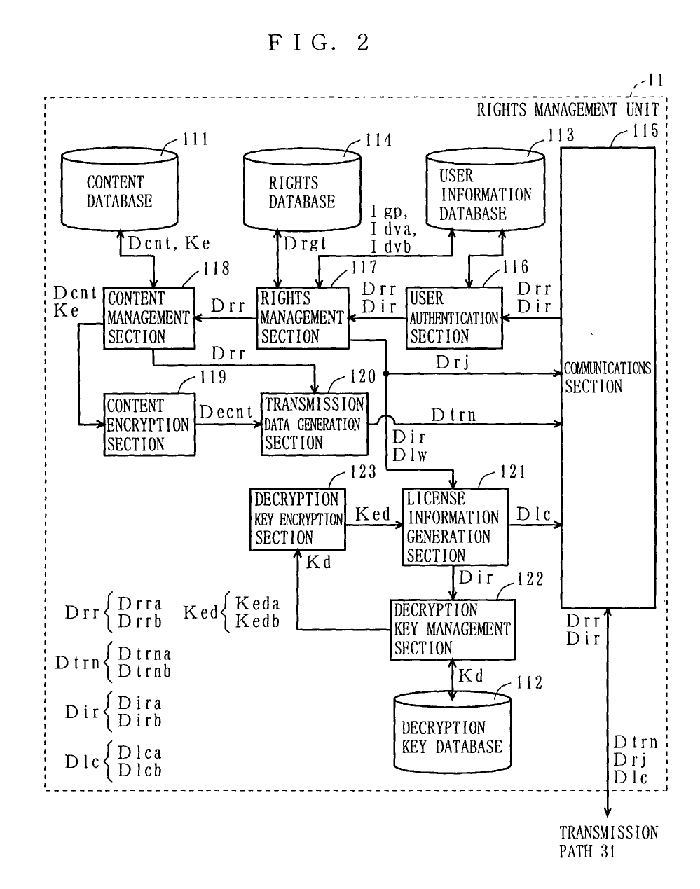

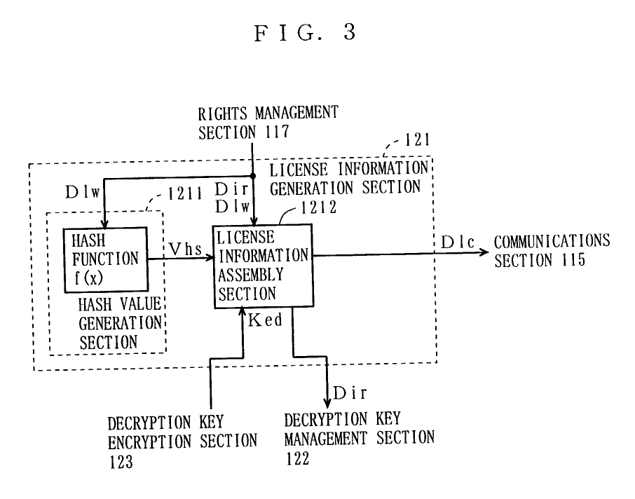

Referring to FIG. 2, described next is the detailed structure of the rights management unit 11 of FIG. 1. In FIG. 2, the rights management unit 11 includes a content database 111, a decryption key database 112, a user information database 113, a rights database 114, a communications section 115, a user authentication section 116, a rights management section 117, a content management section 118, a content encryption section 119, a transmission data generation section 120, a license information generation section 121, a decryption key management section 122, and a decryption key encryption section 123. More in detail, the license information generation section 121 includes, as shown in FIG. 3, a hash value generation section 1211, and a license information assembly section 1212.

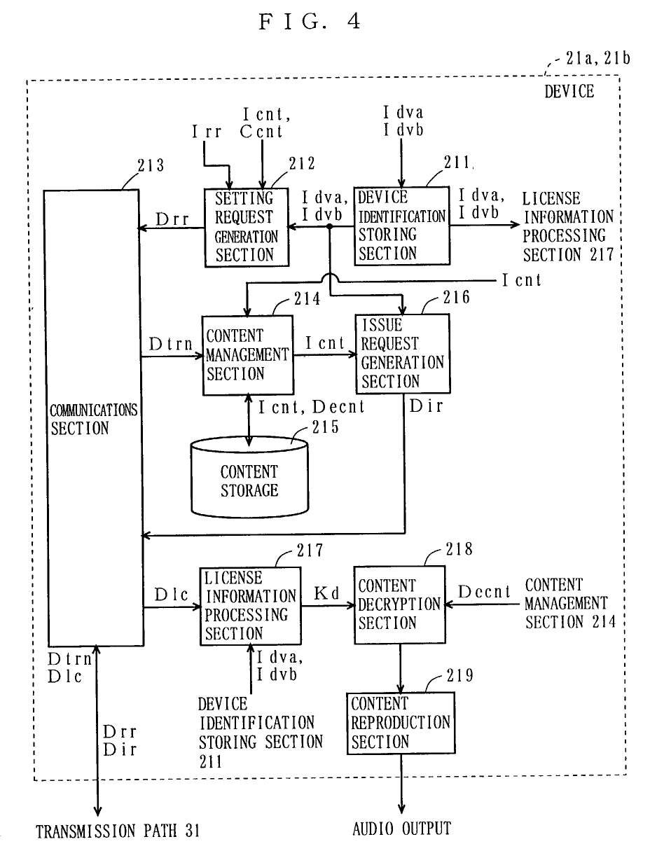

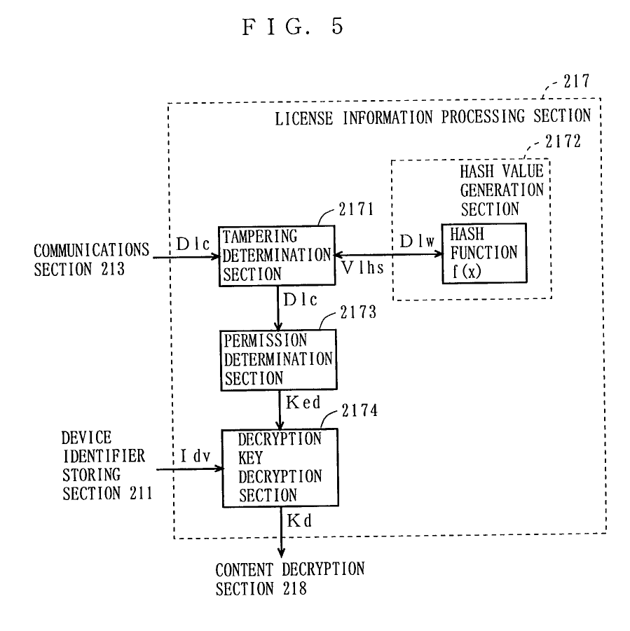

Referring to FIG. 4, described next is the detailed structure of the devices 21a and 21b of FIG. 1. In FIG. 4, the devices 21a and 21b are typified by any one of a personal computer (hereinafter, referred to as PC), a set-top box, a music player, a television receiver, and a game machine. In the present embodiment, expediently, the devices 21a and 21b are presumed to be, respectively, a PC with a music playback function, and a music player. Under this presumption, the devices 21a and 21b each include, at least, a device identifier storing section 211, a setting request generation section 212, a communications section 213, a content management section 214, a content storage 215, an issue request generation section 216, a license information processing section 217, a content decryption section 218, and a content reproduction section 219. More in detail, the license information processing section 217 includes, as shown in FIG. 5, a tampering determination section 2171, a hash value generation section 2172, a permission determination section 2173, and a decryption key decryption section 2174.

Described next is the setup in the license information management system Sa, needed for content distribution from the provider α to the licensee β. For this setup, the provider a constructs the content database (hereinafter, content DB) 111, the decryption key database (decryption key DB) 112, and the user information database (user information DB) 113 of FIG. 2.

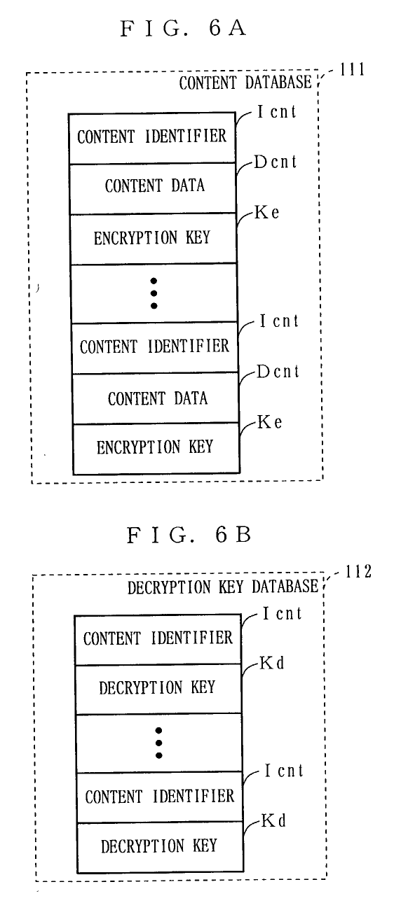

Referring to FIG. 6A, the content DB 111 of FIG. 2 is described in detail. The provider a first creates content data Dcnt or receives it from any content creators for distribution to the licensee β. Here, the content data Dcnt can be used by both the devices 21a and 21b, and exemplified by television programs, movies, radio programs, music, books, or printouts. The content data Dcnt may be game programs or application software. In the present embodiment, the content data Dcnt is expediently music data.

To the content data Dcnt acquired as such, the provider α assigns a content identifier Icnt, with which the content data Dcnt is uniquely identified in the license information management system Sa. Preferably, the content identifier Icnt is also a locator indicating where the content data Dcnt has been stored. In view of digital rights protection, the content data Dcnt is encrypted on the rights management unit 11 side before distributed to the device 21a or 21b. To encrypt the content data Dcnt, the provider a assigns an encryption key Ke, which is specifically designed for the content data Dcnt. The content identifier Icnt, the content data Dcnt, and the encryption key Ke are stored, as a set, in the content DB 111. As shown in FIG. 6A, the content DB 111 plurally stores such a set. In the content DB 111, the content identifier Icnt uniquely identifies the content data Dcnt in the same set. The encryption key Ke is used to encrypt the content data Dcnt in the same set.

In the present embodiment, for schematic simplicity, the content DB 111 is presumably constructed from the content identifiers Icnt, the content data Dcnt, and the encryption keys Ke. However, databases may be constructed independently for the content data Dcnt and the encryption keys Ke. The content identifier Icnt is preferably a locator of the content data Dcnt. In this case, the rights management unit 11 can read out the content data Dcnt from the content DB 111 using the content identifier Icnt included in the setting request Drra coming from the device 21a or 21b. This eliminates the need for the content DB 111 to carry the content identifiers Icnt.

Referring to FIG. 6B, the decryption key DB 112 of FIG. 2 is described in detail. As already described, the content data Dcnt is encrypted using the encryption key Ke before transmitted to the device 21a or 21b. In the below, the content data Dcnt encrypted using the encryption key Ke is referred to as encrypted content data Decnt. In order to decrypt the encrypted content data Decnt, the device 21a or 21b needs to have a decryption key Kd corresponding to the encryption key Ke. Thus, the provider α provides such a decryption key Kd corresponding to the encryption key Ke in the content DB 111. Here, the bit string of the decryption key Kd may be the same or different from that of the encryption key Ke. The resulting decryption key Kd is registered in the decryption key DB 112 together with the content identifier Icnt. As such, the decryption key DB 112 plurally stores a set of the content identifier Icnt and the decryption key Kd, as shown in FIG. 6B. In the decryption key DB 112, the content identifier Icnt identifies the content data Dcnt assigned to the decryption key Kd in the same set. The decryption key Kd is used to decrypt the encrypted content data Denct which is identified by the content identifier Icnt in the same set.

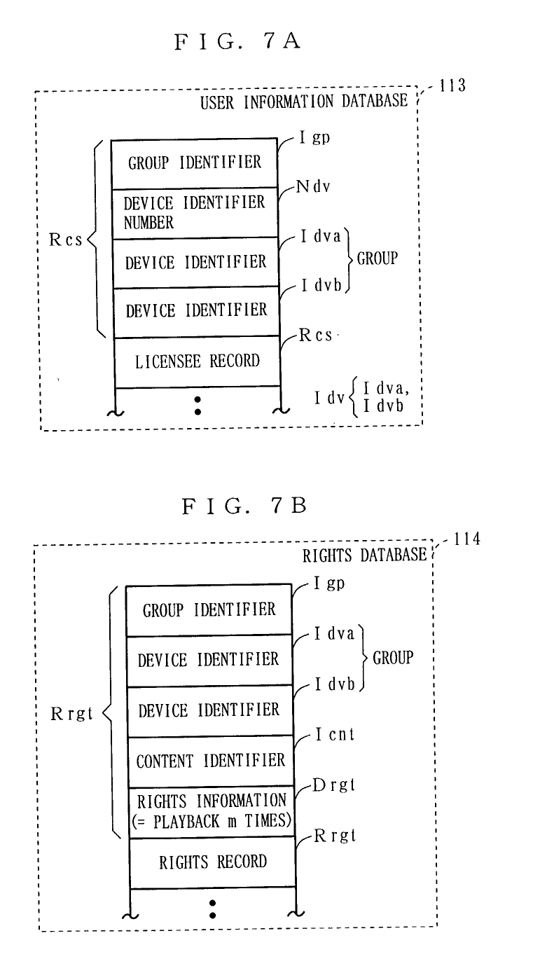

Referring to FIG. 7A, described next in detail is the user information DB 113 of FIG. 2. As described above, the licensee β signs a contract with the provider a for content distribution. Here, contract signing may be done through the transmission path 31, or in other manners. Based on thus signed contract, the provider a assigns a device identifier Idv to every device 21 owned by the licensee . In FIG. 1 example, owned by the licensee β are the two devices 21a and 21b. Thus, the provider a assigns those with device identifiers Idva and Idvb, respectively. The device identifiers Idva and Idvb uniquely identify, respectively, the devices 21a and 21b on the licensee β side in the license information management system Sa. These device identifiers Idva and Idvb are registered in the user information DB 113. Also, the provider α assigns a group identifier Igp to the contract thus made with the licensee β. This is to make the content data Dcnt available for the licensee β and his or her parties no matter with which device 21a or 21b they use. For convenience, the licensee β and his or her parties are broadly referred to as the user β. The provider a accordingly constructs the user information DB 113 from the device identifiers Idva and Idvb, and the group identifier Igp.

To be more specific, the user information DB 113 plurally includes a licensee record Rcs, as shown in FIG. 7A. The licensee record Rcs is created for every contract, and typically includes the group identifier Igp, a device identifier number Ndv, and a plurality of device identifiers Idv. The group identifier Igp specifies that a plurality of device identifiers Idv found in the licensee record Rcs are all in the same group. The device identifier number Ndv indicates how many devices 21 are in the group identified by the group identifier Igp. The device identifiers Idv identify each corresponding device 21 in the group identified by the group identifier Igp. Such a licensee record Rcs helps the rights management unit 11 know that a plurality of devices 21 are in the same group. In a case where a licensee uses only one device 21, the licensee record Rcs accordingly includes only one corresponding device identifier Idv.

Refer back to FIG. 4. The device identifiers Idva and Idvb thus assigned by the provider α are set to the device identifier storing section 211 provided in each of the devices 21a and 21b on the user β side. Specifically, the device identifier Idva is set to the device identifier storing section 211 of the device 21a, and the device identifier Idvb is set to the device identifier storing section 211 of the device 21b. For such a setting, the provider α accordingly operates the device 21a or 21b on the user β side, for example. Alternatively, the provider a may transmit the device identifier Idva or Idvb assigned to the user β to the corresponding device 21a or 21b, and thus received device identifier Idva or Idvb may be automatically set to the corresponding device identifier storing section 211. Still alternatively, such a setting may be made at the time of shipment of the device 21a or 21b. If this is the case, at the time of contract signing, the licensee β notifies the provider α of the device identifiers Idv assigned to his or her devices 21. The provider α uses thus informed device identifiers Idv to construct the user information DB 113.

The rights management database 114 shown in FIG. 7B will be described later.

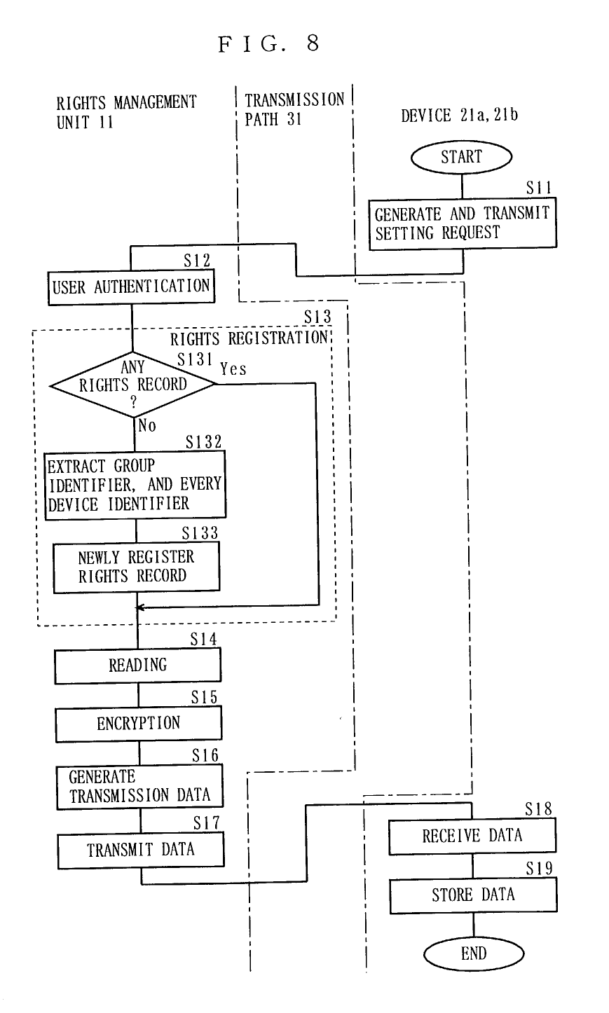

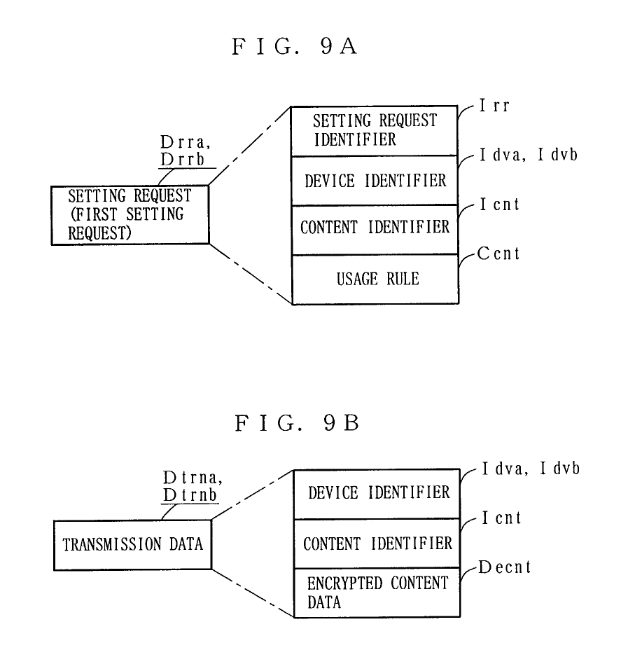

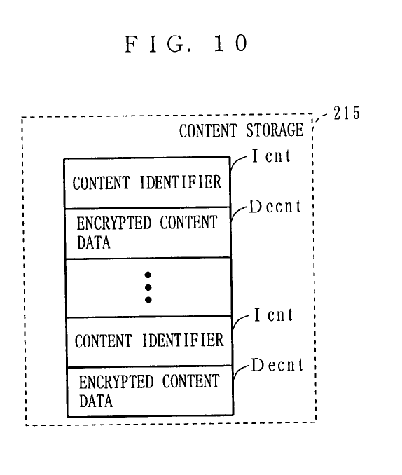

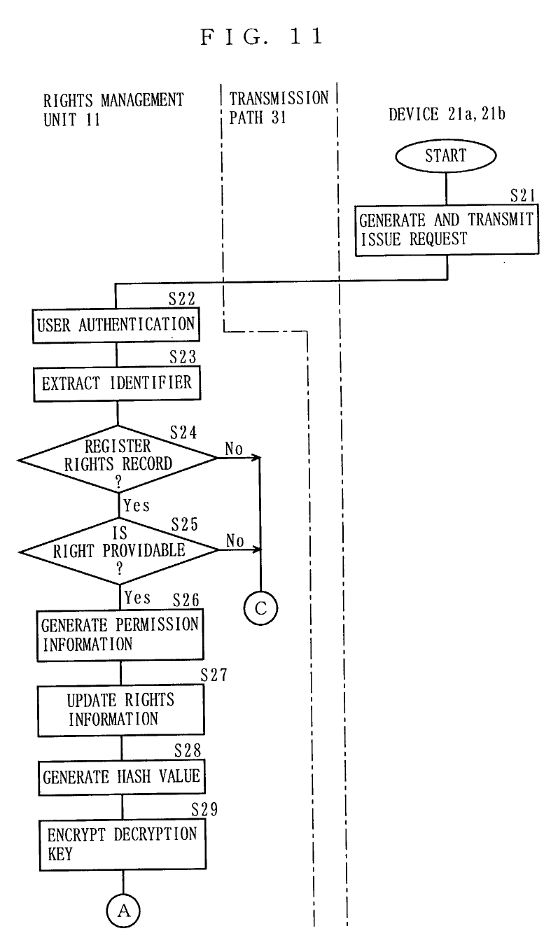

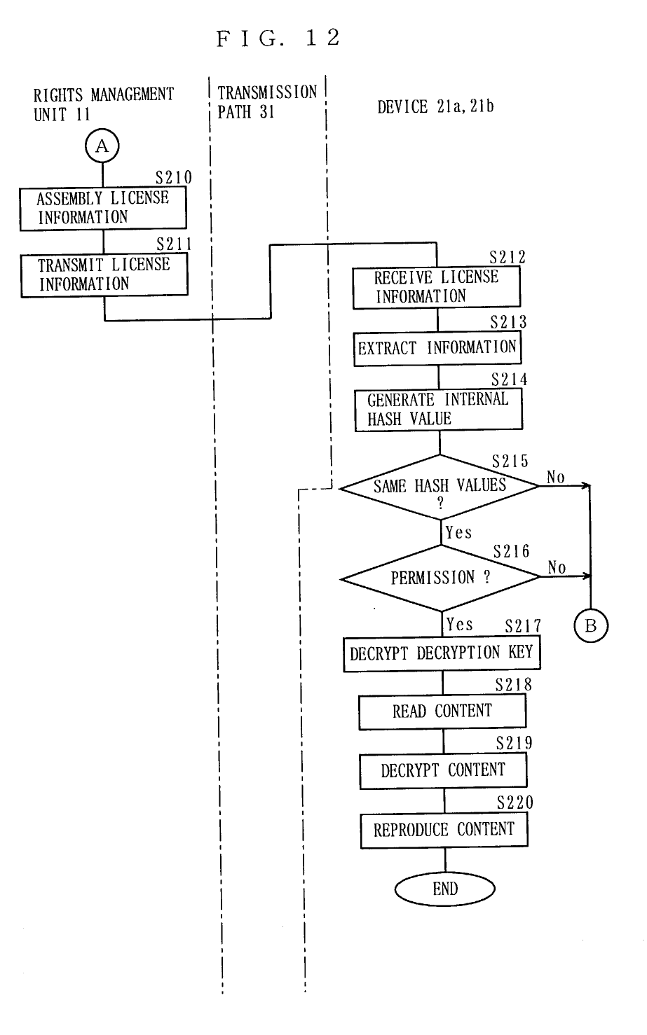

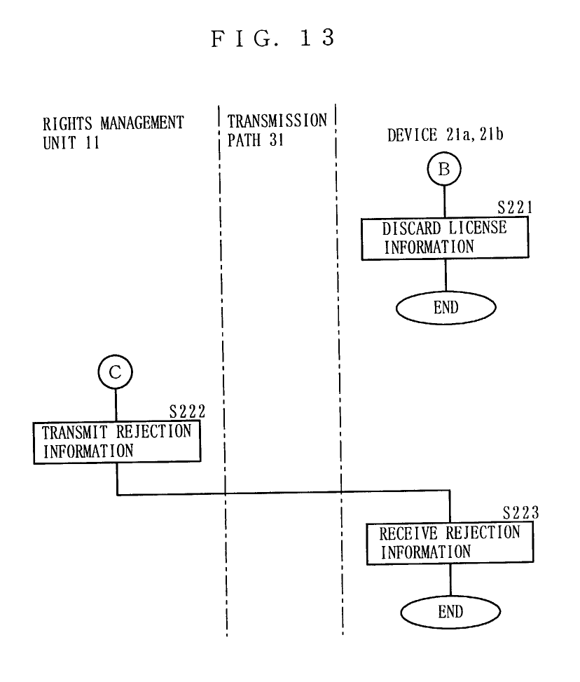

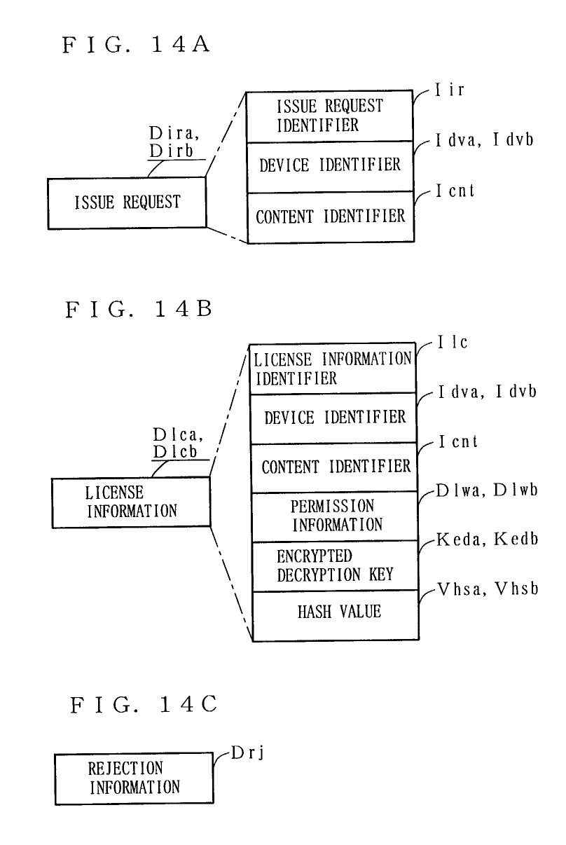

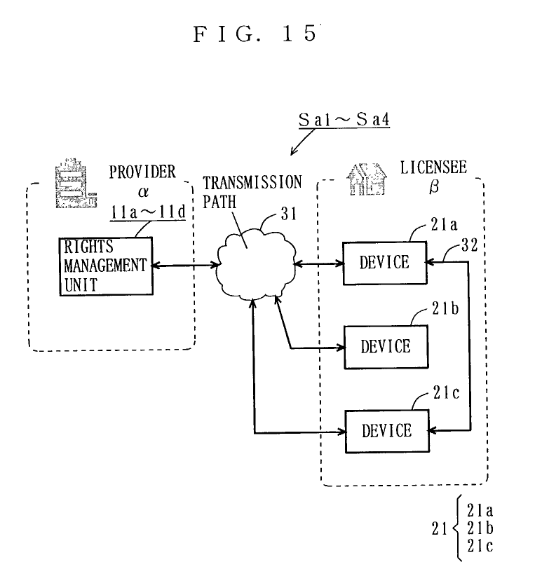

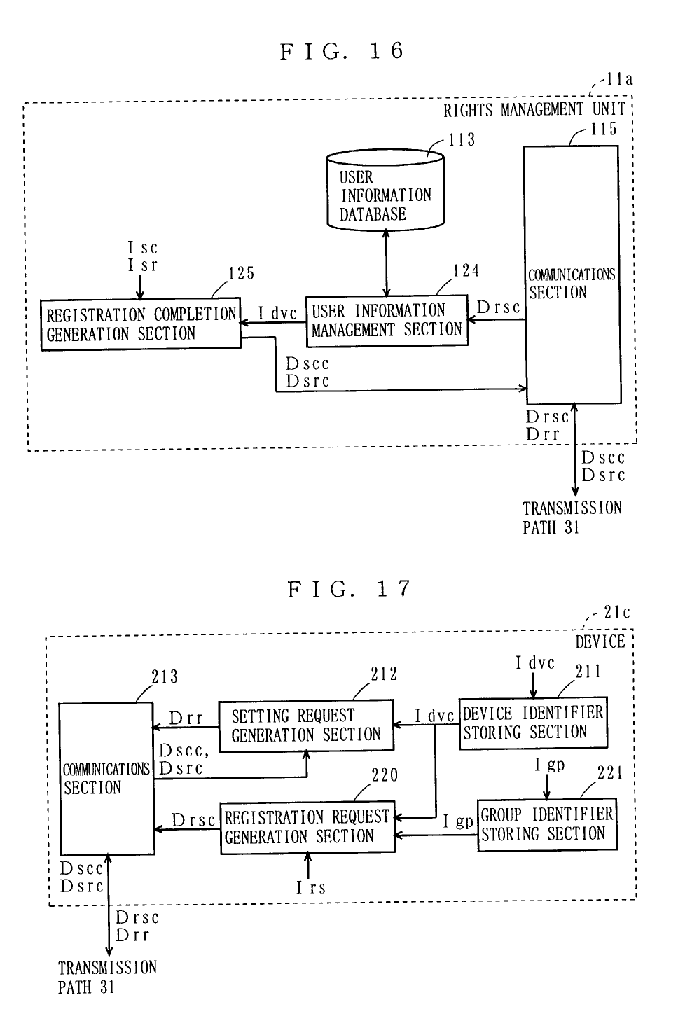

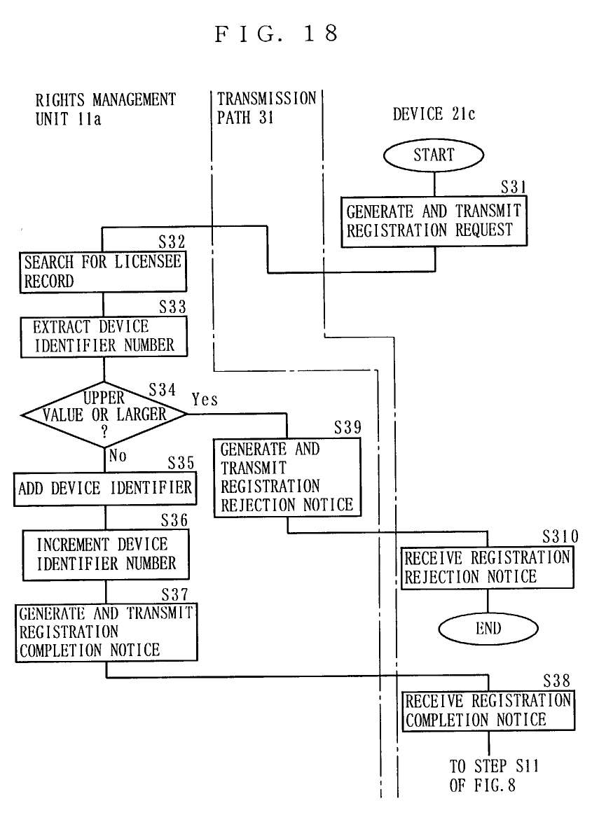

After such a setup is completed, either the device 21a or 21b becomes ready, responding to the user β's operation, for setting a right to use the content data Dcnt with respect to the rights management unit 11, or acquire the content data Dcnt. Referring to FIG. 8, described next is data communications between the device 21a and the rights management unit 11 at the time of right setting or acquisition of the content data Dcnt. First, the user β accesses the rights management unit 11 through operation of the device 21a. The user β then refers to the content DB 111 to see which content data Dcnt he or she wants, and specifies the content identifier Icnt assigned thereto. In the below, thus specified content data Dcnt is referred to as acquiring content data Dcnt. The use β then designates a usage rule Ccnt for use of the acquiring content data Dcnt.

In detail, the usage rule Ccnt is information indicating under what rule the device 21a is asking for a right to use the content data Dcnt. If the content data Dcnt represents music, the usage rule Ccnt is typified by valid period, playback frequency, maximum playback duration, total playback time, or playback quality. Here, the usage rule Ccnt may include two or more of those. For example, as the usage rule Ccnt, the valid period may be set as “from Jun. 1, 2001 to Aug. 31, 2001”, and only for the period, the content data Dcnt becomes available for the device 21a. If the playback frequency is set to five, the device 21a is allowed to playback the content data Dcnt for five times. If the maximum playback duration is set to 10 seconds, the device 21a can playback the content data Dcnt for the duration at a time. This is especially effective for music promotion. As to the total playback time, if set to 10 hours, it means that the content data Dcnt is available for the device 21a at any time for the duration of time. The playback quality may be set as “quality of CDs (Compact Disks)”, and the device 21a can playback the content data Dcnt with thus set playback quality.

Here, those exemplified usage rules Ccnt are possibilities for the case where the content data Dcnt represents music. This is not restrictive, and it is preferable that setting of the usage rule Ccnt is appropriately made depending on what the content Dcnt represents. In the below, the usage rule Ccnt is expediently the playback frequency of the content data Dcnt.

In response to the content identifier Icnt and the usage rule Ccnt designated by the user β, the device 21a generates such a setting request Drra as shown in FIG. 9A for transmission to the rights management unit 11 (FIG. 8, step S11). The setting request Drra is information for requesting the rights management unit 11 for a right to use the acquiring content data Dcnt. In the present embodiment, the setting request Drra is also used to request the rights management unit 11 for distribution of the acquiring content data Dcnt. More in detail, in step S11, the setting request generation section 212 (see FIG. 4) first receives the content identifier Icnt and the usage rule Ccnt designated by the user β. The setting request generation section 212 also receives the device identifier Idva from the device identifier storing section 211. Then, to the set of the device identifier Idva, the content identifier Icnt, and the usage rule Ccnt, the setting request generation section 212 adds a setting request identifier Irr, which is previously stored. As such, the setting request Drra (see FIG. 9A) is generated. The setting request identifier Irr is used by the rights management unit 11 to identify the setting request Drra. The setting request generation section 212 forwards such a setting request Drra to the communications section 213, from which the setting request Drra is transmitted to the rights management unit 11 over the transmission path 31.

In the rights management unit 11 (see FIG. 2), the communications section 115 receives the setting request Drra coming over the transmission path 31, and forwards it to the user authentication section 116. After receiving the setting request Drra, the user authentication section 116 goes through a user authentication process to determine whether the device 21a from which the setting request Drra came is belonging to the user β (FIG. 8; step S12). More specifically, the user authentication section 116 accesses the user information DB 113 (see FIG. 7A) to see whether it carries the device identifier Idva corresponding to the device identifier Idva included in the received setting request Drra. Only when including, the user authentication section 116 authenticates the current setting request Drra as being the one provided from the device 21a of the user β. After completing such a user authentication process, the user authentication section 116 forwards the received setting request Drra to the rights management section 117.

Here, if the received request Drra is not from the user β, the user authentication does not work out. Thus, the user authentication section 116 discards the setting request Drra without forwarding it to the rights management section 117.

The rights management section 117 acknowledges as having received the setting request Drra by referring to the setting request identifier Irr included in the information provided by the user authentication section 116. As acknowledged as such, the rights management section 117 (see FIG. 2) accesses the rights database (hereinafter, rights DB) 114 to go through a right registration process with respect thereto (step S13). More specifically, the rights management section 117 extracts from the setting request Drra the device identifier Idva and the content identifier Icnt, and then determines whether the rights DB 114 (see FIG. 7B) carries a rights record Rrgt including those (step S131). Assuming that rights DB 114 carries no such rights record Rrgt, the procedure goes to step S132. Here, as to the operation when the rights record Rrgt is found in step S131, it will be described later together with the operation of the device 21b.

In step S132, from the received setting request Drra, the rights management section 117 first extracts the device identifier Idva, the content identifier Icnt, and the usage rule Ccnt, and then accesses the user information DB 113 (see FIG. 7A). Then, from the licensee record Rcs including thus extracted device identifier Idva, the rights management section 117 extracts the group identifier Igp and both the device identifiers Idva and Idvb (step S132). Next, the rights management section 117 registers in the rights DB 114, as the rights record Rrgt, a set of the device identifier Idva, the content identifier Icnt, and the usage rule Ccnt extracted from the setting request Drra, and the group identifier Igp, and the device identifiers Idva and Idvb acquired from the user information DB 113 (step S133). Here, from the usage rule Ccnt in the setting request Drra, the rights management section 117 regards the device 21a as requesting for a right to use the acquiring content data Dcnt. In this sense, the rights management section 117 handles the usage rule Ccnt extracted from the setting request Drra as rights information Drgt. That is, the rights information Drgt indicates the right of the device 21a to use the content data Dcnt under the rule indicated by the usage rule Ccnt.

After such a registration process, as shown in FIG. 7B, the rights DB 114 plurally includes the rights record Rtrgt, which includes the group identifier Igp, the device identifiers Idva and Idvb, the content identifier Icnt, and the rights information Drgt. The rights management section 117 accordingly manages the rights of the licensee β for every acquiring content data Dcnt. Moreover, by providing the rights record Rrgt both the device identifiers Idva and Idvb retrieved from the user information DB 113, the setting request Drra from the device 21a enables the units 21a and 21b to share the right to use the content data Dcnt. This is one characteristic of the present embodiment. After completing such a usage rule registration process, the rights management section 117 forwards the setting request Drra to the content management section 118.

Assuming that the current setting re quest Drra includes the usage rule Ccnt of “playback m times” (where m is a natural number), the rights record Rrgt to be newly registered will include the rights information Drgt showing a usage rule of “playback m times” as exemplified in FIG. 7B.

Here, although irrelevant to the technical characteristics of the present license information management system Sa, in step S13, the rights management section 117 may charge the licensee β assigned with the device identifier Idva for the use of the content data Dcnt every time usage rule information Dcrt is registered.

After receiving the setting request Drra, the content management section 118 goes through a process for reading the content data Dcnt and the encryption key Ke designed specifically therefor (step S14). More in detail, the content management section 118 extracts the content identifier Icnt from the setting request Drra. Then, the content management section 118 accesses the content DB 111 to read the content data Dcnt to which the extracted content identifier Icnt has been assigned, and the corresponding encryption key Ke. After such a reading process, the content management section 118 forwards the resulting content data Dcnt and the encryption key Ke to the content encryption section 119. The content management section 118 forwards also the received setting request Drra to the transmission data generation section 120.

The content encryption section 119 goes through a process for encrypting the content data Dcnt (step S15). More specifically, the content encryption section 119 encrypts the content data Dcnt using the encryption key Ke accompanied therewith, and the encrypted content data Decnt is thus generated. After completing such an encryption process, the content encryption section 119 forwards the encrypted content data Decnt to the transmission data generation section 120.

After receiving both the setting request Drra from the content management section 118, and the encrypted content data Decnt from the content encryption section 119, the transmission data generation section 120 goes through a process for generating transmission data (step S16). To be more specific, the transmission data generation section 120 extracts, from the setting request Drra, the content identifier Icnt and the device identifier Idva. Thus extracted device identifier Idva and content identifier Icnt are added to the encrypted content data Decnt, and thus transmission data Dtrna as shown in FIG. 9B is generated. After such a transmission data generation process, the transmission data generation section 120 forwards the resulting transmission data Dtrna to the communications section 115. The received transmission data Dtrna is then transmitted to the device 21a over the transmission path 31 (step S17).

In the device 21a (see FIG. 4), the communications section 213 receives the transmission data Dtrna coming over the transmission path 31 (step S18). More specifically, the communications section 213 acknowledges as having received the transmission data Dtrna addressed thereto because of the device identifier Idva and the content identifier Icnt included therein. As acknowledged as such, the communications section 213 forwards the received data Dtrna to the content management section 214.

The content management section 214 stores, in the content storage 215, the content identifier Icnt and the encrypted content data Decnt in the received data Dtrna (step S19). That is, as shown in FIG. 10, the content storage 215 plurally stores a set of the content identifier Icnt and the encrypted content data Decnt requested using the setting request Drra.

In view of digital rights protection, distributed to the device 21a is the encrypted content data Decnt. Thus, in order to use the content data Dcnt, the device 21a has to decrypt the encrypted content data Decnt using the decryption key Kd provided by the rights management unit 11. In order to provide the decryption key Kd to the device 21a, used in the present license information management system Sa is license information Dlca. Referring to FIGS. 11 to 13, described now are the operations of the device 21a and the rights management unit 11 at the time of acquisition of the license information Dlca, and decryption of the content data Dcnt.

First of all, through operation of the device 21a, the user β specifies which encrypted content data Decnt found in the content storage 215 he or she wants to use. In the below, thus specified encrypted content data Decnt is referred to as decrypting content data Decnt. In response, the device 21a generates such an issue request Dira as shown in FIG. 14A, and transmits it to the rights management unit 11 (FIG. 11; step S21). The issue request Dira is information used by the device 21a for requesting the rights management unit 11 to release the license information Dlca. More specifically, the content management section 214 (see FIG. 4) retrieves, from the content storage 215, the content identifier Icnt attached to the decrypting content data Decnt specified by the licensee β, and forwards it to the issue request generation section 216. The issue request generation section 216 receives the content identifier Icnt thus extracted by the content management section 214. Moreover, the issue request generation section 216 retrieves the device identifier Idva from the device identifier storing section 211. Then, the issue request generation section 216 adds the issue request identifier Iir to the set of the device identifier Idva and the content identifier Icnt so that the issue request Dira (see FIG. 14A) is generated. Here, the issue request identifier Iir is used by the rights management unit 11 to identify the issue request Dira. The issue request generation section 216 forwards the resulting issue request Dira to the communications section 213, from which the issue request Dira is transmitted to the rights management unit 11 over the transmission path 31.

In the rights management unit 11, the communications section 115 (see FIG. 2) receives the issue request Dira coming over the transmission path 31, and forwards it to the user authentication section 116. After receiving the issue request Dira, the user authentication section 116 goes through the user authentication process (step S22). Here, the user authentication process in step S22 is similar to that in step S12, and thus not described in detail again. Only when the user authentication worked out, the user authentication section 116 forwards the received issue request Dira to the rights management section 117.

The rights management section 117 acknowledges as having received from the user authentication section 116 the issue request Dira by referring to the issue request identifier Iir set thereto. As acknowledged as such, from the issue request Dira, the rights management section 117 extracts the device identifier Idva and the content identifier Icnt (step S23). The rights management section 117 then determines whether the rights DB 114 (see FIG. 7B) carries a rights record Rrgt including the same set as the extracted device identifier Idva and the content identifier Icnt (step S24).

If determined “Yes” in step S24, the rights management section 117 refers to the rights information Drgt included in thus found rights record Rrgt to determine whether the device 21a is qualified for permission, i.e., whether the right to the content data Dcnt is still available (step S25). If “Yes”, the rights management section 117 refers to the rights information Drgt to generate permission information Dlwa (step S26). Here, the permission information Dlwa is information to qualify the device 21a to decrypt the decrypting content data Decnt. Here, generating the permission information Dlwa requires the rights information Drgt of the device 21a, so that the rights management section 117 updates the rights information Drgt by the amount used in step S26 (step S27). In a case where the rights information Drgt has been used up prior to step S27, the corresponding rights record Rrgt may be deleted from the rights DB 114.

Here, steps S25 to S27 are specifically exemplified. As assumed in the above, in the current rights record Rrgt, the rights information Drgt represents a right to “playback m times” as exemplified in FIG. 7B. Therefore, in step S25, the rights management section 117 determines that the device 21a may be entitled to playback the music represented by the decrypting content data Decnt. The rights management section 117 accordingly generates the permission information Dlwa in step S26. The permission information Dlwa generated at this time is exemplarily “playback n times”. Here, n is a natural number not exceeding m, and for example, a user-designated value through operation of the device 21a. Alternatively, n may be set on the rights management section 117 side depending on the throughput of the device 21a. Instep S26, the device 21a exercises the right to playback the decrypting content data Decnt for n times. Thus in step S27, the rights management section 117 updates the rights information Drgt from “playback m times” to “playback (m-n) times”.

In the above, the rights information Drgt is presumed as indicating the playback frequency of the content data Dcnt. As already described, the present license information management system Sa does not limit the rights information Drgt (i.e., usage rule Ccnt) by type. There thus needs to appropriately define the procedure from steps S23 to S27 in accordance with the rights information Drgt.

From the rights management section 117 (see FIG. 2), such permission information Dlwa is forwarded to the license information generation section 121 together with the issue request Dira. More specifically, in the license information generation section 121, the hash value generation section 1211 receives only the permission information Dlwa, while the license information assembly section 1212 receives both the permission information Dlwa and the issue request Dira.

First, the hash value generation section 1211 assigns the received permission information Dlwa to a previously-held hash function f(x), and generates a hash value Vhsa (step S28). The hash value Vhsa is a protection measure against tampering with the permission information Dlwa, and is a solution derived by assigning the permission information Dlwa to a generating polynomial f(x). Such a hash value Vhsa is forwarded from the hash value generation section 1211 to the license information assembly section 1212.

The license information assembly section 1212 forwards the received issue request Dira to the decryption key management section 122 (see FIG. 2), in which the aforementioned decryption key DB 112 (see FIG. 6B) is managed. The decryption key management section 122 extracts from the issue request Dira the content identifier Icnt and the device identifier Idva. The decryption key management section 122 also retrieves from the decryption key DB 112 the decryption key Kd in the same set as the content identifier Icnt, and forwards it to the decryption key encryption section 123 together with the device identifier Idva. The decryption key encryption section 123 then encrypts the decryption key Kd using the device identifier Idvb accompanied therewith (step S29), so that the encrypted decryption key Keda is generated. The resulting encrypted decryption key Keda and the device identifier Idva are forwarded to the license information assembly section 1212.

When all the issue request Dira, the permission information Dlwa, the hash value Vhsa, and the encrypted decryption key Keda, the license information assembly section 1212 starts generating such license information Dlca as shown in FIG. 14B (FIG. 12; step S210). More specifically, the license information assembly section 1212 extracts from the received issue request Dira the content identifier Icnt and the device identifier Idva, and adds those to the set of the permission information Dlwa, the encrypted decryption key Keda, and the hash value Vhsa. Further, the license information assembly section 1212 adds a previously-held license information identifier Ilc to the device identifier Idva, so that the license information Dlca is generated. Here, the license information Dlca is information for controlling the use of the decrypting content data Decnt by the device 21a. The license information identifier Ilc is information used by the device 21a to identify the license information Dlca. The license information Dlca is transmitted to the device 21a through the communications section 115 and the transmission path 31 (step S211).

In the device 21a (see FIG. 4), the communications section 213 receives the license information Dlca coming over the transmission path 31 (step S212). More specifically, the communications section 213 acknowledges that the received information is addressed thereto because of the device identifier Idva included therein. And by referring to the license information identifier Ilc set to the information, the communications section 213 acknowledges as having received the license information Dlca. As acknowledged as such, the communications section 213 forwards the received license information Dlca to the license information processing section 217.

The license information processing section 217 includes, as shown in FIG. 5, the tampering determination section 2171, the hash value generation section 2172, the permission determination section 2173, and the decryption key decryption section 2174. The license information Dlca from the communications section 213 is forwarded to the tampering determination section 2171. Therein, from the license information Dlca, the permission information Dlwa and the hash value Vhsa are extracted (step S213). The extracted permission information Dlwa is forwarded to the hash value generation section 2172, while the hash value Vhsa is retained as it is. Here, in order to avoid confusion, the hash value Vhsa extracted in step S213 is now referred to as the external hash value Vehsa in the respect that the hash value is generated outside of the device 21a, i.e., the rights management unit 11.

The hash value generation section 2172 holds the same hash function f(x) as the hash value generation section 1211 (see FIG. 3) on the rights management unit 11 side. The received permission information Dlwa is assigned to the hash function f(x) so that the hash value Vhsa is generated (step S214). Here, the hash value Vhsa generated in step S214 is referred to as the internal hash value Vlhsa in the respect that the hash value is generated inside of the device 21a. The hash value generation section 2172 returns the internal hash value Vlsha to the tampering determination section 2171.

After receiving the internal hash value Vlhsa, the tampering determination section 2171 determines whether the permission information Dlwa has been tampered or not (step S215). More in detail, the internal hash value Vlhsa coincides with the external hash value Vehsa if the permission information Dlwa in the license information Dlca is not tampered. Thus, determined in step S215 is whether or not the received internal hash value Vlhsa coincides with the external hash value Vehsa. If determined “Yes”, the tampering determination section 2171 determines that the permission information Dlwa has not been tampered and thus effective, and then forwards the license information Dlca to the permission determination section 2173.

The permission determination section 2173 refers to the received license information Dlca to determine whether or not the decrypting content data Decnt is allowed for use (step S216). Only when determined “Yes” in step S216, the permission determination section 2173 extracts from the license information Dlca the encrypted decryption key Keda, which is then forwarded to the decryption key decryption section 2174.

More in detail, in step S216, as assumed above, the permission information Dlwa in the license information Dlca approves playback of the content data Dcnt for n times. In this case, if the playback frequency set to the permission information Dlwa in step S216 is 1 or larger, the permission determination section 2173 determines that the decrypting content data Decnt is available. The license information Dlca is thus forwarded to the decryption key decryption section 2174.

In the above, the rights information Drgt presumably indicates the playback frequency of the content data Dcnt. As already described, the present license information management system Sa does not limit the rights information Drgt (i.e., the usage rule Ccnt) by type. Thus, there needs to appropriately define the process of step S216 in accordance with the rights information Drgt.

The decryption key decryption section 2174 receives the encrypted decryption key Keda from the permission determination section 2173. The decryption key decryption section 2174 also retrieves from the device identifier storing section 211 the device identifier Idva. Thereafter, the decryption key decryption section 2174 decrypts the encrypted decryption key Keda using the device identifier Idva (step S217), and the decryption key Kd is forwarded to the content decryption section 218.

Here, before or after step S217, the content management section 214 retrieves the decrypting content data Decnt from the content storage 215 (step S218). FIG. 12 example shows the content management section 214 doing so immediately after step S217. Thus retrieved content data Decnt is forwarded to the content decryption section 218. The content decryption section 218 decrypts the decrypting content data Decnt using the decryption key Kd provided by the decryption key decryption section 2174 (step S219), and the resulting content data Dcnt is forwarded to the content reproduction section 219. The content reproduction section 219 reproduces the content data Dcnt for audio output (step S220). In this manner, the licensee β can listen to the music represented by the content data Dcnt purchased from the provider α.

Refer to step S215 of FIG. 12. In step S215, there may be a case where the tampering determination section 2171 determines that the permission information Dlwa has been tampered. Also, in step S216, there may be a case where the permission determination section 2173 determines that the decrypting content data Decnt is not allowed for use. In these cases, the tampering determination section 2171 and the permission determination section 2173 discard the received license information Dlca (FIG. 13; step S221). As is evident from above, only when the received license information Dlca is effective, the present license information management system Sa allows decryption of the decrypting content data Decnt. As such, the digital rights are successfully protected.

In step S24 of FIG. 11, the rights management section 117 may determine that the rights DB 114 (see FIG. 7B) carries no corresponding rights record Rrgt. In step S25, the rights management section 117 may determine that the device 21a is not qualified for permission. If so, the rights management section 117 generates rejection information Drj (see FIG. 14C) which indicates that the use of the decrypting content data Decnt is rejected. The rejection information Drj is then transmitted to the communications section 115, from which the rejection information Drj is transmitted to the device 21a over the transmission path 31 (FIG. 13; step S222).

In the device 21a (see FIG. 4), the communications section 213 receives the rejection information Drj coming over the transmission path 31 (step S223). The rejection information Drj stops the device 21a to go through a further process. As such, when the rights DB 114 carries no effective rights record Rrgt, the present license information management system Sa forwards the rejection information Drj to the device 21a, from which the issue request Dira has been provided. Therefore, the decrypting content data Decnt is not decrypted on the device 21a side, thereby sufficiently protecting the digital rights.

After determining that the rights DB 114 (see FIG. 7B) carries no corresponding rights record Rrgt in step S24, the rights management section 117 may alternatively generates a new rights record Rrgt for registration into the rights DB 114.

With the rights record Rrgt registered as such, the device 21b becomes able to share the right to use the content data Dcnt with the device 21a. Described next is data communications between the device 21b and the rights management unit 11, and their operations therefor. The operation of the device 21b is almost the same as that of the device 21a, and thus no detailed description is given. The user first designates the content identifier Icnt and the usage rule Ccnt through operation of the device 21b. The device 21b responsively generates a setting request Drrb, and transmits it to the rights management unit 11 (FIG. 8; step S11). Compared with the setting request Drra, the setting request Drrb includes, instead of the device identifier Idva, a device identifier Idvb for its unique specification. This is the only difference, and thus no detailed description is given. If the device 21b previously knows that the rights DB 114 carries any rights record Rdgt available therefor, generated thereby may be the setting request Drrb including no usage rule Ccnt.

In the rights management unit 11 (see FIG. 2), the user authentication section 116 receives from the device 21b the setting request Drrb through the communications section 115. Then, the user authentication process is executed to see whether the device 21b belongs to the user β (step S12). Only when the user authentication worked out, the setting request Drrb is forwarded to the rights management section 117.

If the rights management section 117 acknowledges that the currently received information is the setting request Drrb, the procedure goes to step S13. Instep S13, the rights management section 117 determines whether the rights DB 114 (see FIG. 7B) carries a rights record Rrgt including the device identifier Idva and the content identifier Icnt, both of which are those in the setting request Drrb (step S131). As described above, responding to the setting request Drra coming from the device 21a, the rights DB 114 carries such a rights record Rrgt including the device identifier Idvb and the content identifier Icnt. In this case, the rights management section 117 forwards the setting request Drrb to the content management section 118 without going through steps S132 and S133.

After receiving the setting request Drrb, the content management section 118 reads the content data Dcnt and the encryption key Ke (step S14), and forwards those to the content encryption section 119. The setting request Drrb is also forwarded to the transmission data generation section 120. The content encryption section 119 goes through a process for encrypting the content data Dcnt (step S15). After completing such an encryption process, the encrypted content data Decnt and the setting request Drrb are forwarded to the transmission data generation section 120.

The transmission data generation section 120 then generates transmission data Dtrnb (see FIG. 9B) in a similar manner to the above (step S16). Compared with the transmission data Dtrna, the transmission data Dtrnb includes the device identifier Idvb instead of the device identifier idva. This is the only difference therebetween, and thus no detailed description is given. After step S16, the transmission data generation section 120 forwards the resulting transmission data Dtrnb to the communications section 115, from which the transmission data Dtrnb is transmitted to the device 21a (step S17).

In the device 21b (see FIG. 4), the communications section 213 receives the transmission data Dtrnb (step S18), from which the transmission data Dtrnb is forwarded to the content management section 214. The content management section 214 stores, in the content storage 215, the content identifier Icnt and the encrypted content data Decnt found in the received data Dtrnb (step S19).

In view of digital rights protection, similarly to the device 21a, the content data Dcnt does not become available for the device 21b without the license information Dlcb to be provided by the rights management unit 11. Referring now to FIGS. 11 to 13, described now are the operations of the device 21b and the rights management unit 11 at the time of acquisition of the license information Dlca, and decryption of the content data Dcnt. The operations are almost the same as those of the device 21a and the rights management unit 11, and thus not described in detail.

First of all, through operation of the device 21b, the user β specifies which decrypting content data Decnt in the content storage 215 he or she wants. In the device 21, the issue request generation section 216 responsively generates such an issue request Dirb as shown in FIG. 14A, and transmits it to the rights management unit 11 (FIG. 11; step S21). Compared with the issue request Dira, the issue request Dirb includes the device identifier Idvb instead of the device identifier Idva. There is no other difference therebetween, and thus no detailed description is given. The issue request generation section 216 forwards such an issue request Dirb to the communications section 213, from which the issue request Dirb is transmitted to the rights management unit 11.

In the rights management unit 11, the user authentication section 116 (see FIG. 2) receives the issue request Dirb coming from the device 2b via the communications section 115, and then goes through the user authentication process (step S22). Only when the user authentication worked out, the user authentication section 116 forwards the received issue request Dirb to the rights management section 117. The rights management section 117 extracts from the received issue request Dirb the device identifier Idvb and the content identifier Icnt (step S23). Then the rights DB 114 (see FIG. 7B) is referred to see whether it carries a rights record Rrgt including the same set as the extracted device identifier Idvb and content identifier Icnt (step S24).

If determined “Yes” in step S24, the rights management section 117 refers to the rights information Drgt included in thus found rights record Rrgt to determine whether the device 21b is qualified for permission, i.e., whether the right to use the content data Dcnt is still available (step S25). If determined “Yes” in step S25, the rights management section 117 generates permission information Dlwb using the rights information Drgt (step S26). Compared with the permission information Dlwa, the device identifier Idvb is included instead of the device identifier Idva. This is the only difference therebetween, and thus no further description is given. After step S26, the rights management section 117 updates the rights information Drgt by the amount used in step S26 (step S27).

The rights management section 117 (see FIG. 2) forwards such permission information Dlwb to the license information generation section 121 together with the issue request Dirb. In the license information generation section 121, the hash value generation section 1211 (see FIG. 3) assigns the received permission information Dlwb to a previously-held hash function f(x), and generates a hash value Vhsb (step S28). The hash value Vhsb is a protection measure against tampering with the permission information Dlwb. Such a hash value Vhsb is forwarded to the license information assembly section 1212.

The license information assembly section 1212 forwards the received issue request Dirb to the decryption key management section 122 (see FIG. 2), in which the aforementioned decryption key DB 112 (see FIG. 6B) is managed. From the received issue request Dirb, the content identifier Icnt and the device identifier Idva are extracted. The decryption key management section 122 then retrieves from the decryption key DB 112 the decryption key Kd in the same set as the content identifier Icnt, and forwards it to the decryption key encryption section 123 together with the device identifier Idvb. The decryption key encryption section 123 encrypts the decryption key Kd using the device identifier Idvb accompanied therewith (step S29), so that the encrypted decryption key Kedb is generated. Such an encrypted decryption key Kedb and the device identifier Idvb are forwarded to the license information assembly section 1212.

After receiving all the issue request Dirb, the permission information Dlwb, the hash value Vhsb, and the encrypted decryption key Kedb, the license information assembly section 1212 starts generating such license information Dlcb as shown in FIG. 14B (FIG. 12; step S210). Compared with the license information Dlca, the license information Dlcb includes the device identifier Idvb, the permission information Dlwb, the encrypted decryption key Kedb, and the hash value Vhsb, instead of the device identifier Idva, the permission information Dlwa, the encrypted decryption key Keda, and the hash value Vhsa. There is no other difference therebetween, and thus no detailed description is given. Such license information Dlcb is transmitted to the device 21b through the communications section 115 and the transmission path 31 (step S211).

In the device 21b (see FIG. 4), the communications section 213 receives the license information Dlcb coming over the transmission path 31 (step S212), and forwards it to the license information processing section 217. Therein, the tampering determination section 2171 extracts from the received license information Dlcb the permission information Dlwb and the hash value Vhsb (step S213). The extracted permission information Dlwb is forwarded to the hash value generation section 2172, while the hash value Vhsb is held as the external hash value Vehsb. The hash value generation section 2172 holds the same hash function f(x) as that on the rights management unit 11 side. The received permission information Dlwb is assigned to the hash function f(x) so that the internal hash value Vlhsa is generated (step S214). The resulting internal hash value Vlsha is returned to the tampering determination section 2171.

After receiving the internal hash value Vlhsb, the tampering determination section 2171 determines, in a similar manner to the above, the coincidence between the internal and external hash values Vlhsb and Vehsb (step S215). If determined as coinciding, the tampering determination section 2171 regards the current permission information Dlwb is effective, and thus forwards the license information Dlcb to the permission determination section 2173. Similarly to the above, the permission determination section 2173 determines whether the decrypting content data Decnt is allowed for use (step S216). Only with “Yes”, the encrypted decryption key Kedb is extracted from the license information Dlcb, and transmitted to the decryption key decryption section 2174. After receiving the decryption key Kedb from the permission determination section 2173, the decryption key decryption section 2174 retrieves the device identifier Idvb from the device identifier storing section 211. Then, the encrypted decryption key Kedb is decrypted using the device identifier Idvb (step S217), and the resulting decryption key Kd is forwarded to the content decryption section 218.

The content management section 214 retrieves the content data Decnt to be currently decrypted from the content storage 215 (step S218), and forwards it to the content decryption section 218. The content decryption section 218 then decrypts the decrypting content data Decnt using the decryption key Kd provided by the decryption key decryption section 2174 (step S219). The resulting content data Dcnt is forwarded to the content reproduction section 219, in which the content data Dcnt is reproduced for audio output (step S220).

As such, in the present embodiment, the rights record Rrgt has a plurality of device identifiers Idva and Idvb recorded thereon. This enables the rights management unit 11 to correctly respond to the issue requests Dira and Dirb coming from each different devices 21a and 21b only by referring to such a rights record Rrgt, thereby providing those with the license information Dlca and Dlcb generated from the same rights information Drgt. Thus, successfully provided by the present embodiment is the rights management technology with which a plurality of devices can share the same digital rights.

Note that, in the present embodiment, the rights record Rrgt is including the group identifier Igp for explicitly indicating that the devices 21a and 21b belong to the same group. That is, the group identifier Igp is not necessarily provided to the rights record Rrgt. As a possibility, the rights record Rrgt may include only the group identifier Igp, without the device identifiers Idva and Idvb, to identify the devices 21a and 21b included in the same group.

In the above, the devices 21 are exemplified by two devices 21a and 21b. Alternatively, three or more of the devices may share the same rights information Drgt.

Further, the rights management unit 11 is assumed above as including the content DB 111 due to space limitation. The content data Dcnt is surely distributed from any other server to the devices 21a and 21b.

Still further, the rights information Drgt is assumed as shared by the devices 21a and 21b, both of which are registered in the user information DB 113 at the time of contract signing. However, the user β may want to use any other units 21, e.g., those newly purchased after contract signing, to use the content data Dcnt. To meet such a need, provided are the following rights management units 11a to 11d, which are first to fourth modified examples of the aforementioned rights management unit 11.

### FIRST MODIFIED EXAMPLE

FIG. 15 is a block diagram showing the entire structure of a license information management system Sa1 in which a rights management unit 11a is incorporated. Compared with the license information management system Sa of FIG. 1, the license information management system Sa1 of FIG. 15 includes the rights management unit 11a instead of the rights management unit 11, and further includes a device 21c. These are the only differences therebetween, and thus any constituent in FIG. 15 identical to that of FIG. 1 is provided with the same reference numeral and not described again. Here, FIG. 15 shows a communications cable 32, which is referred to only in the fourth modified example. Thus no description is given in the first to third modified examples.

The rights management unit 11a is placed on the provider a side. Compared with the rights management unit 11, a user information management section 124, and a registration completion generation section 125 are further included. There is no other difference therebetween. Thus, in FIG. 16, any constituent being identical to that of FIG. 2 and having no relevancy to the present modified example is not shown nor described below.

The device 21c belongs to the user β but not yet registered in the user information DB 113 of the rights management unit 11a. As shown in FIG. 17, compared with the devices 21a and 21b of FIG. 4, the device 21c further includes a registration request generation section 220 and a group identifier storing section 221. These are the only differences thereamong, and thus in FIG. 17, any constituent of being identical to that of FIG. 4 and having no relevancy to the present modified example is not shown nor described below. Assuming here that the device identifier storing section 211 of the device 21c previously stores a device identifier Idvc for unique specification of the device 21c, while the group information storing section 221 stores a group identifier Igp assigned to the user β.

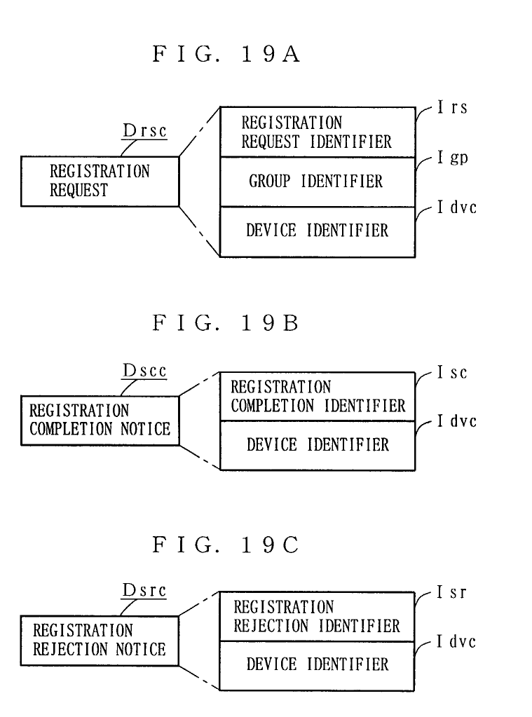

Referring to FIG. 18, in the license information management system Sa1 structured as such, described next are the operations of the device 21c and the rights management unit 11a to register the device 21c to the user information DB 113. First of all, in response to the user β's operation, the device 21c stores the group identifier Igp notified by the provider α into the group identifier storing section 221. The user β then operates the device 21c to designate that the device 21c is to be registered in the user information DB 113. In the device 21c, the registration request generation section 220 responsively generates such a registration request Drsc of FIG. 19A, and transmits it to the rights management unit 11a (FIG. 18; step S31). The registration request Drsc is information for requesting the rights management unit 11a to register the device 21c in the user information DB 113. More in detail, instep S31, the registration request generation section 220 retrieves the device identifier Idvc from the device identifier storing section 211, and from the group identifier storing section 211 the group identifier Igp. Then, to the set of thus extracted group identifier Igp and the device identifier Idvc, a previously-held registration request identifier Irs is added so that the registration request Drsc (see FIG. 19A) is generated. Here, the registration request identifier Irs is used by the rights management unit 11a to identify the registration request Drsc. The registration request Drsc is then forwarded to the communications section 213, from which the registration request Drsc is transmitted to the rights management unit 11a over the transmission path 31.

In the rights management unit 11a (see FIG. 16), the communications section 115 receives the information coming over the transmission path 31. Because of the registration request identifier Irs included therein, the currently received information is acknowledged as being the registration request Drsc. As acknowledged as such, the communications section 115 forwards the registration request Drsc to the user information management section 124. Therein, the group identifier Igp is extracted from the registration request Drsc, and then the user information DB 113 is accessed for searching the licensee record Rcs (see FIG. 7A) including the extracted group identifier Igp (step S32). The user information management section 124 then extracts the device identifier number Ndv from thus found licensee record Rcs (step S33).

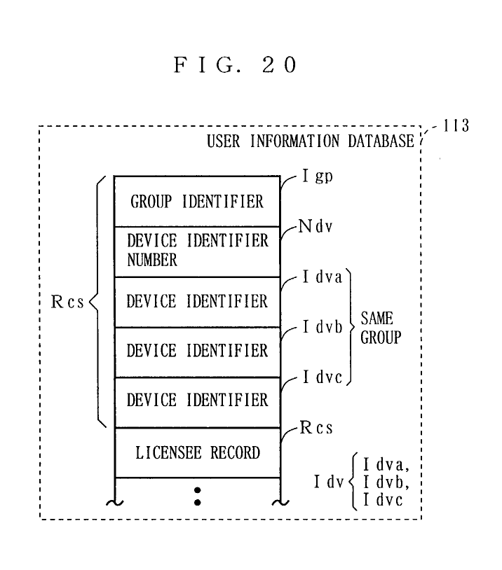

Next, the user information management section 124 determines whether the extracted device identifier number Ndv is a predetermined maximum value Vul or larger (step S34). Here, the maximum value Vul indicates how many units, at the maximum, the user β is allowed to register in the user information DB 113. If determined “No” in step S34, the user information management section 124 extracts from the received registration request Drsc the device identifier Idvc, and adds it to the licensee record Rcs (step S35). The user information management section 124 then increments by 1 the device identifier number Ndv (step S36). As a result, the licensee record Rcs of FIG. 7A is updated to be the one shown in FIG. 20. The user information management section 124 then notifies the registration completion generation section 125 that the licensee record Rcs has been correctly updated, and the device identifier Idvc in the registration request Drsc is forwarded to the registration completion generation section 125.

After notified as the licensee record Drsc has been updated, the registration completion generation section 125 generates such a registration completion notice Dscc as shown in FIG. 19B, and transmits it to the device 21c (step S37). Here, the registration completion notice Dscc is information for notifying the device 21c that its registration into the user information DB 113 is now completed. More in detail, in step S37, the registration completion registration section 125 first adds a previously-held registration completion identifier Isc to the device identifier Idvc provided by the user information management section 124, so that the registration completion notice Dscc (see FIG. 19B) is generated. Here, the registration completion identifier Isc is used by the device 21c to identify the registration completion notice Dscc. The registration completion generation section 125 then forwards the registration completion notice Dscc to the communications section 115, from which the registration completion notice Dscc is transmitted to the device 21c over the transmission path 31.

In the device 21c (see FIG. 17), the communications section 213 receives the information coming over the transmission path 31, and from the registration completion identifier Isc included therein, acknowledges that the received information is the registration completion notice Dscc. As acknowledged as such, the received registration completion notice Dscc is forwarded to the setting request generation section 212. The setting request generation section 212 acknowledges as having received the registration completion notice by referring to the registration completion identifier Isc set to the received information (step S38). As acknowledged as s such, the setting request generation section 212 determines that it is time to execute step S11 of FIG. 8, and thereafter, performs data communications with the rights management unit 11a in a similar manner to the device 21a or 21b in the first embodiment.

As such, in the first modified example, through data communications between the rights management unit 11a and the user β's new device 21c, the device identifier of the device 21c can be registered in the user information DB 113. Therefore, the resulting license information management system Sa1 becomes better in usability.

In step S34, if the device identifier number Ndv is determined as being the maximum value Vul or larger, the user information management section 124 notifies, without going through steps S35 and S36, the registration completion generation section 125 that the licensee record Rcs is rejected for update. Then, the device identifier Idvc in the registration request Drsc is forwarded to the registration completion generation section 125. In response to the update rejection, the registration completion generation section 125 generates such a registration rejection notice Dsrc as shown in FIG. 19C, and transmits it to the device 21c through the communications section 213 and the transmission path 31 (step S39). Here, the registration rejection notice Drsc is information for notifying the device 21c that it is not registered in the user information DB 113, and includes the device identifier Idvc provided by the user information management section 124, and the previously-held registration rejection identifier Isr. In the device 21c (see FIG. 17), the setting request generation section 212 receives the registration rejection notice Dsrc via the communications section 213 (step S310), and accordingly determines that it is not time to execute step S11 of FIG. 8, and terminates the procedure.

In step S32, if failing in finding the licensee record Rcs (see FIG. 7A) including the extracted group identifier Igp, the user information management section 124 preferably goes through the same process as step S39 to refuse registration of the device identifier Idvc to the user information DB 113.

In the above first modified example, through data communications between the device 21c and the rights management device 11a, the device identifier Idvc is registered in the user information DB 113. This is not restrictive, and as the second to fourth modified examples below, the device 21c may work together with the device 21a or 21b to register the device identifier Idvc into the user information DB 113.

### SECOND MODIFIED EXAMPLE

Described next is the entire structure of a license information management system Sa2 including a rights management unit 11b according to a second modified example. Compared with the license information management system Sa of FIG. 1, the license information management system Sa2 of FIG. 15 includes the rights management unit 11b instead of the rights management unit 11, and further includes the device 21c. These is no other difference therebetween, and thus any constituent in FIG. 15 identical to that of FIG. 1 is provided with the same reference numeral and not described again.

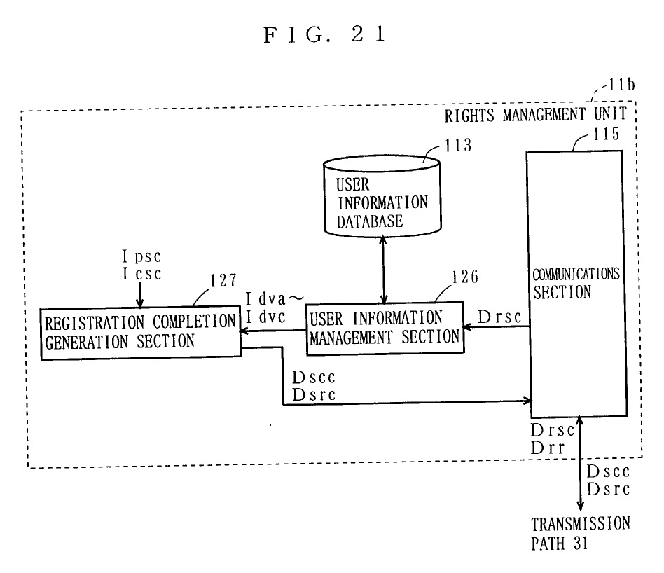

The rights management unit 11b is placed on the provider a side. As shown in FIG. 21, compared with the rights management unit 11 of FIG. 2, a user information management section 126, and a registration completion generation section 127 are further included. There is no other difference therebetween, and thus in FIG. 21, any constituent being identical to that of FIG. 2 and having no relevancy to the present modified example is not shown nor described below.

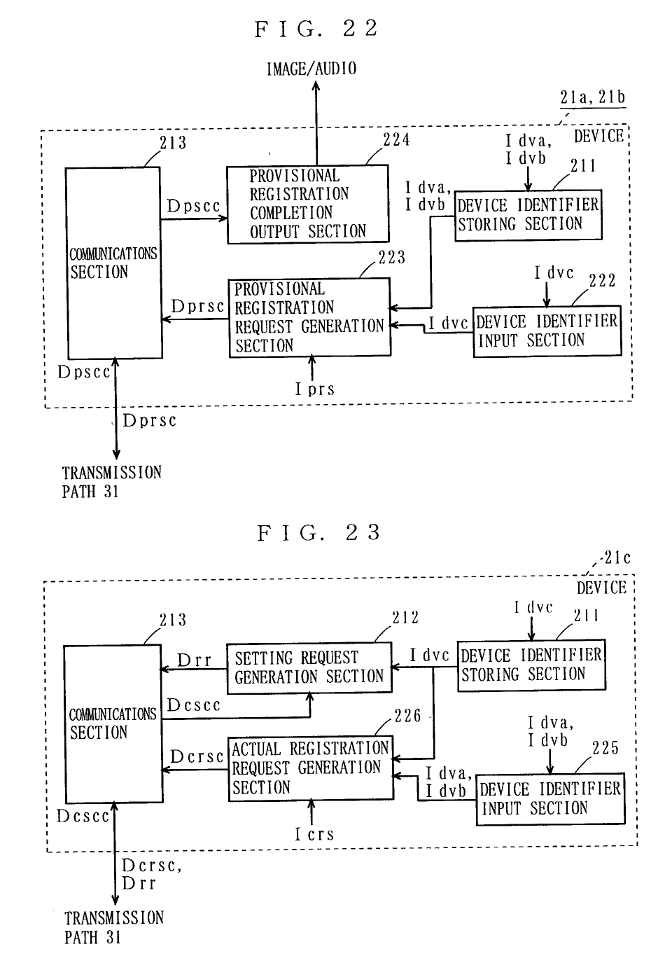

As described in the first embodiment, the device 21a or 21b belongs to the user β, and the user information DB 113 (see FIG. 7A) in the rights management unit 11b carries its corresponding device identifier Idva or Idvb. The device 21a or 21b of FIG. 22 further includes, compared with that of FIG. 4, a device identifier input section 222, a provisional registration request generation section 223, and a provisional registration completion output section 224. Those are provided for registering the device identifier Idvc of the device 21c. There is no other difference therebetween, and thus in FIG. 22, any constituent being identical to that of FIG. 4 and having no relevancy to the present modified example is not shown nor described below.

The device 21c belongs to the user β but not yet registered in the user information DB 113 of the rights management unit 11b. As shown in FIG. 23, compared with the device 21a or 21b of FIG. 4, the device 21c further includes a device identifier input section 225 and an actual registration request generation section 226. These are the only differences therebetween, and thus any constituent being identical to that of FIG. 4 and having no relevancy to the present modified example is not shown nor described below.

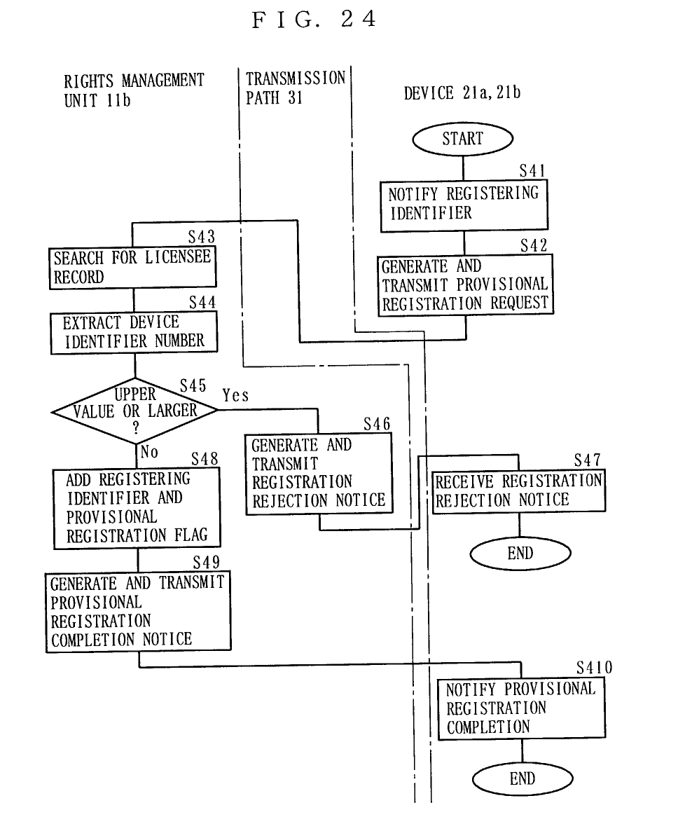

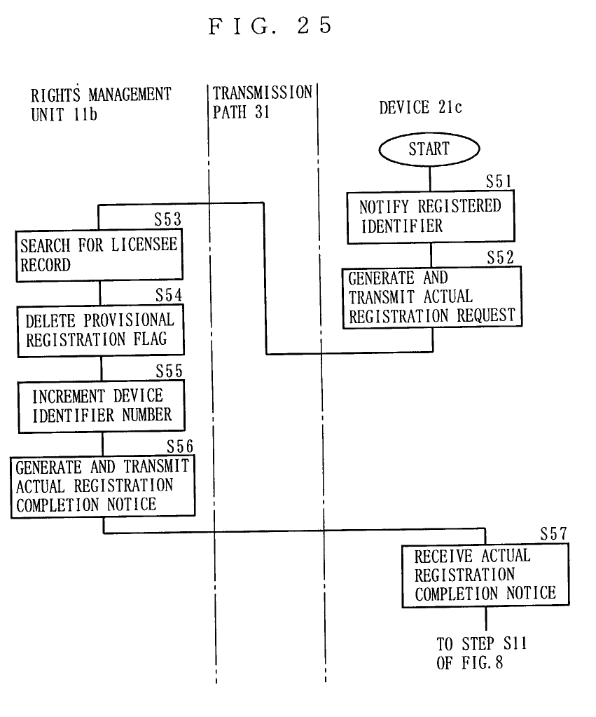

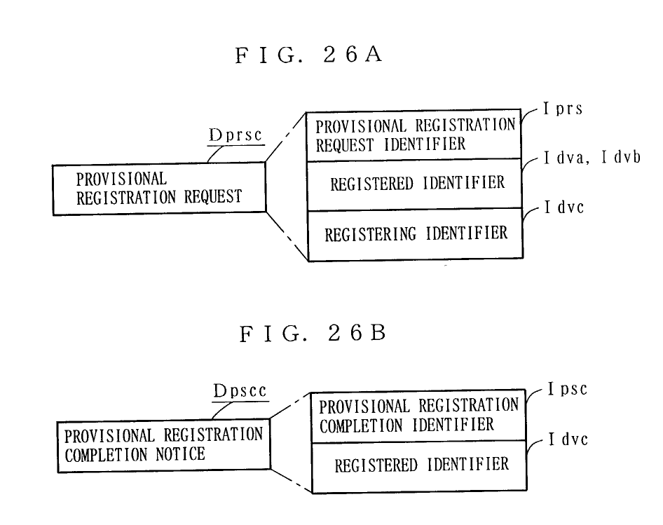

Referring to FIGS. 24 and 25, described next are the operations of the devices 21a and 21c, and the rights management unit 11b, in the license information management system Sa2 structured as above, to register the device identifier Idvc of the device 21c to the user information DB 113. Through operation of the device 21a, the user β designates that the device identifier Idvc is to be provisionally registered in the user information DB 113. The device identifier input section 222 of the device 21a responsively notifies thus designated device identifier Idvc to the provisional registration request generation section 223 (FIG. 24; step S41). Hereinafter, the device identifier Idvc of the device 21c is referred to as the registering identifier Idvc. The provisional registration request generation section 223 then generates such a provisional registration request Dprsc as shown in FIG. 26A, and transmits it to the rights management unit 11b (step S42). The provisional registration request Dprsc is information for requesting the rights management unit 11b to provisionally register the registering identifier Idvc in the user information DB 113. More in detail, in step S42, the provisional registration request generation section 223 first retrieves from the device identifier storing section 211 the device identifier Idva. The retrieved device identifier Idva is handled as the registered identifier Idva. To the set of the registered identifier Idva and the registering identifier Idvc, a previously-held provisional registration request identifier Iprs is added, so that the provisional registration request Dprsc (see FIG. 26A) is generated. Here, the provisional registration request identifier Iprs is used by the rights management unit 11b to identify the provisional registration request Dprsc. The provisional registration request Dprsc is provided to the communications section 213, from which the provisional registration request Dprsc is transmitted to the rights management unit 11b over the transmission path 31.

In the rights management unit 11b (see FIG. 21), the communications section 115 acknowledges as having received the provisional registration request Dprsc because of the provisional registration request identifier Iprs therein. As acknowledged as such, the communications section 115 forwards thus received provisional registration request Dprsc to the user information management section 126. The user information management section 126 then extracts from the received provisional registration request Dprsc the registered identifier Idva, and then accesses the user information DB 113 to search for a licensee record Rcs (see FIG. 7A) including thus extracted registered identifier Idva (Step S43). Then, the user information management section 126 executes the same processes as steps S33 and S34 of FIG. 18 (steps S44 and S45). If determined in step S45 that the device identifier number Ndv is not smaller than the maximum value Vul, the user information management section 126 executes the same process as step S39 of FIG. 18 (step S46). In this case, the device 21a goes through the process similar to step S310 of FIG. 18 (step S47).

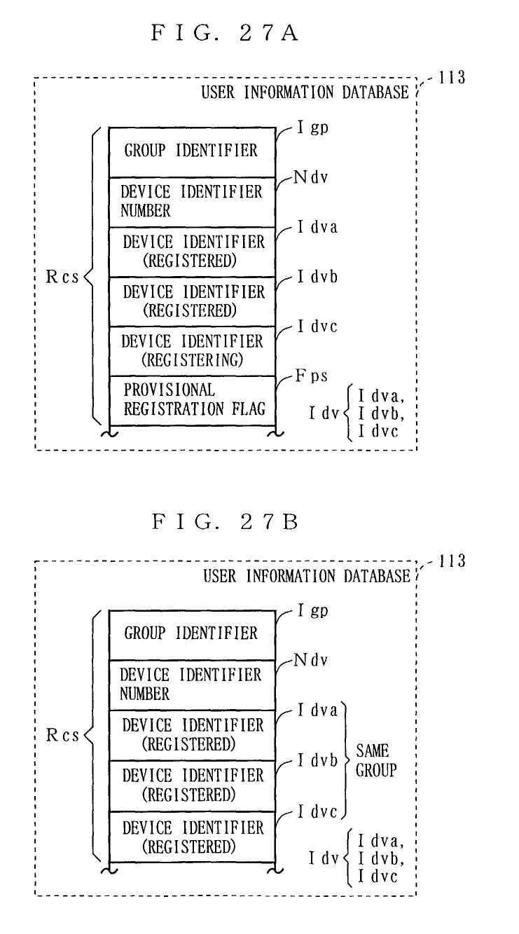

On the other hand, if determined in step S45 that the device identifier number Ndv is smaller than the maximum value Vul, the registering identifier Idvc is extracted from the provisional registration request Dprsc. Then, the registering identifier Idvc is added to the licensee record Rcs together with, for its indication, the corresponding provisional registration flag Fps. The licensee record Rcs of FIG. 7A is updated to be the one shown in FIG. 27A. Thereafter, the user information management section 126 notifies the registration completion generation section 127 that the registering identifier Idvc is now provisionally registered, and then the registered identifier Idva in the received provisional registration request Dprsc is forwarded to the registration completion generation section 127.

After notified as having completed with the provisional registration, the registration completion generation section 127 generates such a provisional registration completion notice Dpscc as shown in FIG. 26B, and transmits it to the device 21a (step S49). The provisional registration completion notice Dpscc is information for notifying the device 21a that the registering identifier Idvc is now provisionally registered in the user information DB 113. More in detail, in step S48, the registration completion generation section 127 first adds a previously-held provisional registration identifier Ipsc to the registered notice Idva provided by the user information management section 126, so that the provisional registration completion identifier Dpscc (see FIG. 26B) is generated. Here, the provisional registration completion identifier Ipsc is used by the device 21a to identify the provisional registration completion notice Dpscc. Such a provisional registration completion notice Dpscc is transmitted from the registration completion generation section 127 to the device 21a through the communications section 115 and the transmission path 31.

In the device 21a (see FIG. 22), the communications section 213 acknowledges that the currently received information is the provisional registration completion notice Dpscc addressed thereto because of the provisional registration completion identifier Ipsc and the registered identifier Idva included therein. As acknowledged as such, the communications section 213 forwards the received provisional registration completion notice Dpscc to the provisional registration completion output section 224. The provisional registration completion output section 224 responsively notifies the user β, by image or audio output, that the device identifier Idvc is now completed with the provisional registration (step S410). This is the end of the procedure on the device 21a side.

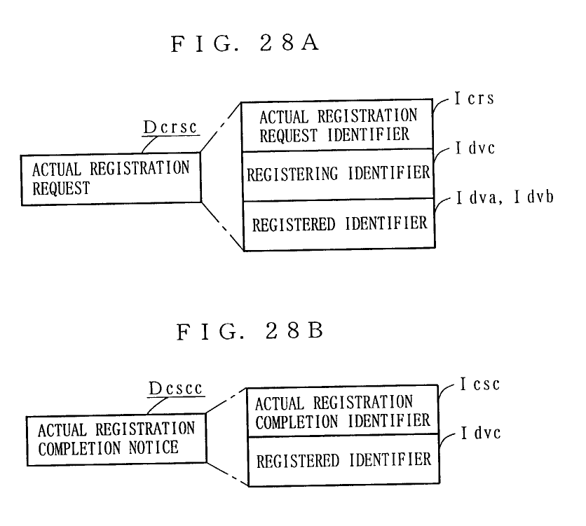

After acknowledging that the provisional registration is now through, the user β operates the device 21c to designate that the device identifier Idvc is to be actually registered into the user information DB 113. The device identifier input section 225 of the device 21c responsively notifies the actual registration request generation section 226 of the user-designated device identifier (registered identifier) Idva of the device 21a (FIG. 25; step S51). The actual registration request generation section 226 then generates such an actual registration request Dcrsc as shown in FIG. 28A, and transmits it to the rights management unit 11b (step S52). Here, the actual registration request Dcrsc is information for requesting the rights management unit 11b to actually register the device identifier Idvc in the user information DB 113. More in detail, in step S52, the actual registration request generation section 226 first retrieves the device identifier (i.e., registering identifier) Idvc from the device identifier storing section 211. Then, to the set of the retrieved registering identifier Idvc and the notified registered identifier Idva, a previously-held actual registration request identifier Icrs is added, so that the actual registration request Dcrsc is generated (see FIG. 28A). Here, the actual registration request identifier Icrs is used by the rights management unit 11b to identify the actual registration request Dcrsc. The actual registration request generation section 226 transmits such an actual registration request Dcrsc to the rights management unit 11b through the communications section 213 and the transmission path 31.

In the rights management unit 11b (see FIG. 21), the communications section 115 acknowledges as having received the actual registration request Dcrsc because of the actual registration request identifier Icrs included therein. As acknowledged as such, the actual registration request Dcrsc is forwarded to the user information management section 126, in which the device identifiers Idva and Idvb are both extracted from the actual registration request Dcrsc. Then, the user information management section 126 accesses the user information DB 113 to search for a licensee record Rcs (see FIG. 27A) including both of the extracted device identifiers Idva and Idvc (step S53). Then, the user information management section 126 deletes the provisional registration flag Fps from thus found licensee record Rcs (step S54), and then increments by 1 the device identifier number Ndv included therein (step S55). In this manner, the device identifier Idvc is actually registered, and as a result, the licensee record Rcs of FIG. 27A is updated to be the one shown in FIG. 27B. Then, the user information management section 126 notifies the registration completion generation section 127 that the registering identifier Idvc is now actually registered. Then the registering identifier Idvc in the received actual registration request Dcrsc is provided to the registration completion generation section 127.

After notified as having completed with the actual registration, the registration completion generation section 127 generates such an actual registration completion notice Dcscc as shown in FIG. 28B, and transmits it to the device 21c (step S56). The actual registration completion notice Dcscc is information for notifying the device 21c that the device identifier Idvc is now actually registered in the user information DB 113. More in detail, in step S56, the registration completion generation section 127 handles the registering identifier Idvc provided by the user information management section 126 as the registered identifier Idvc, and thereto, adds the previously-held actual registration completion identifier Icsc. Thus the actual registration completion notice Dcscc (see FIG. 28B) is generated. Here, the actual registration completion identifier Icsc is used by the device 21c to identify the actual registration completion notice Dcscc. The actual registration completion notice Dcscc is forwarded to the device 21c through the communications section 213 and the transmission path 31.

In the device 21c (see FIG. 23), the communications section 213 acknowledges that the currently received information is the actual registration completion notice Dcscc addressed thereto because of the actual registration completion identifier Icsc and the registering identifier Idvc included therein. As acknowledged as such, the communications section 213 forwards the received actual registration completion notice Dcscc to the setting request generation section 212. Because of the actual registration completion identifier Icsc included in the received information, the setting request generation section 212 acknowledges as having received the actual registration completion notice Dcscc (step S57). As acknowledged as such, the setting request generation section 212 determines that it is time to execute step S11 of FIG. 8, and thereafter, performs data communications with the rights management unit 11b similarly to the device 21a or 21b in the first embodiment.

In the first modified example, when additionally registering the device identifier Idvc into the licensee record Rcs of the user β, the rights management unit 11a remains unsure if the device 21c is really belonging to the user β. In the present modified example, on the other hand, the rights management unit 11b can easily know that the device 21c is belonging to the same user β as the device 21a. Such an interrelation between the devices 21a and 21c is successfully proved by setting the registered identifier Idva and the registering identifier Idvc to the provisional registration request Dprsc coming from the device 21a for provisional registration, and the registered identifier Idva and the registering identifier Idvc to the actual registration request Dcrsc coming from the device 21c for actual registration. As such, provided in the present modified example is such a license information management system Sa2 in which, at the time of additional registration of the device identifiers, devices 21 not belonging to the user β are hardly registered in the licensee record Rcs of the user β.

In the above, described is the exemplary case where the device 21a so operates as to additionally register the device identifier Idvc of the device 21c. Alternatively, the device 21b becomes able to get involved in such an additional registration of the device identifier Idvc by operating similarly to the device 21a.

### THIRD MODIFIED EXAMPLE

Described next is the entire structure of a license information management system Sa3 including a rights management unit 11b according to a third modified example. Compared with the license information management system Sa of FIG. 1, the license information management system Sa3 of FIG. 15 includes the rights management unit 11c instead of the rights management unit 11, and further includes the device 21c. These are the only differences therebetween, and thus any constituent in FIG. 15 identical to that of FIG. 1 is provided with the same reference numeral and not described again.

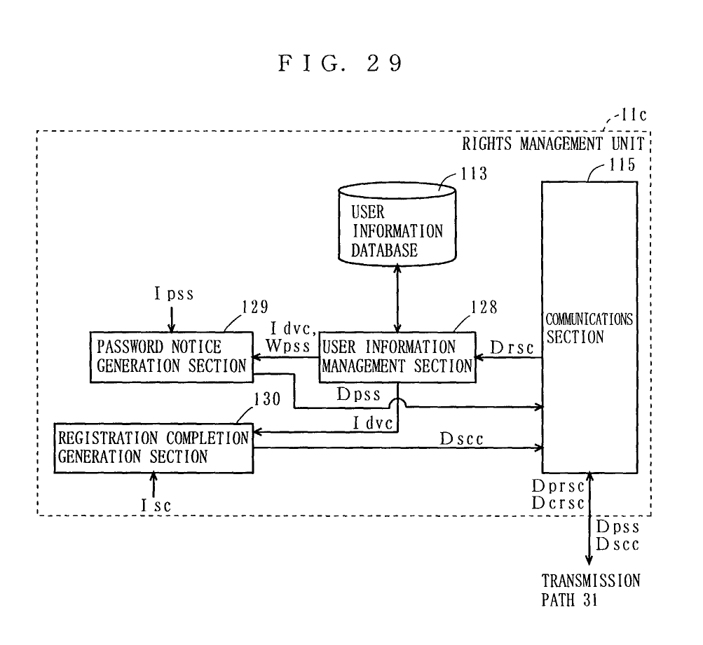

The rights management unit 11c is placed on the provider α side. As shown in FIG. 29, compared with the rights management unit 11 of FIG. 2, a user information management section 128, a password notice generation section 129, and a registration completion generation section 130 are further included. There is no other difference therebetween, and thus in FIG. 29, any constituent being identical to that of FIG. 2 and having no relevancy to the present modified example is not shown nor described below.

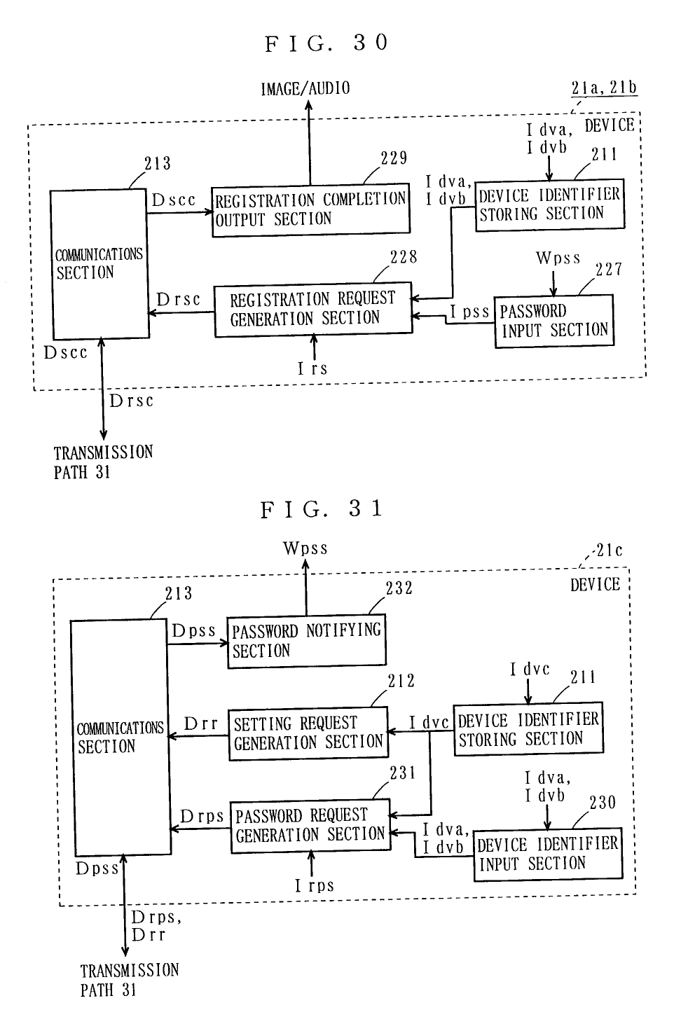

As already described in the first embodiment, the device 21a or 21b belongs to the user β, and the user information DB 113 of the rights management unit 11b carries its corresponding device identifier Idva or Idvb (see FIG. 7A). The device 21a or 21b of FIG. 30 further includes, compared with that of FIG. 4, a password input section 227, a registration request generation section 228, and a registration completion output section 229. Those are provided for registering the device identifier Idvc of the device 21c. There is no other difference therebetween, and thus in FIG. 30, any constituent being identical to that of FIG. 4 and having no relevancy to the present modified example is not shown nor described below.

The device 21c belongs to the user β but not yet registered in the user information DB 113 of the rights management unit 11c. As shown in FIG. 31, compared with the device 21a or 21b of FIG. 4, the device 21c further includes a device identifier input section 230, a password request generation section 231, and a password notifying section 232. There is no other difference therebetween, and thus in FIG. 31, any constituent being identical to that of FIG. 4 and having no relevancy to the present modified example is not shown nor described below.

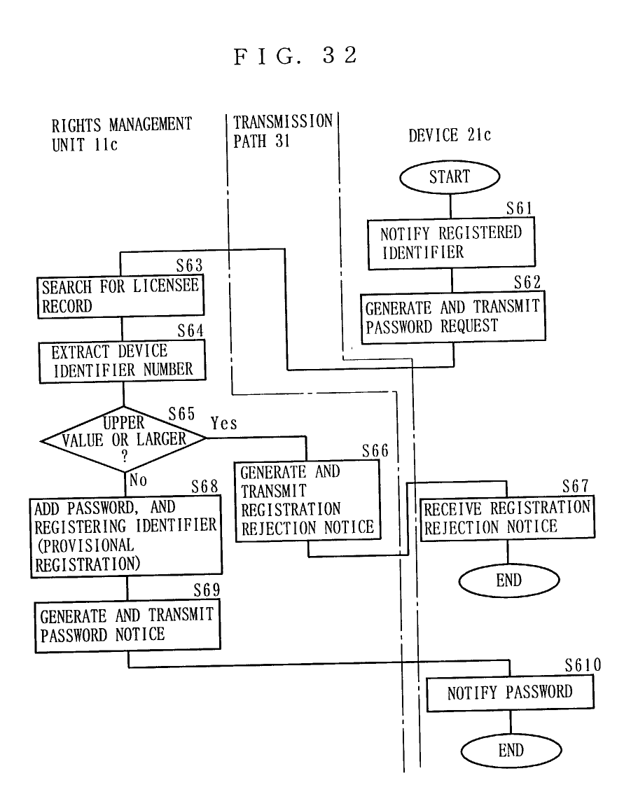

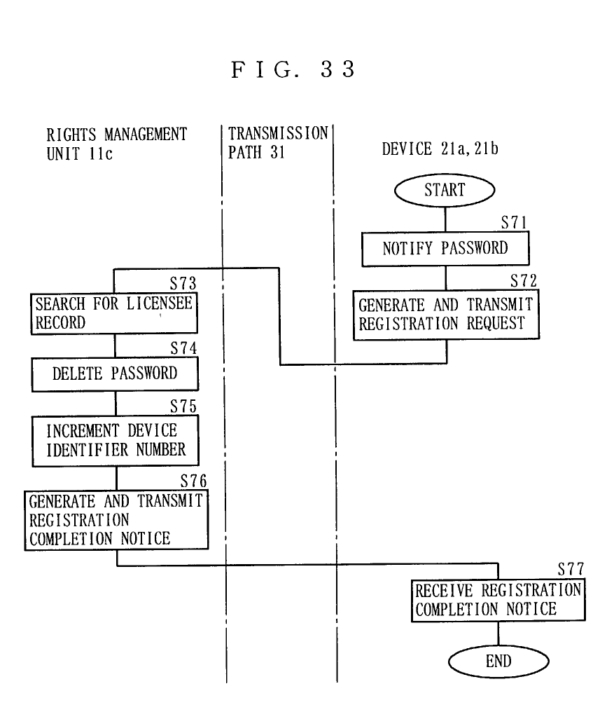

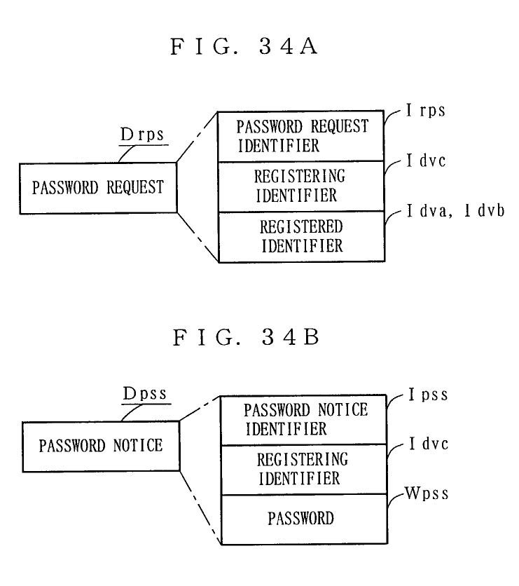

Referring to FIGS. 32 and 33, described next are the operations of the devices 21a and 21c, and the rights management unit 11c, in the license information management system Sa3 structured as such, to register the device identifier Idvc of the device 21c into the user information DB 113. Through operation of the device 21c, the user β designates that the device identifier Idvc is to be provisionally registered in the user information DB 113. In response, the device identifier input section 230 of the device 21c notifies thus user-designated device identifier (hereinafter, registered identifier) Idva to the password request generation section 231 (FIG. 32; step S61). The password registration request generation section 231 then responsively generates such a password request Drps as shown in FIG. 34A, and transmit it to the rights management unit 11c (step S62). The password request Drps is information for requesting the rights management unit 11c to issue a password Wpss needed to register the registering identifier Idvc into the user information DB 113. More in detail, in step S62, the password request generation section 231 first retrieves from the device identifier storing section 211 the registering identifier Idvc. To the set of thus retrieved registering identifier Idvc and the notified registered identifier Idva, a previously-held password request identifier Irps is added, so that the password request Drps (see FIG. 34A) is generated. Here, the password request identifier Irps is used by the rights management unit 11c to identify the password request Drps. The password request Drps is transmitted to the communications section 115 of the rights management unit 11c through the communications section 213 and the transmission path 31.

In the rights management unit 11c (see FIG. 29), the communications section 115 acknowledges as having received the password request Drps because of the password request identifier Irps included in the received information. As acknowledged as such, the communications section 115 forwards thus received password request Drps to the user information management section 128. The user information management section 128 then extracts the registered identifier Idva from the received password request Drps, and then accesses the user information DB 113 to search for a licensee record Rcs (see FIG. 7A) including thus extracted registered identifier Idva (Step S63). Then, the user information management section 128 executes the same processes as steps S33 and S34 of FIG. 18 (steps S64 and S65). If determined in step S65 that the device identifier number Ndv is the maximum value Vul or larger, the user information management section 126 executes the same process as step S39 of FIG. 18 (step S66). In this case, the device 21c goes through the process similar to step S310 of FIG. 18 (step S67).

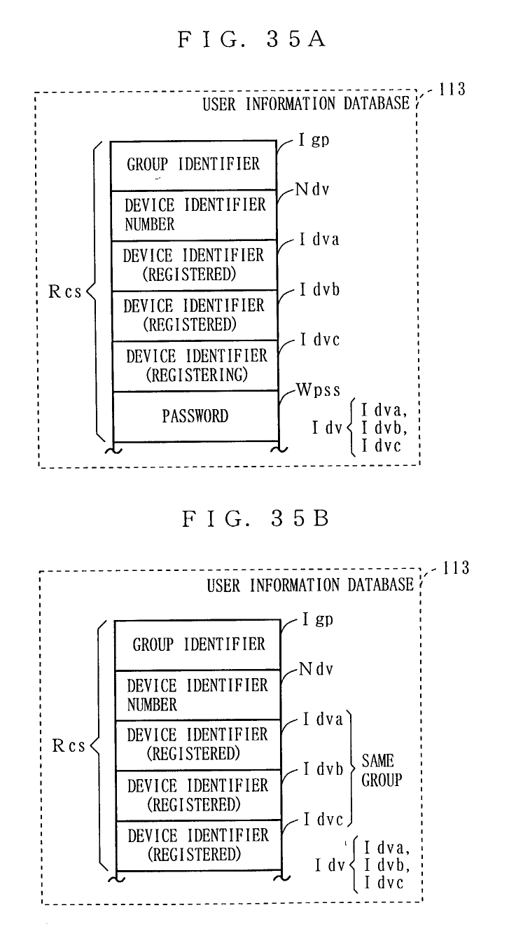

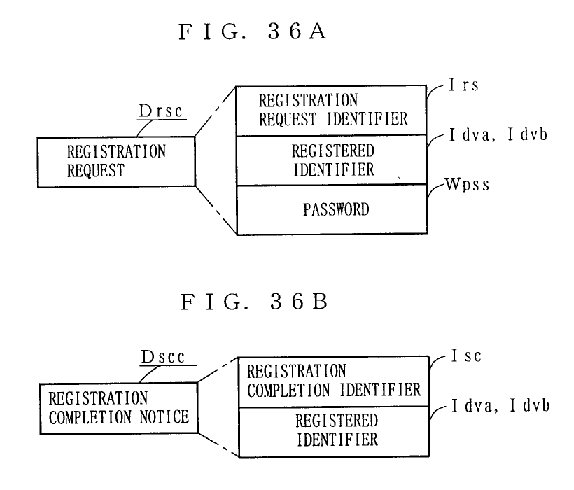

On the other hand, if determined in step S65 that the device identifier number Ndv is not the maximum value Vul or larger, the user information management section 128 goes through the process of step S68 so that the aforementioned password Wpss is generated. Here, it is preferable that the password Wpss is, typically, a combination of letters or symbols selected at random by the user information management section 128. The user information management section 128 then extracts the registering identifier Idvc from the received password request Drps, and the result and the generated password Wpss are added to the licensee record Rcs which is found in step S63 for provisional registration of the registering identifier Idvc (step S68). The licensee record Rcs of FIG. 7A is updated to be the one shown in FIG. 35A. Thereafter, the user information management section 128 notifies the password notice generation section 129 as having completed with the provisional registration of the registering identifier Idvc. Then the registering identifier Idvc in the received password request Dprs and the password Wpss generated in step S68 are both forwarded to the password notice generation section 129.

After notified as having completed with the provisional registration, the password notice generation section 129 generates such a password notice Dpss as shown in FIG. 34B, and transmits it to the device 21c (step S69). The password notice Dpss is information for notifying the device 21c of the password Wpss, which is generated for registering the registering identifier Idvc. More in detail, in step S69, to the set of the registering identifier Idvc and the password Wpss received from the user information management section 126, the password notice generation section 129 adds a previously-held password notice identifier Ipss, so that the password notice Dpss (see FIG. 34B) is generated. Here, the password notice identifier Ipss is used by the device 21c to identify the password notice Dpss. The password notice Dpss is transmitted from the password notice generation section 129 to the communications section 213 of the device 21c through the communications section 115 and the transmission path 31.

In the device 21c (see FIG. 31), the communications section 213 acknowledges as having received the password notice Dpss addressed thereto because of the password notice identifier Ipss and the registering identifier Idvc included therein. As acknowledged as such, the communications section 213 forwards the received password notice Dpss to the password notifying section 232. In response, the password notifying section 232 notifies the user β the password Wpss included in the password notice Dpss by image or audio output (step S610). This is the end of the procedure on the device 21c side. Here, in step S610, the password notifying section 232 may additionally notify the user β by image or audio that the registering identifier Idvc is now provisionally registered.

After acknowledging as the provisional registration is now through, the user β operates the device 21a to designate that the device identifier Idvc is to be actually registered in the user information DB 113. In response, the password input section 227 of the device 21a notifies the registration request generation section 228 of the user-designated password Wpss (FIG. 33; step S71). The registration request generation section 228 responsively generates such a registration request Drsc as shown in FIG. 36A, and transmits it to the rights management unit 11c (step S72). Here, the registration request Drsc is information for requesting the rights management unit 1c to actually register the registering identifier Idvc into the user information DB 113. More in detail, in step S72, the registration request generation section 228 first retrieves from the device identifier storing section 211 the device identifier (i.e., registered identifier) Idva. Then, to the set of the retrieved registered identifier Idva and the notified password Wpss, a previously-held actual registration request identifier Irs is added, so that the registration request Drsc (see FIG. 36A) is generated. Here, the registration request identifier Irs is used by the rights management unit 11c to identify the registration request Drsc. The registration request generation section 228 transmits such a registration request Drsc to the rights management unit 11c through the communications section 213 and the transmission path 31.

In the rights management unit 11c (see FIG. 29), the communications section 115 acknowledges as having received the registration request Drsc because of the registration request identifier Irs included therein. As acknowledged as such, the received registration request Drsc is forwarded to the user information management section 128, in which the registered identifier Idva and the password Wpss are extracted from the received registration request Drsc. Then, the user information management section 128 accesses the user information DB 113 to search for a licensee record Rcs (see FIG. 35A) including both the registered identifier Idva and the password Wpss (step S73). Then, from thus found licensee record Rcs, the user information management section 128 deletes the password Wpss (step S74), and then increments by 1 the device identifier number Ndv included therein (step S75). In this manner, the device identifier Idvc is actually registered, and as a result, the licensee record Rcs of FIG. 35A is updated as to be the one shown in FIG. 35B. Then, the user information management section 128 notifies the registration completion generation section 130 that the registering identifier Idvc is now actually registered. Then, the registered identifier Idva in the received actual registration request Drsc is provided to the registration completion generation section 130.

As notified as having completed with the actual registration, the registration completion generation section 130 generates such a registration completion notice Dscc as shown in FIG. 36B, and transmits it to the device 21a (step S76). The registration completion notice Dscc is information for notifying the device 21a that the device identifier Idvc is now actually registered in the user information DB 113. More in detail, in step S76, the registration completion generation section 130 adds, to the registered identifier Idva received from the user information management section 128, the previously-held registration completion identifier Isc. Thus the registration completion notice Dscc (see FIG. 36B) is generated. Here, the registration completion identifier Isc is used by the device 21a to identify the actual registration completion notice Dscc. The registration completion notice Dscc is forwarded to the communications section 213 of the device 21a through the communications section 115 and the transmission path 31.

In the device 21a (see FIG. 30), the communications section 213 acknowledges as having received the registration completion notice Dscc addressed thereto because of the registration completion identifier Isc and the registered identifier Idva included therein. As acknowledged as such, the communications section 213 forwards the received actual registration completion notice Dscc to the registration completion output section 229. Because of the registration completion identifier Isc included in the received information, the registration completion output section 229 acknowledges as having received the registration completion notice Dscc. The user β is then notified by image or audio output that the registering identifier Idvc is now actually registered (step S77). This makes the device 21c ready to execute step S11 of FIG. 8. Then, the device 21c similarly goes through, as required, the processes executed by the device 21a or 21b in the first embodiment so as to use the content data Dcnt.

According to the above third modified example, similarly to the second modified example, provided is such a license information management system Sa3 in which, at the time of additional registration of the device identifiers, devices 21 not belonging to the user β are hardly registered in the licensee record Rcs of the user β. This is achieved by the device 21a, which has been registered in the user information DB 113 of the unit management unit 11c, involving in registration of the device identifier Idvc of the device 21c, which is not yet registered.

In the above, described is the exemplary case where the device 21a so operates as to additionally register the device identifier Idvc of the device 21c. Alternatively, the device 21b becomes able to get involved in additional registration of the device identifier Idvc by operating similarly to the device 21a.

### FOURTH MODIFIED EXAMPLE

Described next is the entire structure of a license information management system Sa4 including a rights management unit 11d according to a fourth modified example. Compared with the license information management system Sa of FIG. 1, the license information management system Sa4 of FIG. 15 includes the rights management unit lid instead of the rights management unit 11, and further includes the device 21c. Also, the devices 21a and 21c are connected to each other over the communications cable 32 for communications therebetween. There is no other difference therebetween, and thus in FIG. 15, any constituent identical to that of FIG. 1 is provided with the same reference numeral and not described again.

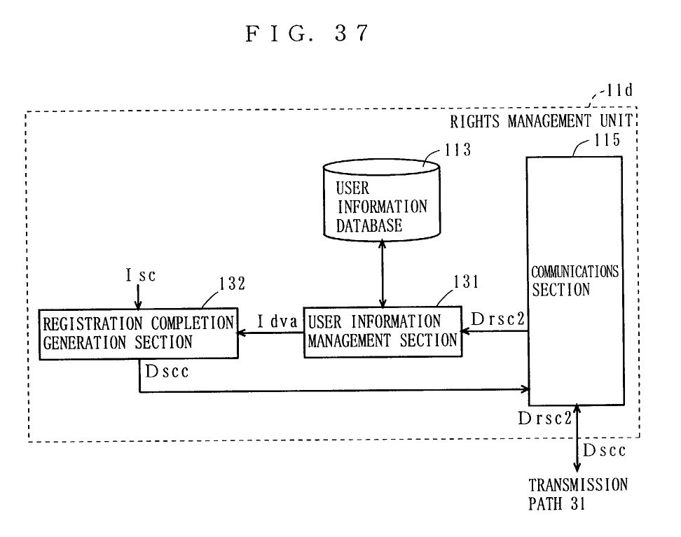

The rights management unit 11d is placed on the provider α side. As shown in FIG. 37, compared with the rights management unit 11 of FIG. 2, a user information management section 131, and a registration completion generation section 132 are further included. There is no other difference therebetween, and thus in FIG. 37, any constituent being identical to that of FIG. 2 and having no relevancy to the present modified example is not shown nor described.

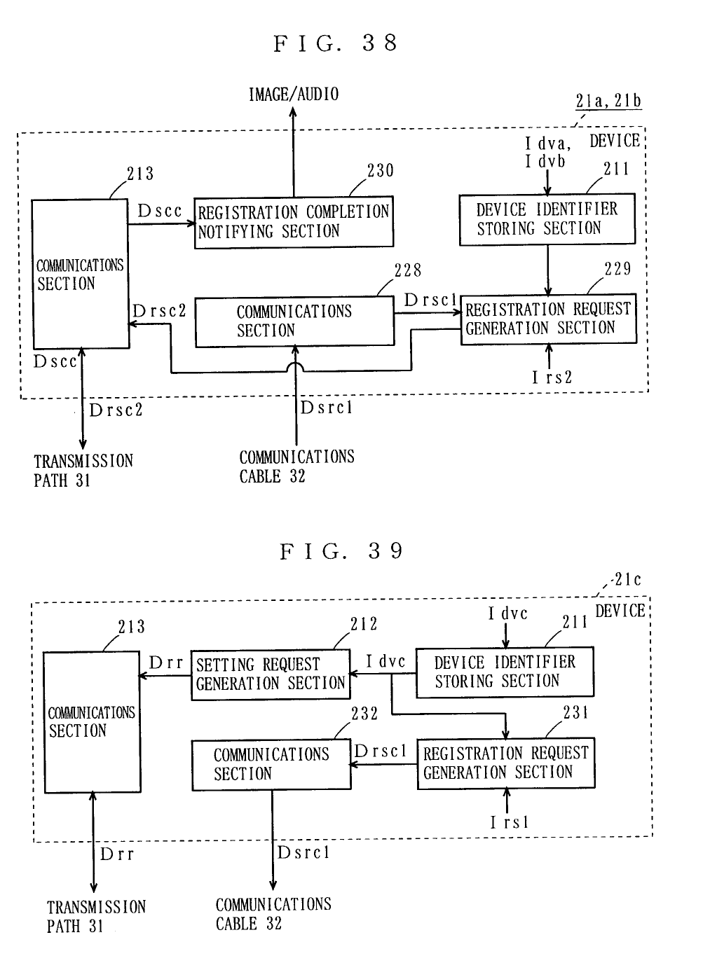

As described in the first embodiment, the device 21a or 21b belongs to the user β, and the user information DB 113 (see FIG. 7A) in the rights management unit lid carries its corresponding device identifier Idva or Idvb. The device 21a or 21b of FIG. 38 further includes, compared with that of FIG. 4, a communications section 228, a registration request generation section 229, and a registration completion notifying section 230. Those are provided for registering the device identifier Idvc of the device 21c. There is no other difference therebetween, and thus in FIG. 38, any constituent being identical to that of FIG. 4 and having no relevancy to the present modified example is not shown nor described below.

The device 21c belongs to the user β, but its device identifier Idvc is not yet registered in the user information DB 113 of the rights management unit 11d. As shown in FIG. 39, compared with the device 21a or 21b of FIG. 4, the device 21c further includes a registration request generation section 231, and a communications section 232. There is no other difference therebetween, and thus in FIG. 39, any constituent being identical to that of FIG. 4 and having no relevancy to the present modified example is not shown nor described below.

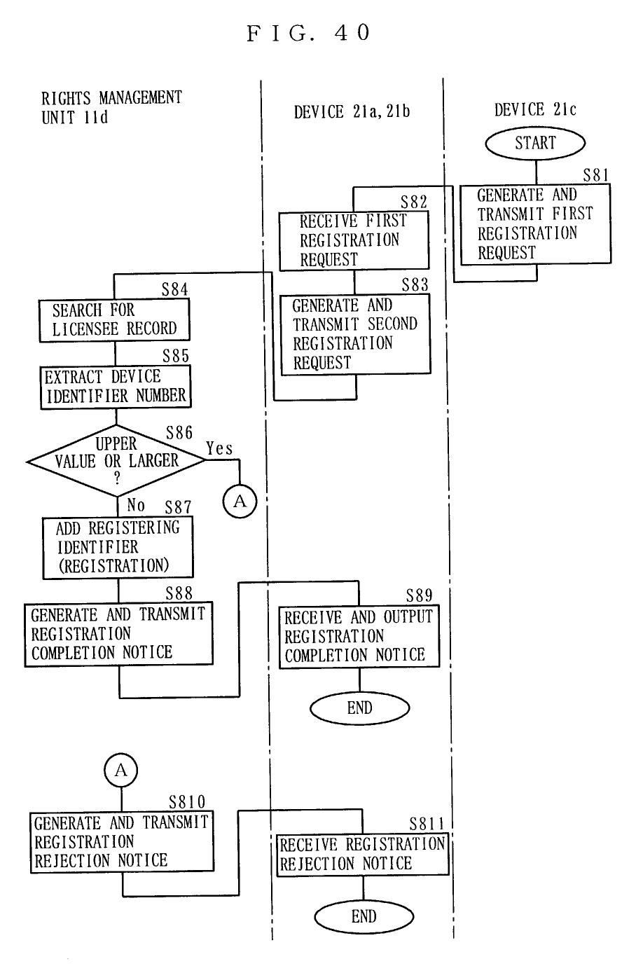

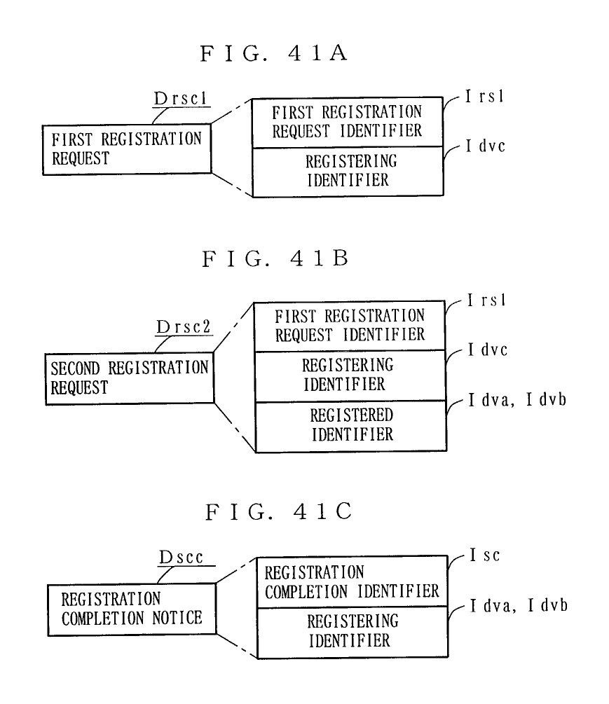

Referring to FIG. 40, described next are the operations of the devices 21a and 21c, and the rights management unit 11d, in the license information management system Sa4 structured as above, to register the device identifier Idvc of the device 21c to the user information DB 113. Through operation of the device 21c, the user β designates that the device identifier Idvc is to be registered into the user information DB 113. In response, the registration request generation section 231 of the device 21c generates such a first registration request Drsc1 as shown in FIG. 41A, and transmits it to the device 21a over the communications cable 32 (FIG. 40; step S81). Here, the first registration request Drsc1 is information for requesting the device 21a, instead of the device 21c, to register the registering identifier Idvc into the user information DB 113. More in detail, in step S81, the registration request generation section 231 first retrieves the device identifier (hereinafter, registering identifier) Idvc from the device identifier storing section 211, and to thus retrieved registering identifier Idvc, adds a previously-held first registration request identifier Irsl, so that the first registration request Drsc1 (see FIG. 41A) is generated. Here, the first registration request identifier Irsl is used by the device 21a to identify the first registration request Drsc1. The registration request generation section 231 transmits the first registration request Drsc1 to the device 21a through the communications section 232 and the transmission cable 32.

In the device 21a (see FIG. 38), the communications section 228 acknowledges as having received the first registration request Drsc1 because of the first registration request identifier Irsl included in the received information (step S82). As acknowledged as such, the first registration request Drsc1 is forwarded to the registration request generation section 229. In response, the registration request generation section 229 generates such a second registration request Drsc2 as shown in FIG. 41B, and transmits it to the rights management unit 11d over the communications path 31 (step S83). Here, the second registration request Drsc2 is information for requesting the rights management unit lid to register the registering identifier Idvc into the user information DB 113. More in detail, in step S83, the registration request generation section 229 first retrieves the device identifier (hereinafter, registered identifier) Idva from the device identifier storing section 211, and to the first registration request Drsc1, adds thus retrieved registered identifier Idva, so that the second registration request Drsc2 (see FIG. 41B) is generated. Here, in the second registration request Drsc2, the first registration request identifier Irsl is used by the rights management unit lid to identify the second registration request Drsc2. Such a second registration request Drsc2 is transmitted to the rights management unit lid (see FIG. 37) from the registration quest generation section 229 through the communications section 213 and the transmission path 31.

In the rights management unit 11d, the communications section 115 acknowledges as having received the second registration request Drsc2 by referring to the first registration request identifier Irs1 included in the information received over the transmission path 31. As acknowledged as such, the communications section 115 forwards thus received second registration request Drsc2 to the user information management section 131. Therein, the registered identifier Idva is extracted from the received second registration request Drsc2. The user information management section 131 then accesses the user information DB 113, and executes the same processes as steps S63 to S65 of FIG. 32 (steps S84 to S86). In step S86, if determined that the device identifier number Ndv is not the maximum value Vul or larger, the user information management section 131 extracts from the received second registration request Drsc2 the registering identifier Idvc, and adds it to the licensee record Rcs found in step S84 for registration of the registering identifier Idvc (step S87). In this manner, the licensee record Rcs of FIG. 7A is updated to be the one shown in FIG. 35A. Thereafter, the user information management section 131 notifies the registration completion generation section 132 that the registering identifier Idvc is now completely registered, and the registered identifier Idva in the received second registration request Drsc2 is forwarded to the registration completion generation section 132.

After notified as having completed with the registration, the registration completion generation section 132 generates such a registration completion notice Dscc as shown in FIG. 41C, and transmits it to the device 21a (step S88). The registration completion notice Dscc is information for notifying the device 21a that the registering identifier Idvc is now completely registered in the user information DB 113. More in detail, in step S88, the registration completion generation section 132 adds a previously-held registration identifier Isc to the registered identifier Idva received from the user information management section 131, so that the registration completion identifier Dscc (see FIG. 41C) is generated. Here, the registration completion identifier Isc is used by the device 21a to identify the registration completion notice Dscc. Such a registration completion notice Dscc is transmitted from the registration completion generation section 132 to the communications section 213 of the device 21a through the communications section 115 and the transmission path 31.

In the device 21a (see FIG. 38), the communications section 213 acknowledges as having received the registration completion notice Dscc addressed thereto because of the registration completion identifier Isc and the registered identifier Idva included therein. As acknowledged as such, the communications section 213 forwards the received registration completion notice Dscc to the registration completion notifying section 230. In response, the registration completion notifying section 230 notifies the user β, by image or audio output, that the registering identifier Idvc is now completely registered (step S610). The user β thus acknowledges that the device identifier Idvc of the device 21c is now registered, and the device 21c becomes ready to execute step S11 of FIG. 8. Then, the device 21c accordingly goes through, as required, the processes executed by the device 21a or 21b in the first embodiment to use the content data Dcnt.

In step S86, if the device identifier number Ndv is determined as being the maximum value Vul or larger, similarly to the preceding embodiment, transmitted from the rights management unit lid to the device 21a is the registration rejection notice Drsc (steps S810 and S811).

According to the fourth modified example, similarly to the second modified example, provided is such a license information management system Sa4 in which, at the time of additional registration of the device identifiers, units 21 not belonging to the user β are hardly registered in the licensee record Rcs of the user β. This is achieved by the device 21a, which has been registered in the user information DB 113 of the unit management unit 11d, involving in registration of the device identifier Idvc of the device 21c, which is not yet registered. Further, in this modified example, as is evident if comparing FIG. 40 with both FIGS. 32 and 33, the devices 21a and 21c are connected to each other over the cable 32 for communications therebetween, whereby the number of processes required for registration of the device identifier Idvc can be reduced.

In the above, described is the exemplary case where the device 21a so operates as to additionally register the device identifier Idvc of the device 21c. Alternatively, the device 21b becomes able to get involved in additional registration of the device identifier Idvc by operating similarly to the device 21a.

Also in the above, the communications cable 32 is used to connect the devices 21a and 21c together for communications therebetween. Alternatively, the devices 21a and 21c may wirelessly communicate with each other, or over the transmission path 31.

Further, in the above, the registration completion notice Dscc is transmitted from the rights management unit 11d to the device 21a. This is surely not restrictive, and the transmission destination may be the device 21c. Or, the registration completion notice Dscc may be first transmitted to the device 21a, and then transferred to the device 21c. In this case, the device 21c is in charge of notifying the user β of completion of registration by means of audio or image.

Still further, in the above second to fourth modified examples, described is the process for additionally registering the device identifier Idvc of the device 21c into the user information DB 113. The second to fourth modified examples are surely applicable to cases where two or more of the device identifiers Idv of the devices 21 are to be additionally registered.

In the second to fourth modified examples, the devices 21a and 21b are allowed, no matter which, to get involved in the additional registration of the device identifier Idvc. Alternatively, either the device 21a or 21b may be provided with such a capability as getting involved in the additional registration of the device identifiers Idv, and only the device with the capability may go through the additional registration.

Still further, in the above first to fourth modified examples, the user information DB 113 may include user information about the user β in addition to the information shown in FIG. 7A. If this is the case, the device 21a or 21b may transmit such user information inputted by the user β to the rights management units 11a to 11d when accessing thereto. The rights management units 11a to 11d then compare the received user information with another user information which is previously stored to determine whether the device 21c is really belonging to the same user β as the device 21a.

In the first embodiment, described is the exemplary case where the devices 21a and 21b, which are both registered in the user information DB 113 at the time of contract signing, as sharing the same rights information Drgt. However, the user β may want to delete the device identifier Idvb of the already-registered device 21b from the user information DB 113 and the rights DB 114. To meet such a need, provided is a following rights management unit 11e, which is a fifth modified examples of the aforementioned rights management unit 11.

### FIFTH MODIFIED EXAMPLE

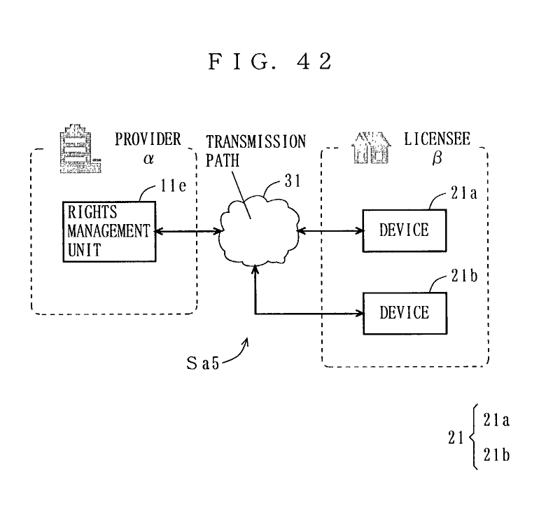

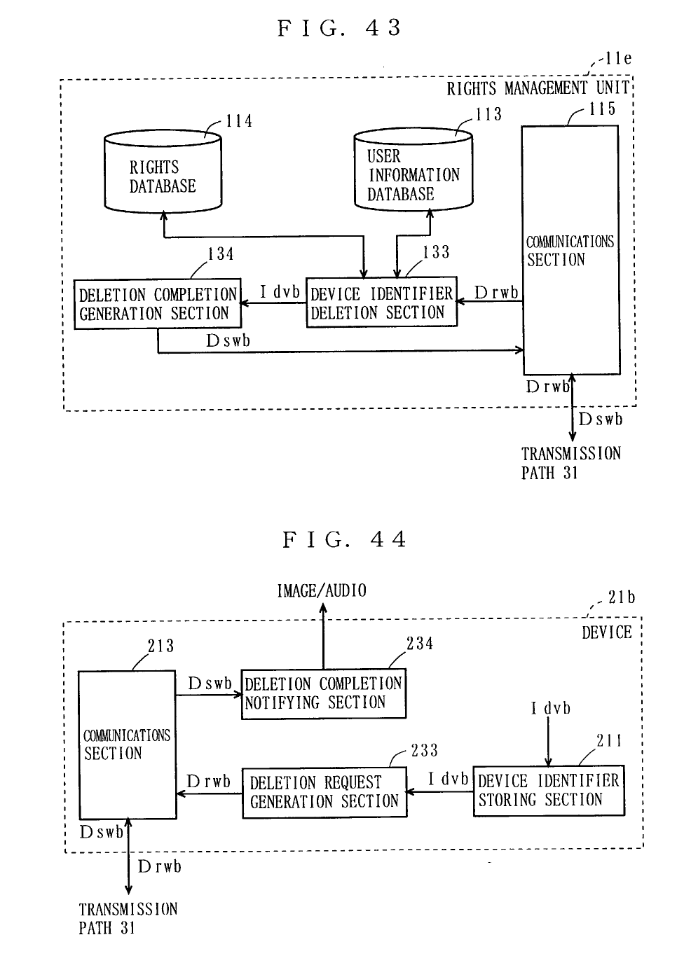

FIG. 42 is a block diagram showing the entire structure of a license information management system Sa5 in which a rights management unit 11e is incorporated. Compared with the license information management system Sa of FIG. 1, the license information management system Sa5 of FIG. 42 includes the rights management unit 11e instead of the rights management unit 11. This is the only difference therebetween, and thus any constituent in FIG. 42 identical to that of FIG. 1 is provided with the same reference numeral and not described again.

The rights management unit 11e is placed on the provider α side. In FIG. 43, compared with the rights management unit 11 of FIG. 2, a device identifier deletion section 133, and a deletion completion generation section 134 are further included. There is no other difference therebetween, and thus in FIG. 43, any constituent being identical to that of FIG. 2 and having no relevancy to the present modified example is not shown nor described below.

As described in the first embodiment, the device 21a or 21b belongs to the user β, and the user information DB 113 (see FIG. 7A) in the rights management unit 11e carries its corresponding device identifier Idva or Idvb. The devices 21a and 21b share the same rights record Rrgt (see FIG. 7B) which has been registered in the rights DB 114 of the rights management unit 11e. The device 21b of FIG. 44 further includes, compared with that of FIG. 4, a deletion request generation section 233, and a deletion completion notifying section 234. Those are provided for deleting the device identifier Idvb. There is no other difference therebetween, and thus in FIG. 44, any constituent being identical to that of FIG. 4 and having no relevancy to the present modified example is not shown nor described below.

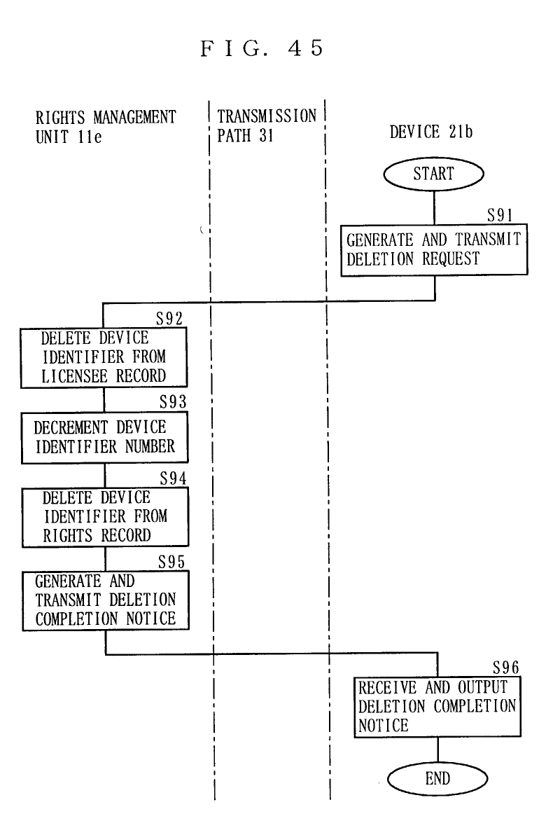

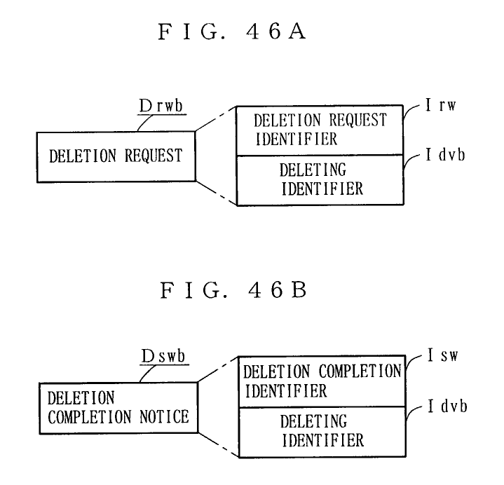

Referring to FIG. 45, described next are the operations of the device 21b and the rights management unit 11e, in the license information management system Sa5 structured as above, to delete the device identifier Idvb of the device 21b from the user information DB 113 and the rights DB 114. First of all, the user β operates the device 21b to designate that the device identifier Idvb is to be deleted from both the user information DB 113 and the rights DB 114. In the device 21b, the deletion request generation section 233 responsively generates such a deletion request as shown in FIG. 46A, and transmits it to the rights management unit 11e (FIG. 45; step S91). The deletion request Drwb is information for requesting the rights management unit 11e to delete the device 21b from the user information DB 113 and the rights DB 114. More in detail, in step S91, the deletion request generation section 233 retrieves the device identifier Idvb from the device identifier storing section 211. Thus retrieved device identifier Idvb is regarded as the deleting identifier Idvb, and thereto, a previously-held deletion request identifier Irw is added. As a result, the deletion request Drwb (see FIG. 46A) is generated. Here, the deletion request identifier Irw is used by the rights management unit 11e to specify the deletion request Drwb. The deletion request Drwb is then transmitted to the rights management unit 11e from the deletion request generation section 233 through the communications section 213, and the transmission path 31.

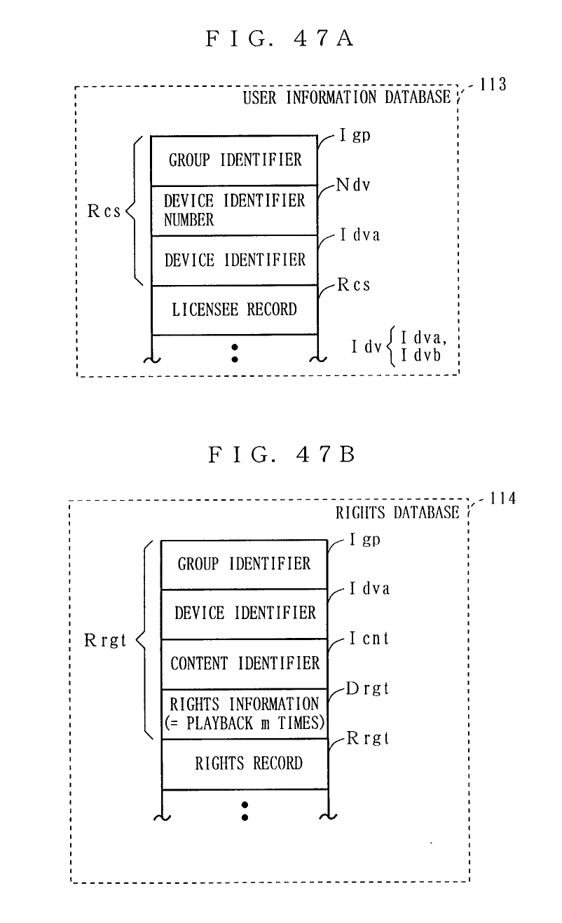

In the rights management unit 11e (see FIG. 43), the communications section 115 acknowledges as having received the deletion request Drwb because of the deletion request identifier Irw included in the received information coming over the transmission path 31. As acknowledged as such, the communications section 115 forwards thus received deletion request Drwb to the device identifier deletion section 133. The device identifier deletion section 133 then extracts the deleting identifier Idvb from the received deletion request Drwb, and then searches the licensee record Rcs (see FIG. 7A) in the user information DB 113 for thus extracted deleting identifier Idvb (step S92). Then, the device identifier deletion section 133 decrements by 1 the device identifier number Ndv included in the licensee record Rcs found in step S92 (step S93). As a result, the licensee record Rcs of FIG. 7A is updated to be the one shown in FIG. 47A.

The device identifier deletion section 133 then searches the rights record Rrgt in the rights DB 114 for the deleting identifier Idvb extracted from the deletion request Irwb, and deletes the result (step S94). The rights record Rrgt of FIG. 7B is thus updated to be the one shown in FIG. 47B. The device identifier deletion section 133 then notifies the deletion completion generation section 134 that the licensee record Rcs and the rights record Rrgt have been correctly updated, and the deleting identifier Idvb in the received registration request Drsc has been deleted.

After notified as having completed with deletion of the deleting identifier Idvb, the deletion completion generation section 134 generates such a deletion completion notice Dswb as shown in FIG. 46B, and transmits it to the device 21b (step S95). Here, the deletion completion notice Dswb is information for notifying the device 21b that the deleting identifier Idvb has been deleted. More in detail, in step S95, the deletion completion generation section 134 adds a previously-held deletion completion identifier Isw to the received deleting identifier Idvb, so that the deletion completion notice Dswb (see FIG. 46B) is generated. Here, the deletion completion identifier Isw is used by the device 21b to identify the deletion completion notice Dswb. Such a deletion completion notice Dswb is transmitted to the device 21b through the communications section 115 and the transmission path 31.

In the device 21b (see FIG. 43), the communications section 213 acknowledges as having received the deletion completion notice Dswb because of the deletion completion identifier Isw included in the information coming over the transmission path 31. As acknowledged as such, the deletion completion notice Dswb is forwarded to the deletion completion notifying section 234. After receiving the deletion completion notice Dswb (step S96), the deletion completion notifying section 234 notifies the user β, by image or audio output, that the device identifier Idvb has been correctly deleted.

According to the fifth modified example, successfully provided is such a license information management system Sa5 with higher usability. This is because, through data communications between the rights management unit 11e and the device 21b, the user β becomes able to delete the device identifier Idvb of the anymore-unwanted device 21b from the user information DB 113 and the rights DB 114.

In the above, described is the exemplary case where the device 21b itself generates the deletion request Drwb of the device identifier Idvb for transmission to the rights management unit 11e. Alternatively, the device 21a may generate the deletion request Drwb in place of the device 21b, and transmits it to the rights management unit 11e. Still alternatively, either the device 21a or 21b may be provided with a capability of generating the deletion request Drwb, and only the device 21 provided with such a capability may be allowed to get involved in transmission of the resulting deletion request Drwb to the rights management unit 11e.

In the above modified example, set to the deletion request Drwb is only one deleting identifier Idvb. This is not restrictive, and a plurality of device identifiers Idv may be set thereto. Further, if the deletion request Drwb is including the group identifier Igp described in the first embodiment, the rights management unit 11e may delete the licensee record Rcs including the group identifier Igp from the user information DB 113, and from the rights DB 114, delete all of the rights records Rrgt including the group identifier Igp.

(Second Embodiment)

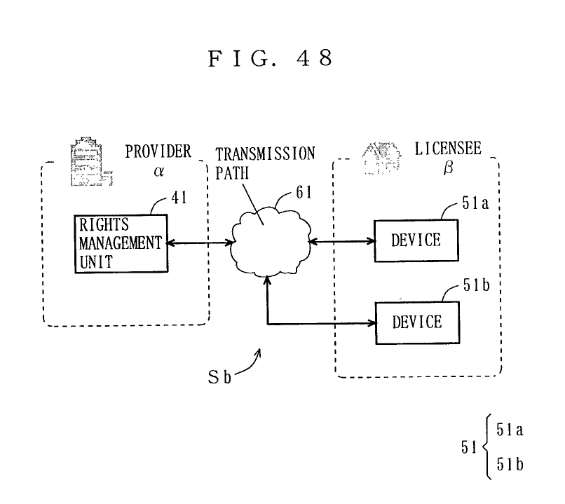

FIG. 48 is a block diagram showing the entire structure of a license information management system Sb including a rights management unit 41 according to a second embodiment of the present invention. In FIG. 48, the license information management system Sb includes the rights management unit 41, a plurality of devices 51, and a transmission path 61. Herein, the devices 51 are exemplarily provided two, i.e., devices 51a and 51b. The rights management unit 41 is placed on the side of a content distribution provider α. The devices 51a and 51b are typically used by a licensee β who is entitled to receive contents under contract with the provider α. The transmission path 61 is wired or wireless, and connects the rights management unit 41 to the device 51a or 51b for data communications therebetween.

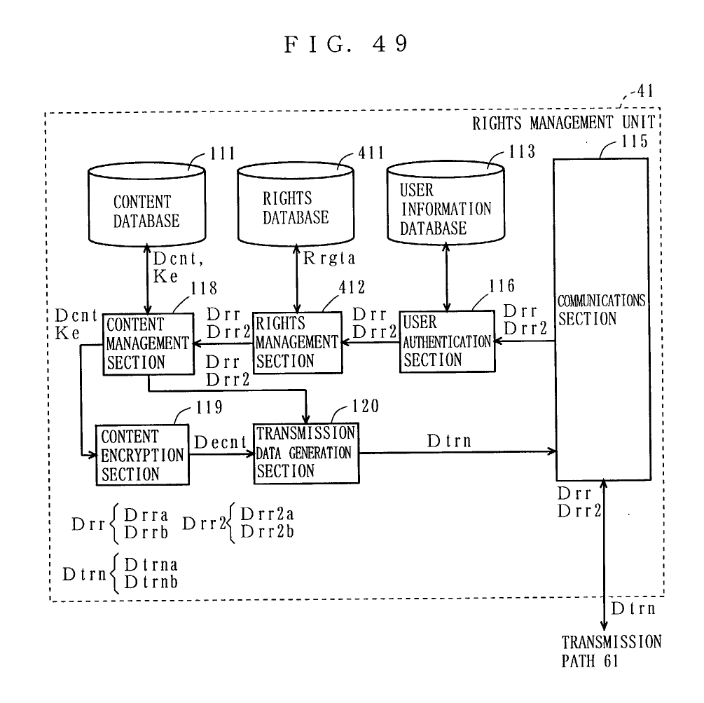

Referring to FIG. 49, described next is the detailed structure of the rights management unit 41 of FIG. 48. Compared with the rights management unit 11 of FIG. 2, the rights management unit 41 of FIG. 49 includes a rights database (hereinafter, rights DB) 411 and a rights management section 412 as alternatives to the rights DB 114 and the rights management section 117. There is no other difference therebetween, and thus in FIG. 49, any constituent identical to that of FIG. 2 is provided with the same reference numeral, and not described again. Also, any constituent having no relevancy to the present modified example is not shown.

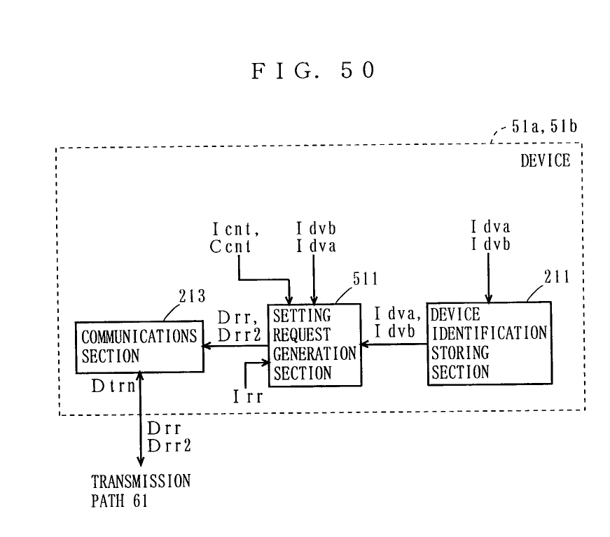

Referring to FIG. 50, described next is the detailed structure of the devices 51a and 51b of FIG. 48. Compared with the devices 21a and 21b of FIG. 4, the devices 51a and 51b are provided with a setting request generation section 511 instead of the setting request generation section 212. This is the only structural differences therebetween, and thus in FIG. 50, any constituent identical to that of FIG. 4 is provided with the same reference numeral, and not described again. Also, any constituent having no relevancy to the present modified example is not shown.

Described next is the setup of the license information management system Sb, needed for content distribution from the provider α to the licensee β similarly to the aforementioned license information management system Sa. For this setup, constructed are the content DB 111, the decryption key DB 112, and the user information DB 113, which are shown in FIGS. 6A, 6B, and 7A. Those are already described in the first embodiment, and thus not described here again.

During the setup, the provider a may assign device identifiers Idva and Idvb for unique identification of the devices 51a and 51b, respectively. The device identifier Idva is set to the device identifier storing section 211 of the device 51a shown in FIG. 50, while the device identifier Idvb to the device identifier storing section 211 of the device 51b. Here, the device identifiers Idva and Idvb may be set to each corresponding device identifier storing section 211 at the time of shipment.

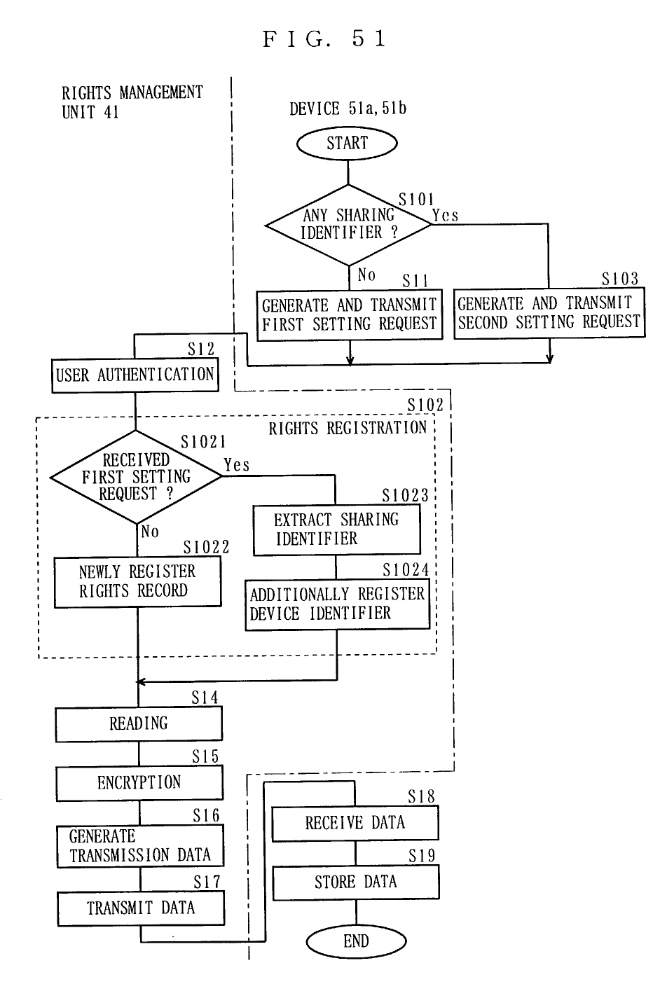

After such a setup is completed, in accordance with the user β's operation, either the device 51a or 51b becomes ready to acquire the content data Dcnt from the rights management unit 41. Referring to the flowchart of FIG. 51, described next is data communications between the device 51a and the rights management unit 41 at the time of acquisition of the content data Dcnt, and their operations therefor. Here, compared with FIG. 8, FIG. 51 further includes steps S101 and S103, and step S102 instead of step S13. There is no other difference therebetween, and thus in FIG. 51, any step identical to that of FIG. 8 is provided with the same step number, and not described again.

The user β accesses the rights management unit 41 through operation of the device 51a. The user β then refers to the content DB 111 to see which content data Dcnt he or she wants, and then specifies the corresponding content identifier Icnt. In the below, thus specified content data Dcnt is referred to as acquiring content data Dcnt. The user β then designates a usage rule Ccnt (see First Embodiment for details) for use of the acquiring content data Dcnt.

In response, the setting request generation section 511 of the device 51a determines whether or not the currently specified includes a sharing identifier Idv (step S101). Here, the sharing identifier Idv is the device identifier Idv not assigned to the device 51 whichever carries out step S101, but to a device 51 which has already been registered in the rights record Rrgta, which is to be shared. As is known from the above, the currently specified includes no such a sharing identifier Idv. The setting request generation section 511 thus generates the first setting request Drra (see First Embodiment) in the same format as FIG. 9A, and transmits it to the rights management unit 41 over the transmission path 61 (step S11). In the present embodiment, the setting request identifier Irr included in the first setting request Drra is used by the rights management unit 41 to specify whether the received information is the first setting request Drra or the second setting request Drr2b.

In the rights management unit 41 (see FIG. 49), responding to the first setting request Drra coming over the transmission path 61, the user authentication section 116 goes through a user authentication process (step S12), and then forwards the first setting request Drra to the rights management section 412. Because of the setting request identifier Irr included in the information provided from the user authentication section 116, the rights management section 412 acknowledges which of the first setting request Drra or the second setting request Drr2b has been provided. As acknowledged as such, the rights management section 412 goes through a right registration process with respect to the rights database (hereinafter rights DB) 114 (step S102). More specifically, determined in step S102 is whether the currently received is the first setting request Drra (step S1021). In step S1021, if the received information is including the sharing identifier Idvb, the rights management section 412 determines as having received the first setting request Drra. If not including, the rights management section 412 determines as having received the second setting request Drr2b. In this example, the rights management section 412 determines as having received the first setting request Drra, and thus the procedure goes to step S1022.

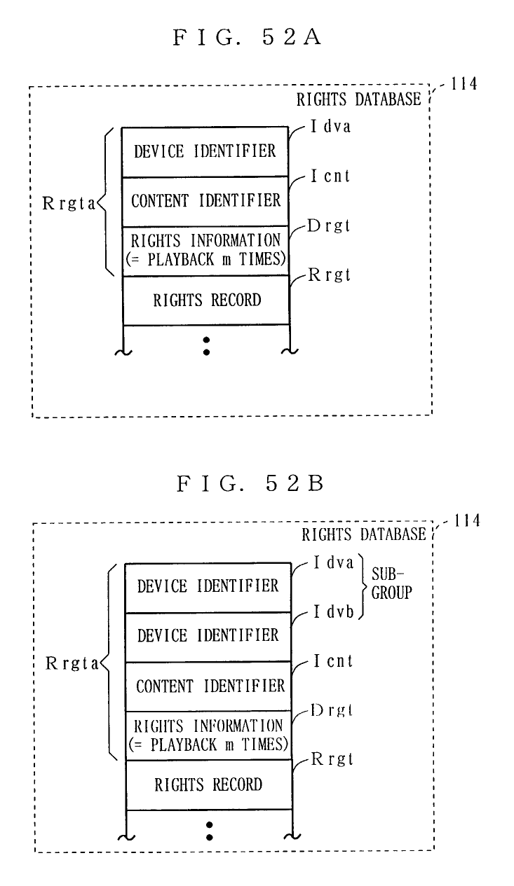

In step S1022, from the first setting request Drra, the rights management section 412 extracts the device identifier Idva, the content identifier Icnt, and the usage rule Ccnt, and then accesses the rights DB 114 to register the extracted results as the rights record Rrgta (step S1022). Here, similar to the first embodiment, the usage rule Ccnt is used as the rights information Drgt. After step S1022, the rights DB 114 plurally stores the rights records Rrgta, each including the device identifier Idva and/or Idvb, the content identifier Icnt, and the rights information Drgt, as shown in FIG. 52A. Note that, as described above in steps S132 and S133 of FIG. 8, after receiving the setting request Drra coming from the device 21a, the rights management section 117 retrieves from the user information DB 113 every device identifier Idv found in the same group. The results are all registered in the rights record Rrgt. On the other hand, in the second embodiment, registered in the rights record Rrgt at step S1022 is only the device identifier Idva belonging to the device 21 from which the first setting request Drra is provided. This is the significant difference between the first and second embodiments.

After step S1022, the rights management section 412 forwards the first setting request Drra to the content management section 118. Thereafter, in a similar manner to the rights management unit 11, the rights management unit 41 executes steps S14 to S17, and the device 51a executes steps S18 and S19 in a similar manner to the device 21a. As a result, from the rights management unit 41, the device 51a receives transmission data Dtrna in the same format as FIG. 9B. Also in the present license information management system Sb, the device 51a receives the license information Dlca (See First Embodiment) from the rights management unit 41 to decrypt the encrypted content data Decnt. The operation at this time is similar to the first embodiment (see FIGS. 11 and 12), and thus no description is given here.

In a case where the device 51b requests the rights management unit 41 to newly register the rights record Rrgt, the same data communications as carried out between the device 51a and the rights management unit 41 is carried out so that no description is given here.

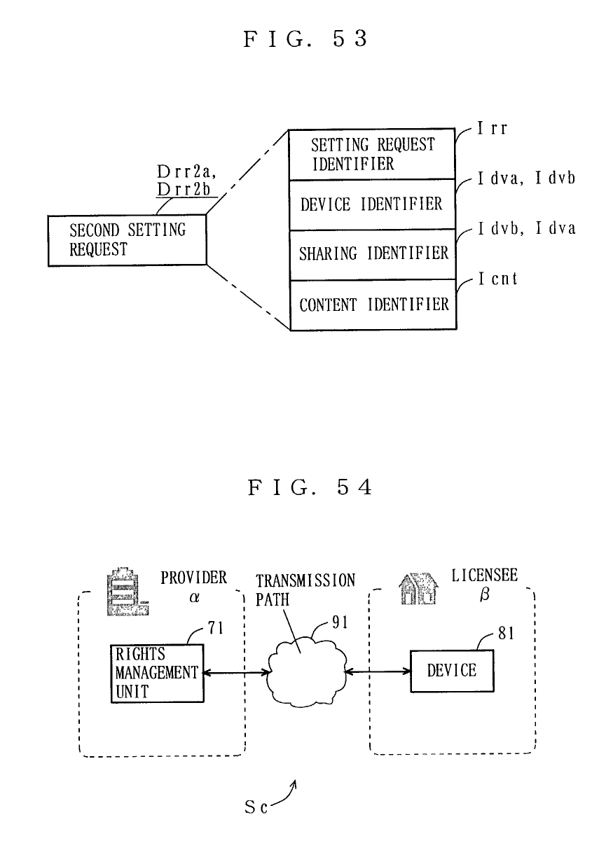

There may be a case where the user β wants to use, with the device 51a, the rights information Drgt which is specifically generated for the device 51b. In such a case, the user β designates the content identifier Icnt through operation of the device 51a, and then designates the device identifier Idvb as the sharing identifier Idv. Note here, the user β has no specific need to designate the usage rule Ccnt because the device 51a shares the rights information Drgt which has been already set by the device 51b. The setting request generation section 511 of the device 51a then determines whether the currently designated includes the sharing identifier Idv (step S101). As is evident from the above, the currently designated includes the device identifier Idvb as the sharing identifier Idv. The setting request generation section 511 thus generates such a second setting request Drr2a as shown in FIG. 53, and transmits it to the rights management unit 41 over the transmission path 61 (step S103). The second setting request Drr2a is information for requesting the rights management unit 41 to make the rights information Drgt registered for the device 51b available also for other devices 51. In this embodiment, the second setting request Drr2a is used also to request the rights management unit 41 to distribute the acquiring content data Dcnt. More in detail, in step S103, the setting request generation section 511 first receives the device identifier Idva from the device identifier storing section 211. The setting request generation section 511 adds, to the user-designated content identifier Icnt and sharing identifier Idvb, the extracted device identifier Idva and the previously-held setting request identifier Irr, so that the second setting request Drr2a (see FIG. 53) is generated. Such a second setting request Drr2a is forwarded from the setting request generation section 511 to the rights management unit 41 via the communications section 213 and the transmission path 61.

In the rights information management unit 41 (see FIG. 49), the user authentication section 116 goes through an authentication process in response to the second setting request Drr2a coming over the transmission path 61(step S12). The second setting request Drr2a is then forwarded to the rights management section 412. Responding to the second setting request Drr2a provided by the user authentication section 116, the rights management section 412 goes through a rights registration process with respect to the rights DB 114 (step S102). In step S102, the rights management section 412 then determines whether the currently received is the first setting request Drra (step S1021). Here, the second setting request Drr2a includes the sharing identifier Idvb so that the rights management section 412 determines that the received is not the first setting request Drra. The procedure thus goes to step S1023.

In step S1023, from the received second setting request Drr2a, the rights management section 412 extracts the sharing identifier Idvb and the content identifier Icnt. Then, the rights management section 412 accesses the rights DB 411 to search for a rights record Rrgta including both the sharing identifier Idvb and the content identifier Icnt. From the second setting request Drr2a, the rights management unit 412 also extracts the device identifier Idva so as to add it to thus found rights record Rrgta (step S1024). After step S1024, in the rights DB 114, the rights record Rrgta is updated to be the one, as shown in FIG. 52B, including the device identifiers Idva and Idvb, the content identifier Icnt, and the rights information Drgt. This indicates that the rights information Drgta of the content data Dcnt is shared by a sub-group structured by the units 51a and 51b. After step S1025 is through, the second setting request Drr2a is forwarded to the content management section 118. Thereafter, the rights management section 412 executes steps S14 to S17, and the device 51b executes steps S18 and S19. Also in the present license information management system Sb, the device 51a receives the license information Dlcb (see First Embodiment) from the rights management unit 41 for decrypting the encrypted content data Decnt. At this time, the device 51a and the rights management unit 41 go through the sequence of processes shown in FIGS. 11 and 12, similarly to those executed by the device 21b and the rights management unit 11 in the first embodiment.

As such, in the present embodiment, the rights record Rrgt has a plurality of device identifiers Idva and Idvb recorded thereon. This enables the rights management unit 41 to correctly respond to the issue requests Dira and Dirb coming from each different devices 51a and 51b only by referring to such a rights record Rrgt, thereby providing those with the license information Dlca and Dlcb generated from the same rights information Drgt. Thus, successfully provided by the present embodiment is the rights management technology with which a plurality of devices can share the same digital rights.

Further, in the first embodiment, responding to one setting request Drr coming from any one of the units 21 belonging to the user β, the rights management unit 11 collectively registers in the rights record Rrgt all of the corresponding device identifiers Idv of the user β's devices 21. In the present embodiment, on the other hand, the rights management unit 41 does not go through registration of the device identifier Idv of the device 51 unless otherwise the second setting request Drr2 comes therefrom. This helps more strict control over the sharing of the rights information Drgt.

Similarly to the license information management system Sa of the first embodiment, the present license information management system Sb becomes capable of adding or deleting the device identifier Idva and/or Idvb by having the rights management unit 41 and the units 51a and 51b go through the processes as described in the second to fifth modified examples above.

(Third Embodiment)

FIG. 54 is a block diagram showing the entire structure of a license information management system Sc according to a third embodiment of the present invention. In FIG. 54, the license information management system Sc includes a rights management unit 71 and a device 81, at least one of each, and a transmission path 91. The rights management unit 71 is placed on the side of a content distribution provider α. The device 81 is placed on the side of a licensee β who is entitled to receive contents under contract with the provider α. The transmission path 91 is wired or wireless, and connects the rights management unit 71 and the device 81 for data communications therebetween.

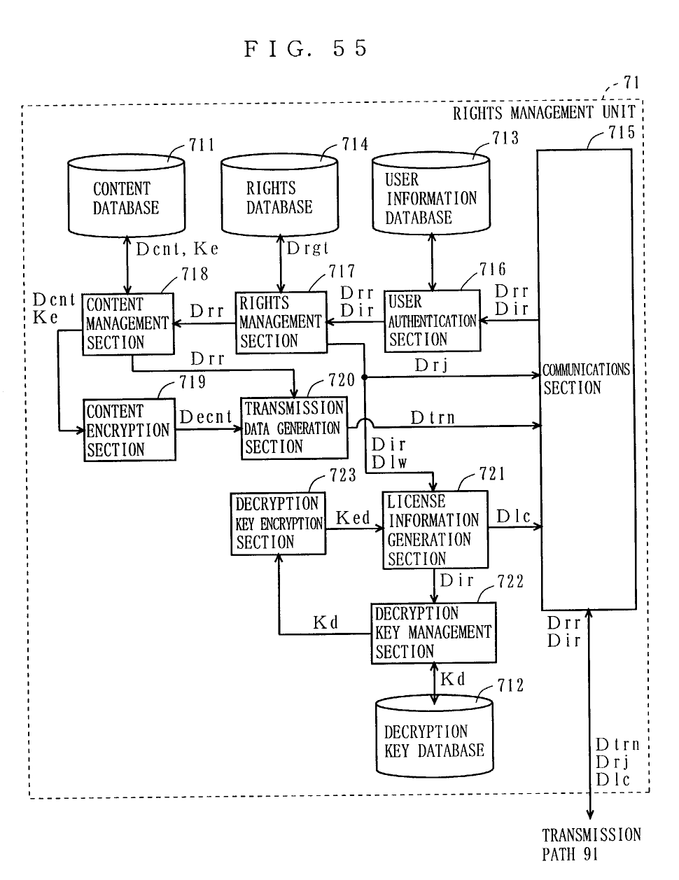

Referring to FIGS. 55 to 58, described next is the detailed structures of the rights management unit 71 and the device 81 of FIG. 54.

FIG. 55 is a functional block diagram showing the detailed structure of the rights management unit 71 of FIG. 54. In FIG. 55, the rights management unit 71 includes a content database 711, a decryption key database 712, a user information database 713, a rights database 714, a communications section 715, a user authentication section 716, a rights management section 717, a content management section 718, a content encryption section 719, a transmission data generation section 720, a license information generation section 721, a decryption key management section 722, and a decryption key encryption section 723.

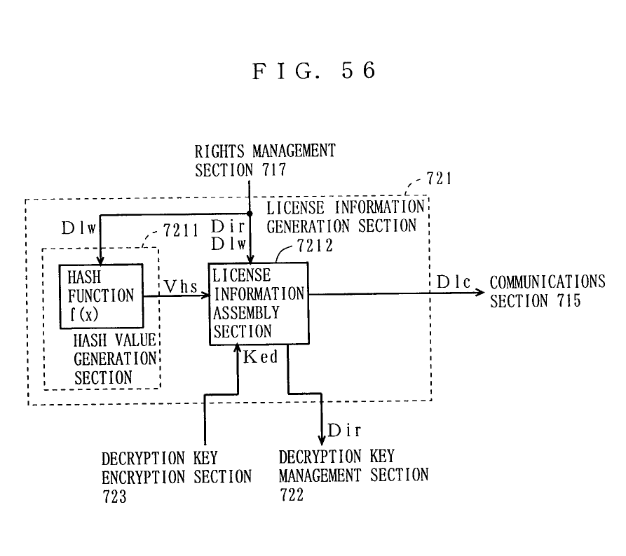

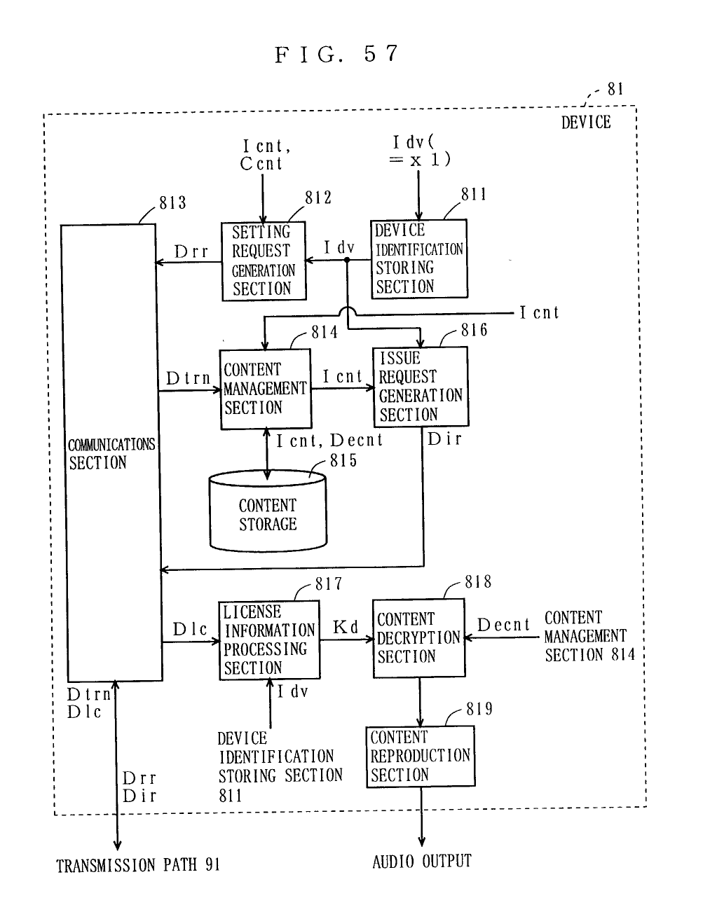

FIG. 56 is a diagram showing the detailed structure of the license information generation section 721 of FIG. 55. In FIG. 56, the license information generation section 721 includes a hash value generation section 7211, and a license information assembly section 7212.

FIG. 57 is a functional block diagram showing the detailed structure of the device 81 of FIG. 54. In FIG. 57, the device 81 is also a consumer-electronics product as in the preceding embodiments. In the present embodiment, however, the device 81 is expediently a music player. Under such a presumption, the device 81 includes a device identifier storing section 811, a setting request generation section 812, a communications section 813, a content management section 814, a content storage 815, an issue request generation section 816, a license information processing section 817, a content decryption section 818, and a content reproduction section 819.

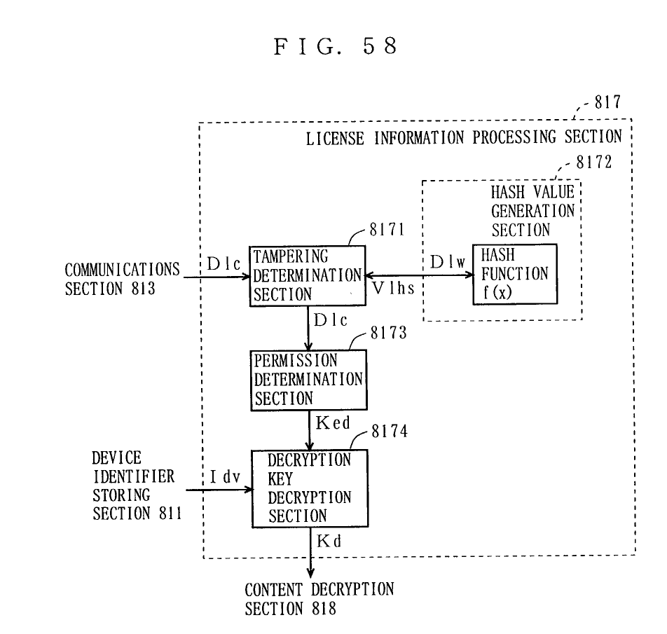

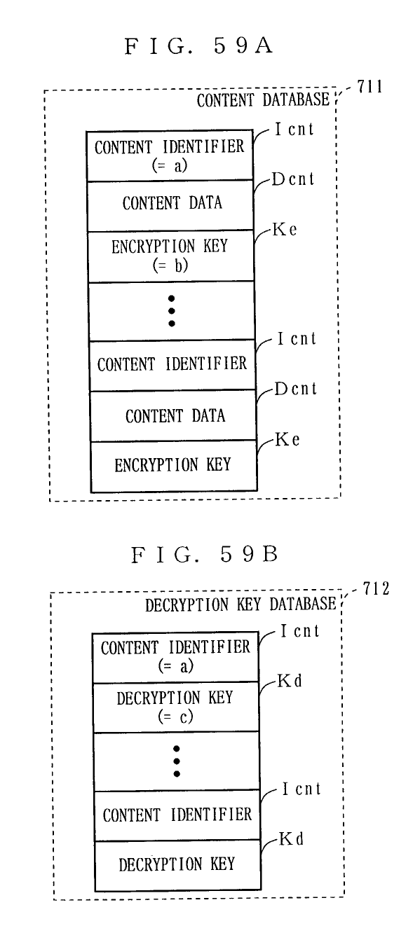

FIG. 58 is a functional block diagram showing the detailed structure of the license information processing section 817 of FIG. 57. In FIG. 58, the license information processing section 817 includes a tampering determination section 8171, a hash value generation section 8172, a permission determination section 8173, and a decryption key decryption section 8174.

Described next is the setup of the license information management system Sc, needed for content distribution from the provider α to the licensee β. For this setup, constructed are the content database (hereinafter, content DB) 711, the decryption key database (decryption key DB) 712, and the user information database (user information DB) 713.

Referring to FIG. 59A, the content DB 711 of FIG. 55 is described in detail. The provider a constructs such a content data DB 711 as shown in FIG. 59A. More specifically, the provider a creates content data Dcnt or receives it from any content creators for distribution to the licensee β. Here, the content data Dcnt can be used by the device 81, and exemplified by television programs, movies, radio programs, music, books, or printouts. The content data Dcnt may be game programs or application programs. In the present embodiment, the content data Dcnt is expediently music data.

To the content data Dcnt acquired as such, the provider α assigns a content identifier Icnt, with which the content data Dcnt is uniquely specified in the license information management system Sc. In view of digital rights protection, the content data Dcnt is encrypted on the rights management unit 71 side before distributed to the device 81. For encryption, to the content data Dcnt, the provider α assigns an encryption key Ke which is specifically designed therefor. The content identifier Icnt, the content data Dcnt, and the encryption key Ke are stored, as a set, in the content DB 711. As shown in FIG. 59A, the content DB 711 plurally stores such a set. In the content DB 711, the content identifier Icnt uniquely identifies the content data Dcnt in the same set. The encryption key Ke is used to encrypt the content data Dcnt in the same set.

Herein, for the sake of simplicity, the content data Dcnt shown in FIG. 59A is assigned with a “a” as a unique content identifier Icnt. Also, to the same set including “a” as the content identifier Icnt, registered is a “b” as an encryption key ke specifically designed therefor.

In the present embodiment, the content DB 711 is constructed from the content identifiers Icnt, the content data Dcnt, and the encryption keys Ke. However, surely databases may be independently constructed for the content data Dcnt and the encryption keys Ke. In some cases, the content identifier Icnt may specify the storage location of the content data Dcnt in the content DB 711. If so, the content DB 711 has no need to carry the content identifiers Icn therein. That is, the content identifier Icn is not necessarily be included in the content DB 711.

Referring next to FIG. 59B, the decryption key DB 712 of FIG. 55 is described in detail. As already described, the content data Dcnt is encrypted using its corresponding encryption key Ke before transmitted to the device 81. In the below, the content data Dcnt encrypted as such is referred to as encrypted content data Decnt. In order to decrypt the encrypted content data Decnt, the device 81 needs to have a decryption key Kd corresponding to the encryption key Ke. To meet the necessity, the provider a makes such a decryption key Kd corresponding to the encryption key Ke in the content DB 711. Here, the bit string of the decryption key Kd may be the same or different from that of the encryption key Ke. The resulting decryption key Kd is stored in the decryption key DB 712 together with the content identifier Icnt. As such, the decryption key DB 712 plurally stores the set of the content identifier Icnt and the decryption key Kd, as shown in FIG. 59B. In the decryption key DB 712, the content identifier Icnt is used to identify the content data Dcnt assigned to the decryption key Kd in the same set. The decryption key Kd is used to decrypt the encrypted content data Denct identified by the content identifier Icnt in the same set.

In the below, for the sake of simplicity, in FIG. 59B, registered in the same set as “a” being the content identifier Icnt is “c” as the decryption key Kd. As is evident from the above, “c” as the decryption key Kd is used to decrypt the encrypted content data Decnt using “b” as the decryption key ke.

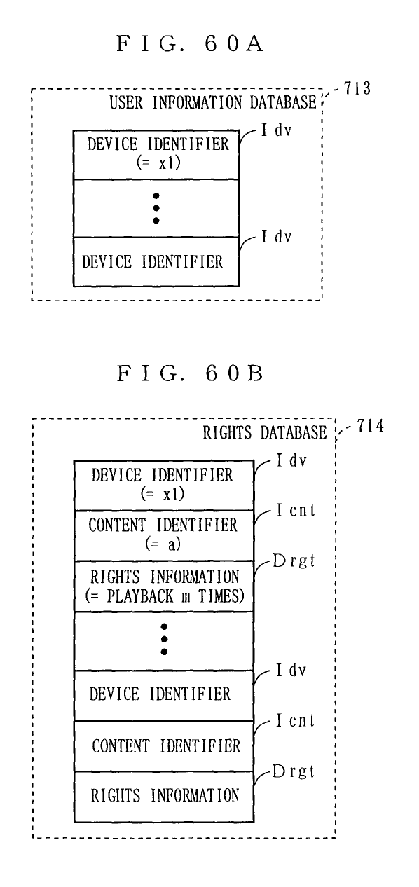

Referring to FIG. 60A, the user information DB 713 of FIG. 55 is described in detail. As described above, the licensee β signs a contract with the provider α for content distribution. Here, contract signing may be done through the transmission path 91, or in other manners. Based on thus signed contract, the provider α assigns a device identifier Idv to the licensee β. The device identifier Idv uniquely specifies the device 81 on the licensee β side in the license information management system Sc. such a device identifier Idv is registered in the user information DB 713. As such, as shown in FIG. 60A, the user information DB 713 plurally includes the device identifier Idv.

Refer back to FIG. 57. The device identifier Idv thus assigned by the provider α is set to the device identifier storing section 811 provided in the device 81 on the licensee β side. For such a setting, typically, the provider α accordingly operates the device 81 on the licensee β side. Alternatively, the provider a may forward over the transmission path 91 the device identifier Idv assigned to the licensee β to the corresponding device 81, and therein, thus received device identifier Idv is automatically registered in the device identifier storing section 211.

Such a setting may be made at the time of shipment of the device 81. If this is the case, at the time of contract signing, the licensee β notifies the provider α of the device identifier Idv assigned to the device 81. The provider α registers thus notified device identifier Idv in the user information DB 713.

Herein, for the sake of simplicity, as shown in FIG. 60A, the user information DB 713 presumably registers “x1” as a device identifier Idv. As shown in FIG. 57, presumably set to the device identifier storing section 811 is “x1” as the device identifier Idv.

Here, the rights management database 714 shown in FIG. 60B will be described later.

After such a setup is completed, the device 81 becomes able to acquire the content data Dcnt from the rights management unit 71 in response to the licensee β's operation.

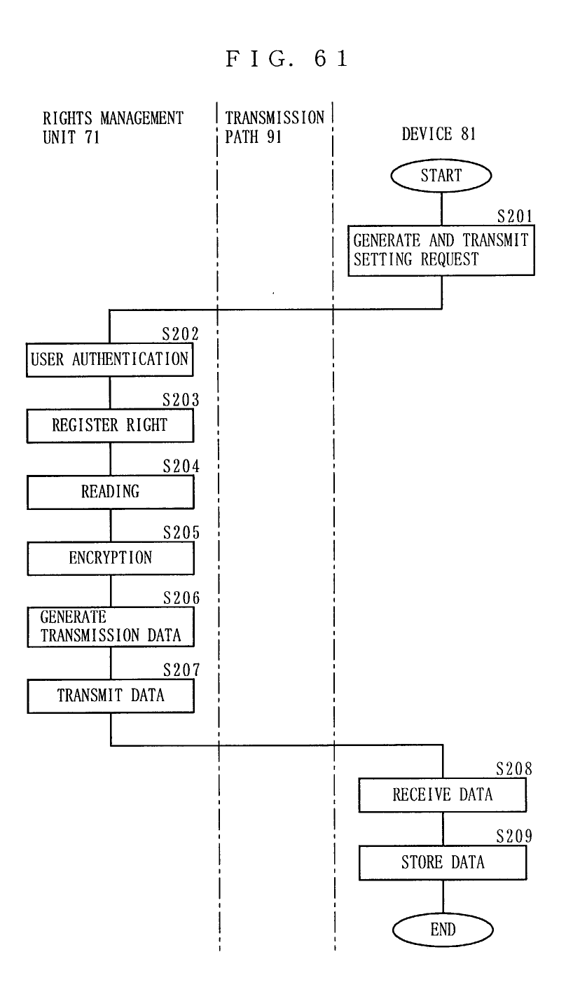

Referring to FIG. 61, described next are the operations of the device 81 and the rights management unit 71 at the time of acquisition of the content data Dcnt. First, the licensee β accesses the rights management unit 71 through operation of the device 81. The licensee β then refers to the content DB 711 to see which content data Dcnt he or she wants, and specifies the corresponding content identifier Icnt. In the below, thus specified content data Dcnt is referred to as acquiring content data Dcnt. The licensee β then designates a usage rule Ccnt for use of the acquiring content data Dcnt.

In detail, the usage rule Ccnt is information indicating under what rule the device 81 is asking for a right to use the content data Dcnt. If the content data Dcnt represents music, the usage rule Ccnt is typified by valid period, playback frequency, maximum playback duration, total playback time, or playback quality. Here, the usage rule Ccnt may include two or more of those. For example, as the usage rule Ccnt, the valid period may be set as “from Jun. 1, 2001 to Aug. 31, 2001 ”, and only for the period, the content data Dcnt becomes available for the device 81. If the playback frequency is set to five, the device 81 is allowed to playback the content data Dcnt for five times. If the maximum playback duration is set to 10 seconds, the device 81 can playback the content data Dcnt for the duration at a time. This is especially effective for music promotion. As to the total playback time, if set to 10 hours, it means that the content data Dcnt is available for the device 81 at any time for the duration of time. The playback quality may be set as “quality of CDs (Compact Disks)”, and the device 81 can playback the content data Dcnt with thus set playback quality.

Here, those exemplified usage rules Ccnt are possibilities for the case where the content data Dcnt represents music. This is not restrictive, and it is preferable that setting of the usage rule Ccnt is appropriately made depending on what the content Dcnt represents.

In the below, the usage rule Ccnt is expediently the playback frequency of the content data Dcnt.

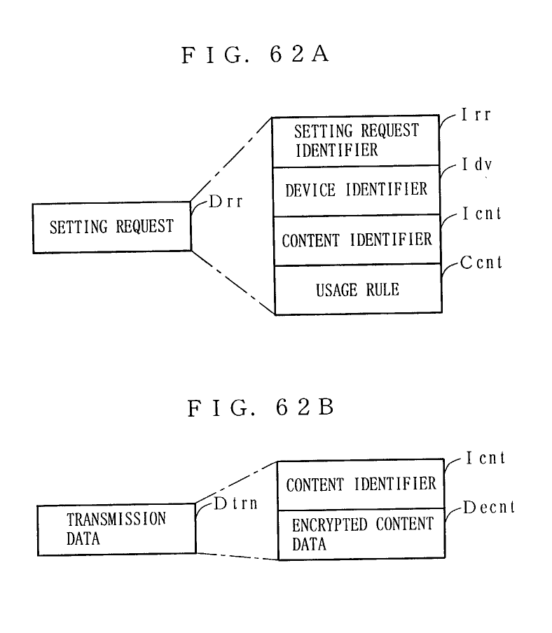

As described above, the licensee β designates the content identifier Icnt and the usage rule Ccnt through operation of the device 81. The device 81 responsively generates such a setting request Drr as shown in FIG. 62A for transmission to the rights management unit 11 (FIG. 61, step S201). The setting request Drr is information for requesting the rights management unit 71 for a right to use the acquiring content data Dcnt. In the present embodiment, the setting request Drr is also used to request the rights management unit 71 for distribution of the acquiring content data Dcnt. More in detail, in step S201, the setting request generation section 812 (see FIG. 57) first receives the content identifier Icnt and the usage rule Ccnt designated by the licensee β. The setting request generation section 812 also receives the device identifier Idv from the device identifier storing section 811. Then, to the set of the device identifier Idv, the content identifier Icnt, and the usage rule Ccnt, the setting request generation section 812 adds a setting request identifier Irr, which is previously stored. As such, the setting request Drr (see FIG. 62A) is generated. The setting request identifier Irr is used by the rights management unit 71 to identify the setting request Drr. The setting request generation section 812 forwards such a setting request Drr to the communications section 813, from which the setting request Drr is transmitted to the rights management unit 71 over the transmission path 91.

In the rights management unit 71 (see FIG. 55), the communications section 715 receives the setting request Drr coming over the transmission path 91, and forwards it to the user authentication section 716. In response to the setting request Drr, the user authentication section 716 goes through a user authentication process (FIG. 61; step S202). More specifically, the user authentication section 716 refers to the aforementioned user information DB 713 (see FIG. 60A) under its management to see if including the device identifier Idv corresponding to the device identifier Idv set to the received setting request Drr. Only when including, the user authentication section 716 authenticates the current setting request Drr as being the one provided from the device 81 of the licensee β. After completing such a user authentication process, the user authentication section 716 forwards the received setting request Drr to the rights management section 717.

Here, if the received request Drr is not from the licensee β, the user authentication does not work out. Thus, the user authentication section 716 discards the setting request Drr without forwarding it to the rights management section 717.

The rights management section 717 (see FIG. 55) manages the rights database (hereinafter, rights DB) 714. Because of the setting request identifier Irr set to the received information, the rights management section 717 acknowledges as having received the setting request Drr from the user authentication section 716. As acknowledged as such, the rights management section 717 goes through a right registration process with respect to the rights DB 714 (step S203). More specifically, the rights management section 717 extracts from the setting request Drr the device identifier Idv, the content identifier Icnt, and the usage rule Ccnt, and registers the resulting set to the rights DB 714. Here, the rights management section 717 regards the device 81 as asking for a right to use the acquiring content data Dcnt with the usage rule Ccnt set to the setting request Drr. That is, from the rights management section 717 side, the usage condition Ccnt denotes the right for the device 81 to use the acquiring content data Dcnt. In this sense, the rights management section 717 handles the usage rule Ccnt extracted from the setting request Drr as rights information Drgt, which is requested by the device 81. As shown in FIG. 60B, the rights DB 714 plurally includes the device identifiers Idv, the content identifiers Icnt, and the rights information Drgt. The rights DB 714 thus enables the rights management section 717 to manage the right to the acquiring content data Dcnt on the licensee β basis. After such a usage rule registration process, the rights management section 717 forwards the currently received setting request Drr to the content management section 718.

Here, the rights information Drgt to be registered in the above rights DB 714 is described more specifically. As assumed in the above, the usage rule Ccnt in the present embodiment is the playback frequency. Here, assuming that the current setting request Drr includes “x1” as the device identifier Idv, “a” as the content identifier Icnt, and “playback m times” (where m is a natural number) as the usage rule Ccnt. Under such an assumption, as shown in FIG. 60B, such a set as including “x1” as the device identifier Idv, “a” as the content identifier Icnt, and “playback m times” as the rights information Drgt is accordingly set.

Here, although irrelevant to the technical characteristics of the present license information management system Sc, in step S203, the rights management section 717 may charge the licensee β to whom the device identifier Idv is assigned for the use of the content data Dcnt every time rights information Drgt is registered.

After receiving the setting request Drr, the content management section 718 goes through a process for reading the content data Dcnt (step S204). More in detail, the content management section 718 extracts the content identifier Icnt from the setting request Drr. Then, the content management section 718 accesses the content DB 711 to read the content data Dcnt to which the extracted content identifier Icnt has been assigned, and the encryption key Ke. After such a reading process, the content management section 718 forwards the resulting content data Dcnt and the encryption key Ke to the content encryption section 719. The content management section 718 forwards also the received setting request Drr to the transmission data generation section 720.

The content encryption section 719 goes through a process for encrypting the content data Dcnt (step S205). More specifically, the content encryption section 719 encrypts the content data Dcnt using the encryption key Ke accompanied therewith, and the encrypted content data Decnt is thus generated. After completing such an encryption process, the content encryption section 719 forwards the encrypted content data Decnt to the transmission data generation section 720.

After receiving both of the setting request Drr from the content management section 718, and the encrypted content data Decnt from the content encryption section 719, the transmission data generation section 720 goes through a process for generating transmission data (step S206). To be more specific, the transmission data generation section 720 extracts, from the setting request Drr, the content identifier Icnt. Thus extracted content identifier Icnt is added to the encrypted content data Decnt, and thus transmission data Dtrn as shown in FIG. 62B is generated. After such a transmission data generation process, the transmission data generation section 720 forwards the resulting transmission data Dtrna to the communications section 715. The received transmission data Dtrn is then transmitted to the device 81 over the transmission path 91 (step S207).

In the device 81 (see FIG. 57), the communications section 813 receives the transmission data Dtrn coming over the transmission path 91 (step S208). More specifically, the communications section 813 acknowledges as having received the transmission data Dtrn because of the content identifier Icnt therein. As acknowledged as such, the communications section 813 forwards the received data Dtrn to the content management section 814.

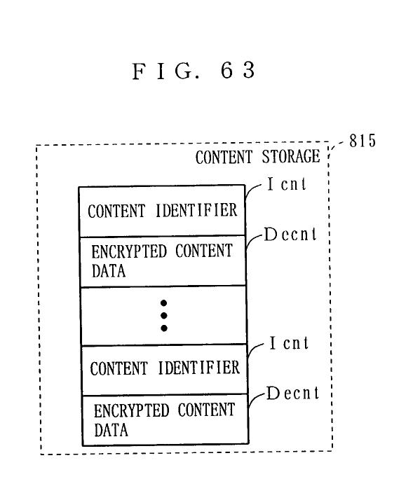

The content management section 814 stores, in the content storage 815, the content identifier Icnt and the encrypted content data Decnt in the received data Dtrn (step S209). That is, as shown in FIG. 63, the content storage 815 plurally stores a set of the content identifier Icnt and the encrypted content data Decnt requested by the setting request Drr.

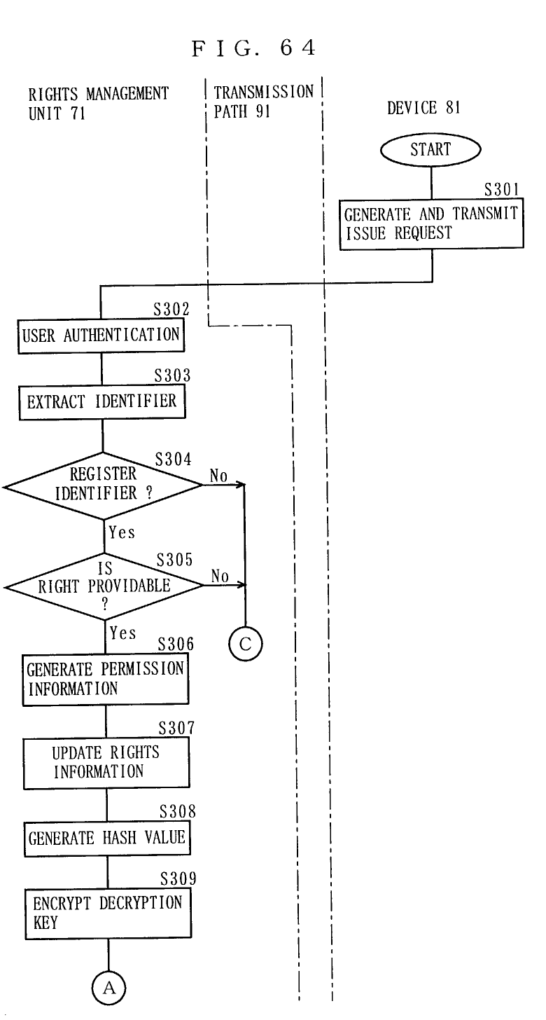

In view of digital rights protection, distributed to the device 81 is the encrypted content data Decnt. Thus, for use of the content data Dcnt, the device 81 has to decrypt thus received encrypted content data Decnt using the decryption key Kd provided by the rights management unit 71. In order to provide the decryption key Kd to the device 81, the present license information management system Sc uses license information Dlc, which will be described later. Referring now to FIGS. 64 to 66, described below are the operations of the device 81 and the rights management unit 71 at the time of acquisition of the license information Dlc, and decryption of the content data Dcnt.

First of all, through operation of the device 81, the licensee β access the content storage 815, and specifies which encrypted content data Decnt found therein he or she wants to use. In the below, thus specified encrypted content data Decnt is referred to as decrypting content data Decnt.

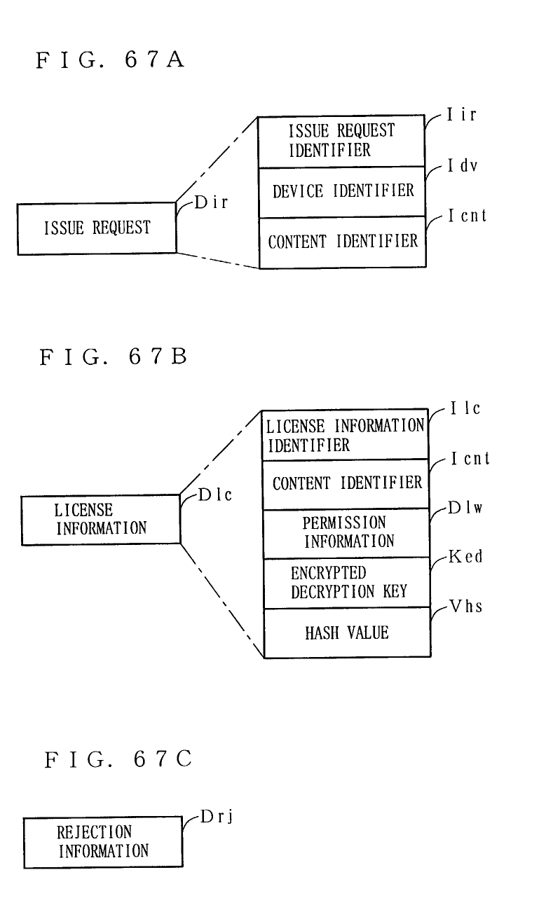

In response, the device 81 generates such an issue request Dir as shown in FIG. 67A, and transmits' it to the rights management unit 71 (FIG. 64; step S301). The issue request Dir is information for requesting the rights management unit 71 to release the license information Dlc, i.e., requesting for a permission to use the decrypting content data Decnt. More in detail, in step S301, the content management section 814 (see FIG. 57) retrieves, from the content storage 815 under its management, the content identifier Icnt attached to the decrypting content data Decnt specified by the licensee β. The issue request generation section 816 receives the content identifier Icnt thus retrieved by the content management section 814, and the device identifier Idv from the device identifier storing section 811. Then, to the device identifier Idv and the content identifier Icnt, the issue request generation section 816 adds the issue request identifier Iir so that the issue request Dir (see FIG. 67A) is generated. Here, the issue request identifier Iir is used by the rights management unit 71 to identify the issue request Dir. The issue request generation section 816 forwards the resulting issue request Dir to the communications section 813, from which the issue request Dir is transmitted to the rights management unit 71 over the transmission path 91.

In the rights management unit 71, the communications section 715 (see FIG. 55) receives the issue request Dir coming over the transmission path 91, and forwards it to the user authentication section 716. In response to the issue request Dir, the user authentication section 716 goes through a user authentication process (step S302). More specifically, the user authentication section 716 extracts the device identifier Idv from the received issue request Dir. Then, the user authentication section 716 applies the authentication process to the issue request Dir in a similar manner to the step S202 (see FIG. 61), and then forwards the issue request Dir to the rights management section 717.

The rights management section 717 acknowledges that the received from the user authentication section 716 is the issue request Dir because of the issue request identifier Iir set thereto. As acknowledged as such, from the issue request Dir, the rights management section 717 extracts the device identifier Idv and the content identifier Icnt (step S303). The rights management section 717 then determines whether the rights DB 714 (see FIG. 60B) carries the set of the extracted device identifier Idv and the content identifier Icnt (step S304).

If determined “Yes” in step S304, the rights management section 717 refers to the rights information Drgt included in the same set to determine whether the device 81 is qualified for permission (step S305). If “Yes” in step S305, the rights management section 717 extracts partially or entirely the rights information Drgt (step S306). To avoid confusion, the resulting rights information Drgt extracted in step S306 is referred to as permission information Dlw in the respect that the information is used to make the content data Dcnt available for the device 81 which is identified by the current issue request Dir. That is, generated in step S306 is the permission information Dlw.

Here, generating the permission information Dlw requires partially or entirely the rights information Drgt registered for the device 81, so that the rights management section 717 updates the rights information Drgt partially or entirely extracted in step S306 (step S307).

Here, steps S303 to S307 are specifically exemplified. As shown in FIG. 60B, the rights DB 714 presumably carries, as a set, “x1” as the device identifier Idv, “a” as the content identifier Icnt, and “playback m times” as the rights information Drgt. Also, it is presumed that the device 81 transmits the issue request Dir which includes “x1” as the device identifier Idv, and “a” as the content identifier Icnt.

Under such presumption, in step S303, extracted from the issue request Dir is “x1” as the device identifier Idv, and “a” as the content identifier Icnt. And determined in step S304 is that the rights DB 714 is carrying the set of “x1” and “a”. As a result, because the rights information Drgt in the same set indicates “playback m times”, in step S305, it will be determined that the device 81 is qualified for permission. Then in step S306, generated is the permission information Dlw, exemplified by “playback n times”. Here, n is a natural number not exceeding the aforementioned m, and more preferably, is set according to the throughput of the device 81. As an example, if the hardware of the device 81 is relatively low in capability, n may be set to the smallest value allowed for the device 81 to use the decrypting content data Decnt.

After steps S303 to S306, the device 81 (device identifier Idv “x1”) may exercise the right for playing back the content data Dcnt (content identifier Icnt “a”) for n times. Thus in step S307, the rights information Drgt is updated from “playback m times” to “playback (m−n) times”.

In the above, the rights information Drgt is presumed as indicating the playback frequency of the content data Dcnt. However, as already described, the present license information management system Sc does not limits the rights information Drgt (i.e., usage rule Ccnt) by type. There thus needs to appropriately define steps S303 to S307 by process in accordance with the rights information Drgt.

The resulting rights information Dlw is forwarded from the rights management section 717 (see FIG. 55) to the license information generation section 721 together with the issue request Dir. More specifically, in the license information generation section 721, as shown in FIG. 56, the hash value generation section 7211 receives only the permission information Dlw, while the license information assembly section 7212 receives both the permission information Dlw and the issue request Dir.

First, the hash value generation section 7211 assigns the received permission information Dlw to a hash function f(x) which is previously held, and generates a hash value Vhs (step S308). The hash value Vhs is a protection measure against tampering with the permission information Dlw, and is a solution derived by assigning the permission information Dlw to a generating polynomial f(x). Such a hash value Vhs is forwarded from the hash value generation section 7211 to the license information assembly section 7212.

The license information assembly section 7212 forwards the received issue request Dir to the decryption key management section 722 (see FIG. 55), in which the aforementioned decryption key DB 712 (see FIG. 59B) is managed. From the received issue request Dir, the content identifier Icnt and the device identifier Idv are extracted. The decryption key management section 722 then retrieves the decryption key Kd in the same set as the content identifier Icnt from the decryption key DB 712, and forwards it to the decryption key encryption section 723 together with the device identifier Idv. The decryption key encryption section 723 encrypts the received decryption key Kd using the device identifier Idv accompanied therewith (step S309), so that the encrypted decryption key Ked is generated. The resulting encrypted decryption key Ked is forwarded to the license information assembly section 7212.

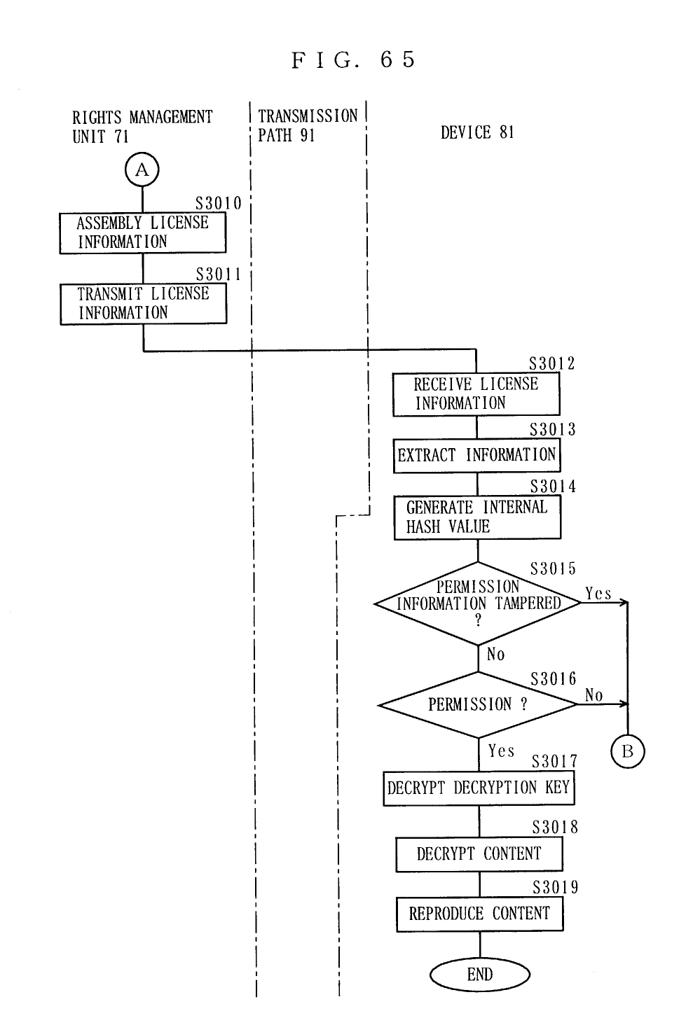

After receiving all the issue request Dir, the permission information Dlw, the hash value Vhs, and the encrypted decryption key Ked, the license information assembly section 7212 starts generating such license information Dlc as shown in FIG. 67B (FIG. 65; step S3010). More specifically, the license information assembly section 7212 extracts from the received issue request Dir the content identifier Icnt, and adds it to the set of the permission information Dlw, the encrypted decryption key Ked, and the hash value Vhs. Further, the license information assembly section 7212 adds a previously-held license information identifier Ilc to the content identifier Icnt, so that the license information Dlc is generated. The resulting license information Dlc is information for controlling the use of the decrypting content data Decnt by the device 81. The license information identifier Ilc is information used by the device 81 to identify the license information Dlc. Such license information Dlc is forwarded to the communications section 715, from which the license information Dlc is transmitted to the device 81 over the transmission path 91 (step S3011).

In the device 81 (see FIG. 57), the communications section 813 receives the license information Dlc coming over the transmission path 91 (step S3012). More specifically, the communications section 813 acknowledges as having received the license information Dlc because of the license information identifier Ilc set to the information. As acknowledged as such, the communications section 813 forwards the received license information Dlc to the license information processing section 817.

The license information processing section 817 includes, as shown in FIG. 58, the tampering determination section 8171, the hash value generation section 8172, the permission determination section 8173, and the decryption key decryption section 8174. The license information Dlc from the communications section 813 is forwarded to the tampering determination section 8171, in which the permission information Dlw and the hash value Vhs are extracted from the license information Dlc (step S3013). The extracted permission information Dlw is forwarded to the hash value generation section 8172, while the hash value Vhs is retained as it is. Here, to avoid confusion, the hash value Vhs extracted in step S3013 is referred to as the external hash value Vehs in the respect that the hash value is generated outside of the device 81, i.e., the rights management unit 71.

The hash value generation section 8172 holds the same hash function f(x) as the hash value generation section 7211 (see FIG. 3) on the rights management unit 71 side. The received permission information Dlw is assigned to the hash function f(x) so that the hash value Vhs is generated (step S3014). Here, the hash value Vhs generated in step S3014 is referred to as the internal hash value Vlhs in the respect that the hash value is generated inside of the device 81. The hash value generation section 8172 returns the internal hash value Vlhs to the tampering determination section 8171.

In response to the internal hash value Vlhs, the tampering determination section 8171 determines whether the permission information Dlw has been tampered or not (step S3015). More in detail, the internal hash value Vlhs coincides with the external hash value Vehs if the permission information Dlw in the license information Dlc is not tampered. Thus, in step S3015, determined is whether or not the received internal hash value Vlhs coincides with the external hash value Vehs. If determined “Yes”, the tampering determination section 8171 determines that the permission information Dlw has not been tampered and thus effective, and then forwards the license information Dlc to the permission determination section 8173.

The permission determination section 8173 refers to the received license information Dlc to determine whether or not the decrypting content data Decnt is allowed for use (step S3016). Only when determined “Yes” in step S3016, the permission determination section 8173 extracts from the license information Dlc the encrypted decryption key Ked, which is then forwarded to the decryption key decryption section 8174.

More in detail, in step S3016, as assumed above, the permission information Dliw in the license information Dlc approves playback of the content data Dcnt for n times. In this case, if the playback frequency assigned to the permission information Dlw in step S3016 is 1 or larger, the permission determination section 8173 determines that the decrypting content data Decnt is available. Thus, from the license information Dlc, the encrypted decryption key Ked is extracted, and forwarded to the decryption key decryption section 8174.

In the above example, the rights information Drgt indicates the playback frequency of the content data Dcnt. As already described, the present license information management system Sc does not limit by type the rights information Drgt, i.e., the usage rule Ccnt. Thus, there needs to appropriately define step S3016 by process in accordance with the rights information Drgt.

The decryption key decryption section 8174 receives the encrypted decryption key Ked from the permission determination section 8173. The decryption key decryption section 8174 also receives the device identifier Idv from the device identifier storing section 811. Thereafter, the decryption key decryption section 8174 decrypts the encrypted decryption key Ked using the device identifier Idv (step S3017), and the decryption key Kd is forwarded to the content decryption section 818.

Here, in step S301, the content management section 814 extracts the aforementioned decrypting content data Decnt together with the content identifier Icnt. Thus extracted content data Decnt is forwarded to the content decryption section 818. The content decryption section 818 decrypts the received content data Decnt using the decryption key Kd received from the decryption key decryption section 8174 (step S3018), and the resulting content data Dcnt is forwarded to the content reproduction section 819. The content reproduction section 819 reproduces the content data Dcnt for audio output (step S3019). In this manner, the licensee scan listen to the music represented by the content data Dcnt purchased from the provider a.

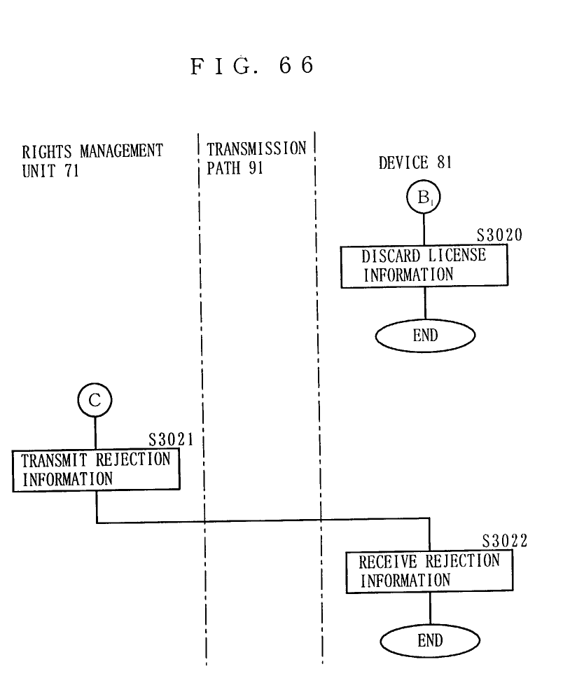

Refer to step S3015 of FIG. 65. In step S3015, there may be a case where the tampering determination section 8171 determines that the permission information Dlw has been tampered. Also, in step S3016, there may be a case where the permission determination section 8173 determines that the decrypting content data Decnt is not allowed for use. In these cases, the tampering determination section 8171 and the permission determination section 8173 discard the license information Dlc (FIG. 66; step S3020). As is evident from above, only when the provided license information Dlc is effective, the present license information management system Sc allows decryption of the decrypting content data Decnt. As such, the digital rights are successfully protected.

In step S304 of FIG. 64, the rights management section 717 may determine that the rights DB 714 (see FIG. 60B) does not carry the set of the device identifier Idv and the content identifier Icnt. In step S305, the rights management section 717 may determine that the device 81 is not qualified for permission. If so, the rights management section 717 generates rejection information Drj (see FIG. 67C), and transmits it to the communications section 715. Here, the rejection information Drj indicates that the use of the decrypting content data Decnt is rejected. The rejection information Drj is then transmitted from the communications section 715 to the device 81 over the transmission path 91 (FIG. 66; step S3021).

In the device 81 (see FIG. 57), the communications section 813 receives the rejection information Drj coming over the transmission path 91 (step S3022). The rejection information Drj stops the device 81 to go through a further process. As such, when the rights DB 714 carries no effective set, in the present license information management system Sc, the rejection information Drj is forwarded to the device 81. Therefore, the decrypting content data Decnt is not decrypted on the device 81 side, thereby sufficiently protecting the digital rights.

After determining that the rights DB 714 (see FIG. 60B) carries no effective set in step S304, the rights management section 717 may alternatively generates a new set of the device identifier Idv, the content identifier Icnt, and the rights information Drgt for registration into the rights DB 714.

As such, in the present license information management system Sc, the rights information Drgt indicating the right for the unit 81 to use the content data Dcnt can be collectively managed on the rights management unit 71 side. Therefore, the device 81 becomes free from the processing load resulted from management of the rights information Drgt. Accordingly, successfully provided by the present license information management system Sc is a right protection technology suiting to consumer-electronics products having low throughput.

In the above embodiment, the rights management unit 71 under the same provider α's management presumably goes through all of the processes of FIGS. 61, and 64 to 66. These processes are not necessarily executed by one rights management unit. That is, in the present license information management system Sc, a rights management unit managed by a certain provider may take charge of distributing the content data Dcnt, and another rights management unit managed by another provider may take charge of releasing the license information Dlc. Further, for the sake of simplicity, the content data Dcnt is acquired first (processes of FIG. 61), and then the license information Dlc is acquired (processes of FIGS. 64 to 66). This order is not restrictive, and the license information Dlc may be acquired first, and then acquisition of the content data Dcnt may follow, or the acquisition processes may be carried out at the same time.

In the present embodiment, the content DB 114 plurally stores not-yet-encrypted content data Dcnt, and the encryption keys Ke, and the rights management unit 71 encrypts the content data Dcnt using the corresponding encryption key Ke immediately before generating the transmission data Dtrn (see step S205), Alternatively, in order to reduce the processing time taken to encrypt the content data Dcnt, the content DB 114 may plurally store the aforementioned encrypted content data Decnt. If this is the case, to the encrypted content data Decnt specified by the content identifier Icnt set to the setting request Drr, the rights management unit 71 adds the content identifier Icnt to generate the transmission data Dtrn.

In the above, in the license information generation section 721, the hash value generation section 7211 generates the hash value Vhs only from the permission information Dlw. Alternatively, the license information assembly section 7212 provides, to the hash value generation section 7211, any one or more of components of the license information Dlc, i.e., the license information identifier Ilc, the content identifier Icnt, the permission information Dlw, and the encrypted decryption key Ked. Then, the hash value generation section 7211 assigns those received to the aforementioned hash value function f(x) to generate the hash value Vhs.

In the present embodiment, the license information Dlc includes the encrypted decryption key Ked. Alternatively, the decryption key Kd may be included. In this case, however, the decryption key Kd may be stolen by third parties on the transmission path 91. Thus, there needs to protect the license information Dlc provided from the rights management unit 71 to the device 81 using a technology typified by SSL (Secure Socket Layer). The issue here is that, using only SSL may have the device 81 store the license information Dlc as it is. This is not preferable in view of digital rights protection, because the license information Dlc becomes available for other devices if the device transfers it to those. Therefore, the device 81 may be preferably provided with an algorithm that encrypts the license information Dlc using the device identifier Idv stored in the device identifier storing section 811. If provided, the license information Dlc becomes available only for the device 81, successfully protecting digital rights.

Further, in the above, the user information DB 713 expediently carries only the device identifiers Idv. Alternatively, the user information DB 713 may carry user information (e.g., address, phone number) with which the licensee β can be uniquely identified. Or, such detailed user information may be used to encrypt the decryption key Kd. If so, the decryption key Kd may be protected by encryption to a greater degree, and thus the resulting license information management system Sc can protect digital rights in a more preferable manner.

Still further, in the above, the content data Dcnt is expediently music data. Thus, the device 81 is provided with the content reproduction section 819, and therein, the decrypted content data Dcnt is reproduced for audio output. As described above, however, the content data Dcnt may be any data as long as it can be used by the device 81, and represented by the content data Dcnt may be varied in type, e.g., television programs, movies, radio programs, books, printouts, game programs, application programs. Accordingly, the content reproduction section 819 is not limited to a constituent capable of sound output, but depending on the type of the content data Dcnt, may be a constituent capable of image outputs for television programs, movies, books, printouts, and games, or audio output for radio programs. Further, instead of such a content reproduction section 819, provided may be an interface, with which the decrypted content data Dcnt can be transferred to any outer devices, e.g., television receivers, radios, music players, e-book readers, game machines, PCs, personal digital assistants, cellular phones, external storage.

The issue here that, with such a-license information management system Sc in which the provider a distributes contents to the licensee β, the device 81 is fixedly assigned with the device identifier Idv. Such a one-to-one relationship takes away the possibility for the licensee β to use his or her rights information Drgt for the content data Dcnt with the device 81 located at somewhere else, e.g., in an accommodation having a contract with the same provider α. With the similar reasons, the licensee β cannot use the content data Dcnt with his or her rights information Drgt in his or her friend's house who have a contract with the same provider α. For betterment, provided is the following license information management system Sc1, which is a sixth modified example, to realize content distribution with better usability.

### SIXTH MODIFIED EXAMPLE

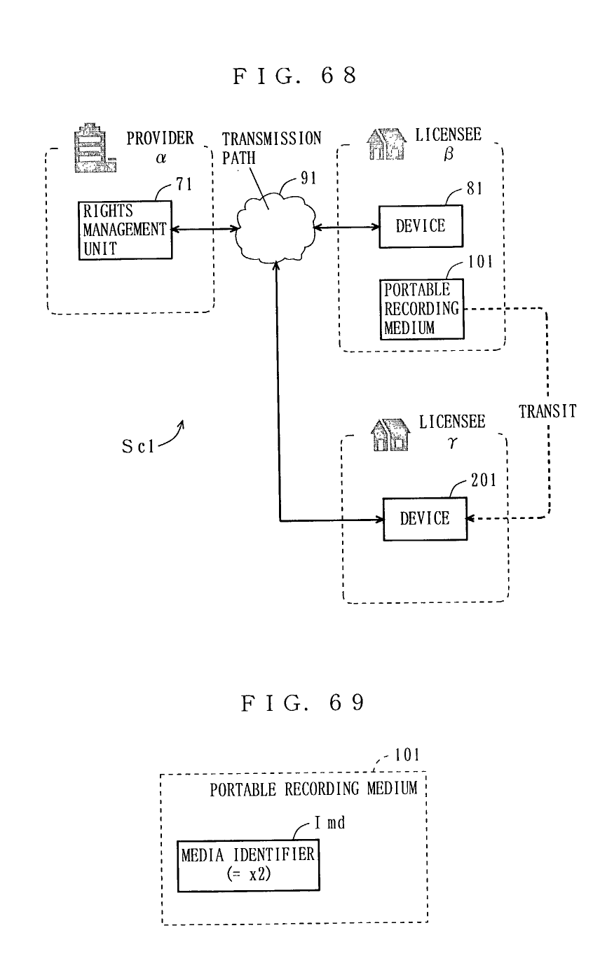

FIG. 68 is a block diagram showing the entire structure of a license information management system Sc1. In FIG. 68, compared with the license information management system Sc of FIG. 54, a portable recording medium 101, and a device 201 are further included. There is no other structural difference therebetween, and thus in FIG. 68, any constituent identical to that of FIG. 54 is provided with the same reference numeral, and not described again. That is, in the below, FIGS. 55 and 57 are referred to describe the rights management unit 71 and the device 81.

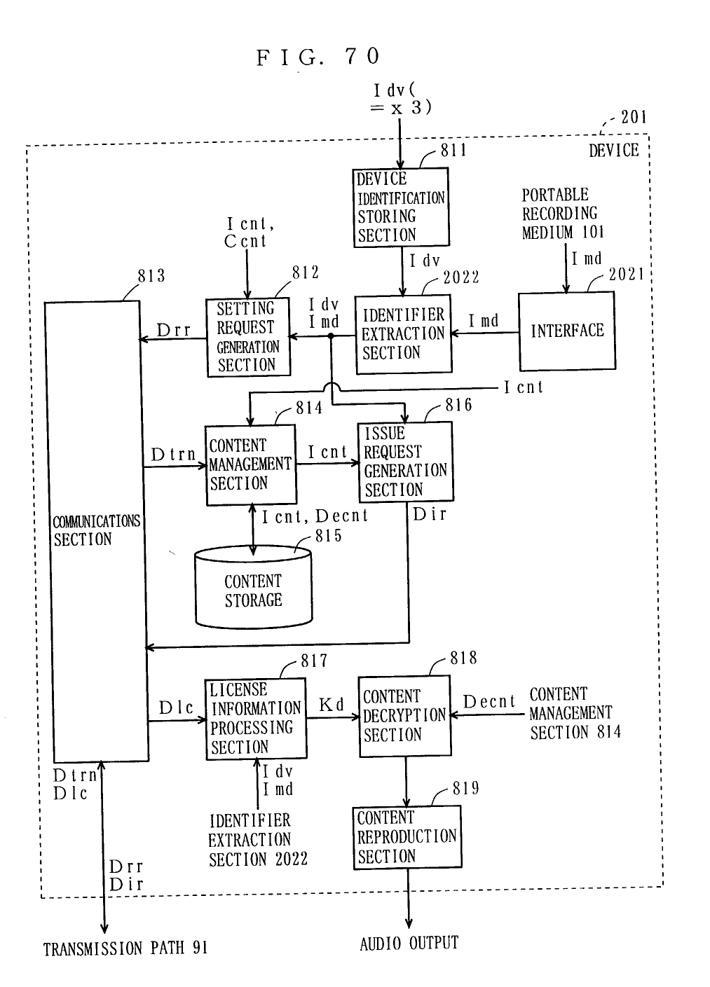

The portable recording medium 101 can be carried around by the licensee β, typified by SD cards™ and SmartMedia™. As shown in FIG. 69, the portable recording medium 101 stores in a predetermined recording region a media identifier Imd for its unique identification. Herein, as shown in FIG. 69, the media identifier Imd is expediently “x2”. Such a portable recording medium 101 is managed by the same licensee β as the aforementioned device 81.

The device 201 is placed on the side of a licensee γ, who is entitled to receive contents under contract with the provider α. The licensee γ presumably owns an accommodation where the device 201 is placed. The structure of the device 201 is now described in detail.

Here, FIG. 70 is a functional block diagram showing the detailed structure of the device 201 of FIG. 68. In FIG. 70, although being typically a consumer-electronics products as the device 81, the device 201 of the present modified example is presumably a music player. Under such a presumption, the device 201 is so structured as to be attachable/detachable the portable recording medium 101. Compared with the device 81 of FIG. 57, an interface 2021, and an identifier extraction section 2022 are further included. There is no other difference therebetween, and thus in the device 201 of FIG. 70, any constituent identical to the device 81 of FIG. 57 is provided with the same reference numeral, and not described in detail.

Described next is the setup in the license information management system Sc1, needed for the licensee β to receive contents from the provider α on the device 201 belonging to any other licensee, i.e., licensee γ, by using his or her rights information Drgt. For this setup, similarly to the preceding embodiments, constructed are the content database (hereinafter, content DB) 711, the decryption key database (decryption key DB) 712, and the user information database (user information DB) 713, all of which are shown in FIG. 55. Here, the content DB 711 and the decryption key DB 712 are the same as those described referring to FIGS. 59A and 59B, and this no description is given here.

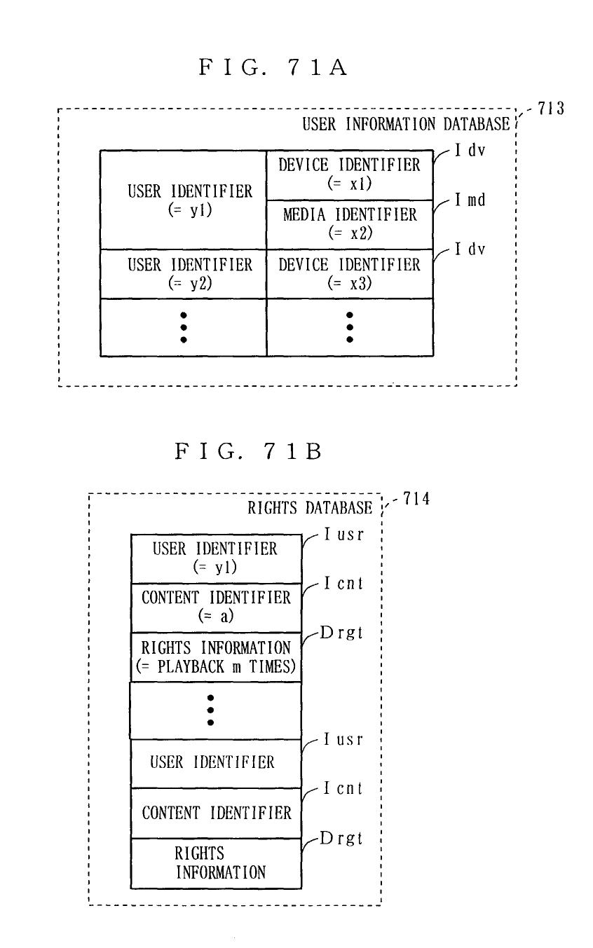

As to the user information DB 713, however, registered therein are different sets of information. Referring to FIG. 71A, the user information DB 713 of FIG. 55 is described in detail. As described above, the licensee β signs a contract with the provider α for content distribution. Based on thus signed contract, the provider α assigns a user identifier Iusr to the licensee β. The user identifier Iusr uniquely identifies the licensee β. Also, the provider α assigns the same device identifier Idv as above to the device 81 belonging to the licensee β. Here, as already described, the licensee β may notify the provider α of the device identifier Idv previously set to the device 81. The device identifier Idv uniquely identifies the device 81 of the licensee β in the license information management system Sc1. The provider α is also informed of the media identifier Imd recorded on the portable recording medium 101 of the licensee β. For the licensee β, such a set of the device identifier Idv and the media identifier Imd are registered in the user information DB 713 together with the user identifier Iusr. As such, as shown in FIG. 71A, the user information DB 713 plurally includes such a set.

As described above, the device identifier Idv thus assigned by the provider α is also registered into the device identifier storing section 811 in the device 81 of the licensee (see FIG. 57).

The licensee γ also signs a contract with the provider a for content distribution. For the sake of simplicity, unlike the licensee β, the licensee γ presumably does not have the portable recording medium 101. Based on thus signed contract, the provider α assigns a user identifier Iusr to the licensee γ for its unique identification. Also, the provider a assigns the device identifier Idv to the device 201 of the licensee r for its unique identification in the license information management system Sc1. For the licensee γ, such a set of the device identifier Idv and the user identifier Iusr are registered in the user information DB 713. As such, as shown in FIG. 71A, the user information DB 713 plurally includes such a device identifier Idv which is registered for every user identifier Iusr.

The device identifier Idv assigned by the provider a to the device 201 is set to the device identifier storing section 811 in the device 201 of the licensee γ side, as shown in FIG. 70.

For the sake of simplicity, as shown in FIG. 71A, the user information DB 713 presumably carries for the licensee β, corresponding to “y1” as the user identifier Iusr, “x1” as the device identifier Idv, and “x2” as the media identifier Imd. Under this presumption, as shown in FIG. 57, set to the device identifier storing section 811 on the device 81 side is “x1” as the device identifier Idv.

For the licensee γ, the user information DB 713 presumably carries, corresponding to “y2” as the user identifier Iusr, “x3” as the device identifier Idv. Under this presumption, as shown in FIG. 70, set to the device identifier storing section 811 on the device 201 side is “x3” as the device identifier Idv.

The rights database 714 of FIG. 71B will be described later.

After such a setup is completed, similar to the above, the device 81 becomes ready to acquire from the rights management unit 71 the content data Dcnt and the license information Dlc (see FIGS. 61, and 64 to 66). The characteristic of the present modified example is that, as shown in FIG. 68, the licensee β, brings the portable recording medium 101 to the licensee γ side, and then uses the licensee γ's device 201 to receive the content data Dcnt and the license information Dlc from the rights management unit 71.

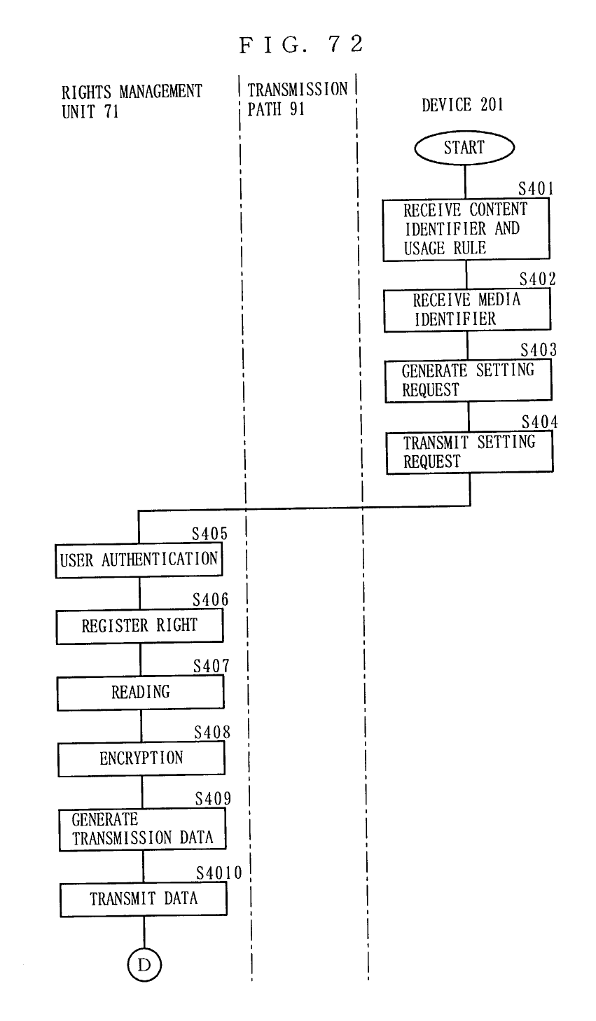

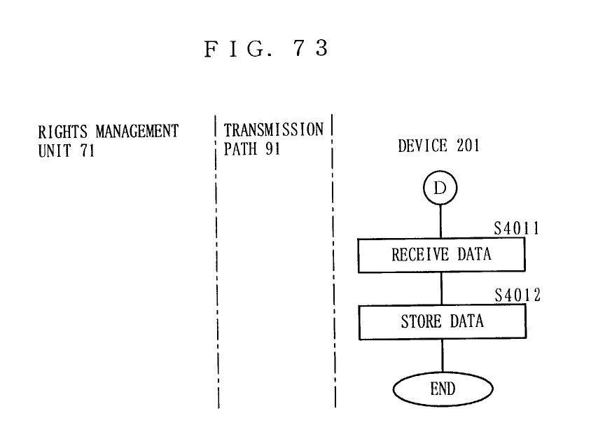

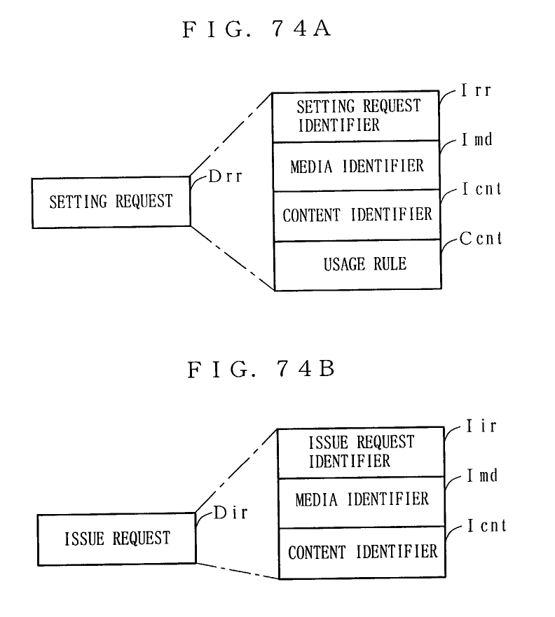

Referring to FIGS. 72 and 73, described next are the operations of the device 201 and the rights management unit 71 when the licensee β acquires the content data Dcnt using the device 201. The licensee β first attaches his or her portable recording medium 101 to the device 201 of the licensee γ. This connects the portable recording medium 101 to an identifier extraction section 2022 for data communications therebetween through an interface 2021 (see FIG. 70). Then, the licensee β accesses the rights management unit 71 through operation of the device 201. The licensee β then refers to the content DB 711 to see which content data Dcnt found therein he or she wants this time, and specifies the content identifier Icnt assigned thereto. In the below, thus specified content data Dcnt is referred to as acquiring content data Dcnt. The licensee β then designates a usage rule Ccnt for use of the acquiring content data Dcnt. The usage rule Ccnt is not described here because a detailed description is given in the above. Also in the present modified example, the usage rule Ccnt is expediently the playback frequency of the content data Dcnt.

As described above, the licensee β designates the content identifier Icnt and the usage rule Ccnt through operation of the device 201. The setting request generation section 812 (see FIG. 70) receives thus designated content identifier Icnt and the usage rule Ccnt (step S401).

Next, the setting request generation section 812 instructs the identifier extraction section 2022 to select either the device identifier Idv or the media identifier Imd, and return the result thereto. In the case that the portable recording medium 101 is attached to the device 201, the device 201 includes both the device identifier Idv stored in the device identifier storing section 811 and the media identifier Imd stored in the portable recording medium 101. Therefore, in response to the instruction of the setting request generation section 812, if the portable recording medium 101 is attached, the identifier extraction section 2022 retrieves the media identifier Imd stored in the portable recording medium 101 through the interface 2021. Thus retrieved media identifier Imd is provided to the setting request generation section 812 (step S402).

Here, if the portable recording medium 101 is not attached to the device 202, the identifier extraction section 2022 retrieves the device identifier Idv from the device identifier storing section 811, and forwards it to the setting request generation section 812. If this is the case, the licensee γ is the one who acquires the content data Dcnt using the device 201. Such a case has no relevancy to the object of the present modified example, and the operation of the device 201 when the identifier extraction section 2022 extracts the device identifier Idv is evident from the above. Therefore no description is given below.

Then, to the media identifier Imd, the content identifier Icnt, and the usage rule Ccnt, the setting request generation section 812 adds a previously-held setting request identifier Irr. As such, the setting request Drr (see FIG. 74A) is generated (step S403). The setting request Drr is information for requesting the rights management unit 11 for a right to use the content data Dcnt. In this embodiment, the setting request Drr is also used to request the rights management unit 71 to distribute the acquiring content data Dcnt. Also, the setting request identifier Irr is used by the rights management unit 71 to identify the setting request Drr. The setting request generation section 812 forwards such a setting request Drr to the communications section 813, from which the setting request Drr is transmitted to the rights management unit 71 over the transmission path 91 (step S404).

In the rights management unit 71 (see FIG. 55), the communications section 715 receives the setting request Drr coming over the transmission path 91, and forwards it to the user authentication section 716. In response, the user authentication section 716 applies a user authentication process to the setting request Drr (step S405). More specifically, the user authentication section 716 refers to the aforementioned user information DB 713 (see FIG. 71A) under its management to see if including the media identifier Imd same as that in the setting request Drr. Only when including, the user authentication section 716 authenticates the current setting request Drr as being the one provided from the licensee β. The user authentication section 716 then retrieves from the user information DB 713 the user identifier Iusr corresponding to the media identifier Imd, and forwards it to the rights management section 717 together with the setting request Drr.

The rights management section 717 (see FIG. 55) manages the rights database (hereinafter, rights DB) 714. Because of the setting request identifier Irr therein, the rights management section 717 acknowledges as having received the setting request Drr from the user authentication section 716. As acknowledged as such, the rights management section 717 goes through a right registration process with respect to the rights DB 714 (step S406). More specifically, the rights management section 717 extracts from the setting request Drr the content identifier Icnt, and the usage rule Ccnt, and registers the resulting set to the rights DB 714 together with the user identifier Iusr. Here, the rights management section 717 regards the licensee β as requesting for the right to use the acquiring content data Dcnt because of the usage rule Ccnt set to the setting request Drr. Thus, from the rights management section 717, the usage rule Ccnt indicates the right for the licensee β to use the acquiring content data Dcnt. In this sense, the rights management section 717 handles the usage rule Ccnt extracted from the setting request Drr as rights information Drgt. As shown in FIG. 71B, the rights DB 714 plurally includes the user identifiers Iusr, the content identifier Icnt, and the rights information Drgt. The rights DB 714 thus enables the rights management section 717 to manage the right to the acquiring content data Dcnt on the licensee β basis. After completing the usage rule registration process, the rights management section 717 forwards the setting request Drr to the content management section 718.

Here, the rights information Drgt to be registered in such a rights DB 714 is described more specifically. As described above, the usage rule Ccnt in the present embodiment is the playback frequency. Assuming now that set to the current setting request Drr is “x1” as the media identifier Imb, “a” as the content identifier Icnt, and “playback m times” (where m is a natural number) as the usage rule Ccnt. Under such an assumption, in the user authentication process of step S405, the user authentication section 716 retrieves from the user information DB 713 “y1” as the user identifier Iusr, and forwards it to the rights management section 717. Accordingly, in step S406, as shown in FIG. 71B, set to a piece of usage rule information Dcrt are “y1” as the user identifier Iusr, “a” as the content identifier Icnt, and “playback m times” as the rights information Drgt.

Here, although irrelevant to the technical characteristics of the present license information management system Sc1, in step S406, the rights management section 717 may charge the licensee β to whom the user identifier Iusr is assigned every time rights information Drgt is registered.

After receiving the setting request Drr, the content management section 718 goes through a process for reading the content data Dcnt similarly to step S204 of FIG. 61 (step S407). Then, the content encryption section 719 goes through an encryption process similar to step S205 (step S408). The transmission data generation section 720 then goes through a transmission data generation process similarly to step S206 (step S409). As a result, similar to step S206, the transmission data Dtrn (see FIG. 62B) is transmitted to the device 201 over the transmission path 91 (step S4010).

In the device 201 (see FIG. 70), the communications section 813 goes through the same reception process as step S208 of FIG. 61 (FIG. 73; step S4011). The content management section 814 goes through the same storage process as step S209 (step S4012). As a result, as described referring to FIG. 63, the content storage 815 plurally stores a set of the content identifier Icnt, and the encrypted content data Decnt.

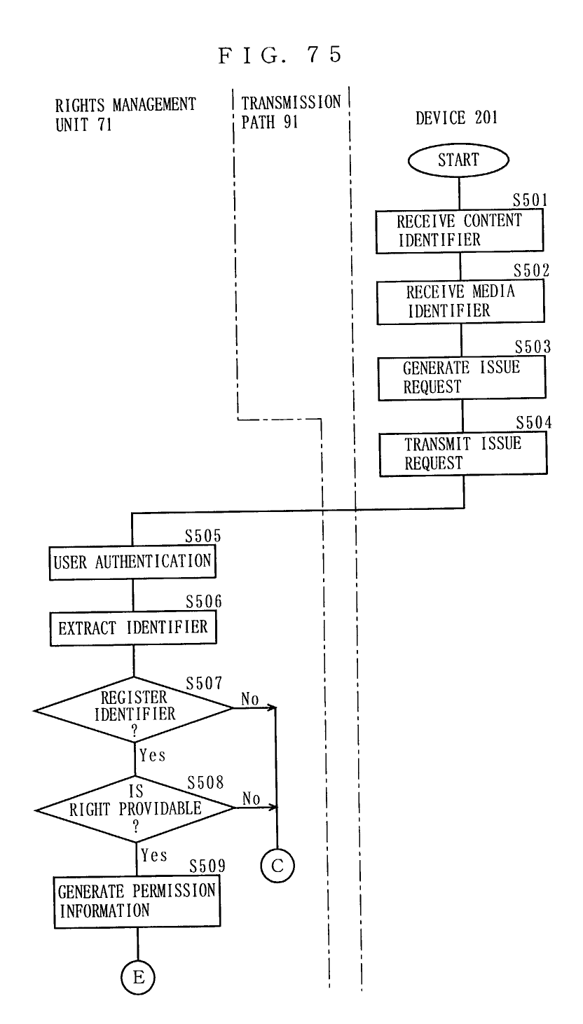

Similar to the preceding embodiments, distributed to the device 201 is the encrypted content data Dcnt. For the use of the content data Dcnt, the device 201 thus needs to decrypt the encrypted content data Dcnt using the decryption key Kd provided by the rights management unit 71. In the present license information management system Sc1, the license information Dlc (described later) to provide such a decryption key to the device 201 being operated by the licensee β. Referring to FIGS. 75 to 77, described next are the operations of the device 201 and the rights management unit 71 at the time of acquisition of the license information Dlc, and decryption of the content data Dcnt.

The licensee β first accesses the content storage 815 through operation of the device 201 to specify which encrypted content data Decnt he or she wants to use. In the below, thus specified encrypted content data Decnt is referred to as decrypting content data Decnt.

The content management section 814 (see FIG. 70) manages the content storage 815, and retrieves therefrom, the content identifier Icnt attached to the decrypting content data Decnt designated by the licensee β. Thus extracted content identifier Icnt is provided to the issue request generation section 816 (step S501).

Next, the issue request generation section 816 instructs the identifier extraction section 2022 to select either the device identifier Idv or the media identifier Imd, and return the result thereto. In response to the instruction of the issue request generation section 816, if the portable recording medium 101 is attached, the identifier extraction section 2022 extracts the media identifier Imd stored in the portable recording medium 101 through the interface 2021. Thus extracted media identifier Imd is provided to the setting request generation section 816 (step S502).

Here, if the portable recording medium 101 is not attached to the device 201, the identifier extraction section 2022 retrieves the device identifier Idv from the device identifier storing section 811, and forwards it to the setting request generation section 812. If this is the case, the licensee T is the one who acquires the content data Dcnt using the device 201. Such a case has no relevancy to the object of the present modified example, and the operation of the device 201 when the identifier extraction section 2022 extracts the device identifier Idv is evident from the above. Therefore no description is given below.

Then, to the media identifier Imd and the content identifier Icnt, the issue request generation section 816 adds the previously-held setting request identifier Irr. As such, the issue request Dir (see FIG. 74B) is generated (step S503). The issue request Dir is information requesting the rights management unit 71 to release the license information Dlc. The issue request identifier Iir is used by the rights management unit 71 to identify the issue request Dir. The issue request generation section 816 forwards such a setting request Dir to the communications section 813, from which the setting request Dir is transmitted to the rights management unit 71 over the transmission path 91 (step S504).

In the rights management unit 71 (see FIG. 55), the communications section 715 receives the issue request Dir coming over the transmission path 91, and forwards it to the user authentication section 716. In response to the issue request Dir, the user authentication section 716 applies a user authentication process to the issue request Dir (step S505). More specifically, the user authentication section 716 refers to the aforementioned user information DB 713 (see FIG. 71A) to see if including the media identifier Imd same as that in the issue request Dir. Only when including, the user authentication section 716 authenticates the current issue request Dir as being the one provided from the licensee β. The user authentication section 716 then retrieves from the user information DB 713 the user identifier Iusr corresponding to the media identifier Imd, and forwards it to the rights management section 717 together with the issue request Dir.

Because of the issue request identifier Iir in the issue request Dir, the rights management section 717 acknowledges as having received the issue request Dir from the user authentication section 716. As acknowledged as such, the rights management section 717 extracts from the issue request Dir the content identifier Icnt (step S506). Then, the rights management section 717 refers to the rights DB 714 (see FIG. 71B) if including the set of the received user identifier Iusr and the extracted content identifier Icnt (step S507).

If determined “Yes” in step S507, the rights management section 717 refers to the rights information Drgt included in the same set to determine whether the device 201 being operated by the licensee β is qualified for permission (step S508). If “Yes”, the rights management section 717 extracts partially or entirely the rights information Drgt (step S509). To avoid confusion, the resulting rights information Drgt extracted in step S306 is referred to as permission information Dlw in the respect that the information is used to make the content data Dcnt available for the device 201 of the licensee β identified by the current issue request Dir. That is, generated in step S509 is the permission information Dlw.

Here, generating the permission information Dlw requires partially or entirely the rights information Drgt registered for the licensee β, so that the rights management section 717 updates the rights information Drgt partially or entirely extracted in step S509 (FIG. 75; step S5010).

Here, steps S506 to S5010 are specifically exemplified. As shown in FIG. 71B, the rights DB 714 presumably carries, as a set, “y1” as the user identifier Iusr, “a” as the content identifier Icnt, and “playback m times” as the rights information Drgt. Also, it is presumed that the device 201 transmits the issue request Dir which includes “x2” as the media identifier Imd, “a” as the content identifier Icnt.

Under this assumption, in step S506, the rights management section 717 receives “y1” as the user identifier Iusr, and extracts from the issue request Dir “a” as the content identifier Icnt. In step S507, it is determined that the rights DB 714 is carrying the set of “y1” and “a”. As a result, because the rights information Drgt in the same set indicates “playback m times”, in step S508, it will be determined that the device 201 currently operated by the licensee β is qualified for permission. Then in step S509, generated is the permission information Dlw, exemplified by “playback n times”. Here, n is a natural number not exceeding the aforementioned m, and more preferably, is set according to the throughput of the device 81. As an example, if the hardware of the device 81 is relatively low in capability, n may be set to the smallest value. e.g., “1”, allowed for the device 81 to use the decrypting content data Decnt.

After steps S506 to S509, the portable recording medium 101 (media identifier Imd “x2”) attached to the device 201 may exercise the right for reproducing the content data Dcnt (content identifier Icnt “a”) form times. Thus, in step S5010, the rights information Drgt of the licensee β is updated from “playback m times” to “playback (m−n) times”.

Such rights information Dlw is forwarded from the rights management section 717 (see FIG. 55) to the license information generation section 721 together with the issue request Dir. More specifically, as shown in FIG. 56, in the license information generation section 721, the hash value generation section 7211 receives only the permission information Dlw, while the license information assembly section 7212 receives both the permission information Dlw and the issue request Dir.

First, the hash value generation section 7211 generates a hash value Vhs in a similar manner to step S308 of FIG. 64 (step S5011), and forwards the resulting hash value Vhs to the license information assembly section 7212. The license information assembly section 7212 forwards the received issue request Dir to the decryption key management section 722 (see FIG. 55), in which the aforementioned decryption key DB 712 (see FIG. 59B) is managed. From the received issue request Dir, the content identifier Icnt and the media identifier Imd are extracted. The decryption key management section 722 then retrieves the decryption key Kd in the same set as the content identifier Icnt from the decryption key DB 712, and forwards it to the decryption key encryption section 723 together with the media identifier Imd. The decryption key encryption section 723 encrypts the received decryption key Kd using the media identifier Imd accompanied therewith (step S5012), so that the encrypted decryption key Ked is generated. The resulting encrypted decryption key Ked is forwarded to the license information assembly section 7212.

After receiving all the issue request Dir, the permission information Dlw, the hash value Vhs, and the encrypted decryption key Ked, the license information assembly section 7212 starts generating such license information Dlc as shown in FIG. 67B in a similar manner to step S3010 of FIG. 65 (step S5013). The license information Dlc is forwarded to the device 201 through the communications section 715 and the transmission path 91 (step S5014).

In the device 201 (see FIG. 70), the communications section 813 receives the license information Dlc coming over the transmission path 91 in a similar manner to step S3012 (step S5015), and then forwards it to the license information processing section 817.

The license information processing section 817 includes, as shown in FIG. 58, the tampering determination section 8171, the hash value generation section 8172, the permission determination section 8173, and the decryption key decryption section 8174. The license information Dlc from the communications section 813 is forwarded to the tampering determination section 8171, in which the permission information Dlw is extracted from the license information Dlc as in step S3013 (step S5016). Also, the hash value Vhs is extracted as the external hash value Vehs (step S5016). Thus extracted permission information Dlw is forwarded to the hash value generation section 8172, while the hash value Vehs is retained as it is.

The hash value generation section 8172 generates an internal hash value Vlhs as in step S3014 (step S5017), and returns it to the tampering determination section 8171.

In response to the internal hash value Vlhs, the tampering determination section 8171 determines whether the permission information Dlw has been tampered or not in a similar manner to step S3015 (step S5018). If determined “Yes”, the license information Dlc is forwarded to the permission determination section 8173.

The permission determination section 8173 refers to the received license information Dlc to determine whether or not the decrypting content data Decnt is allowed for use as in step S3016 (step S5019). Only when determined “Yes” in step S5019, the permission determination section 8173 extracts from the license information Dlc the encrypted decryption key Ked, which is then forwarded to the decryption key decryption section 8174.

More in detail, in step S5019, as assumed above, the permission information Dlw in the license information Dlc approves playback of the content data Dcnt for n times. In this case, if the playback frequency assigned to the permission information Dlw in step S5019 is 1 or larger, the permission determination section 8173 determines that the decrypting content data Decnt is available. Thus from license information Dlc, the encrypted decryption key Ked is extracted, and forwarded to the decryption key decryption section 8174.

The decryption key decryption section 8174 receives the encrypted decryption key Ked from the permission determination section 8173. Then, the decryption key decryption section 8174 instructs the identifier extraction section 2022 to select either the device identifier Idv or the media identifier Imd, and return the result thereto. In response to the instruction of the decryption key decryption section 8174, if the portable recording medium 101 is attached, the identifier extraction section 2022 extracts the media identifier Imd stored in the portable recording medium 101 through the interface 2021. Thus extracted media identifier Imd is provided to the decryption key decryption section 8174.

Here, if the portable recording medium 101 is not attached to the device 201, the identifier extraction section 2022 retrieves the device identifier Idv from the device identifier storing section 811, and forwards it to the decryption key decryption section 8174. If this is the case, there is no relevancy to the object of the present modified example, and the operation of the device 201 when the identifier extraction section 2022 extracts the device identifier Idv is similar to the above. Therefore no description is given below.

After receiving the media identifier Imd as such, the decryption key decryption section 8174 decrypts the encrypted decryption key Kd using the media identifier Imd (FIG. 77; step S5020). The decryption key Kd is forwarded to the content decryption section 818.

Here, the content management section 814 extracts in step S5010 not only the content identifier Icnt but the aforementioned decrypting content data Decnt. Thus extracted decrypting content data Decnt is forwarded to the content decryption section 818. The content decryption section 818 then decrypts the decrypting content data Dcnt using the decryption key Kd received from the decryption key decryption section 8174 (step S5021), and the resulting content data Decnt is forwarded to the content reproduction section 819. The content data Dcnt is then reproduced for audio output (step S5022). In this manner, the licensee β can listen to the music represented by the content data Dcnt purchased from the provider a. As such, with the present license information management system Sc1, the licensee β can use the content data Dcnt with his or her own rights information Drgt in the device 201 under another licensee γ's management. Accordingly, the license information management system Sc1 becomes more user-friendly.

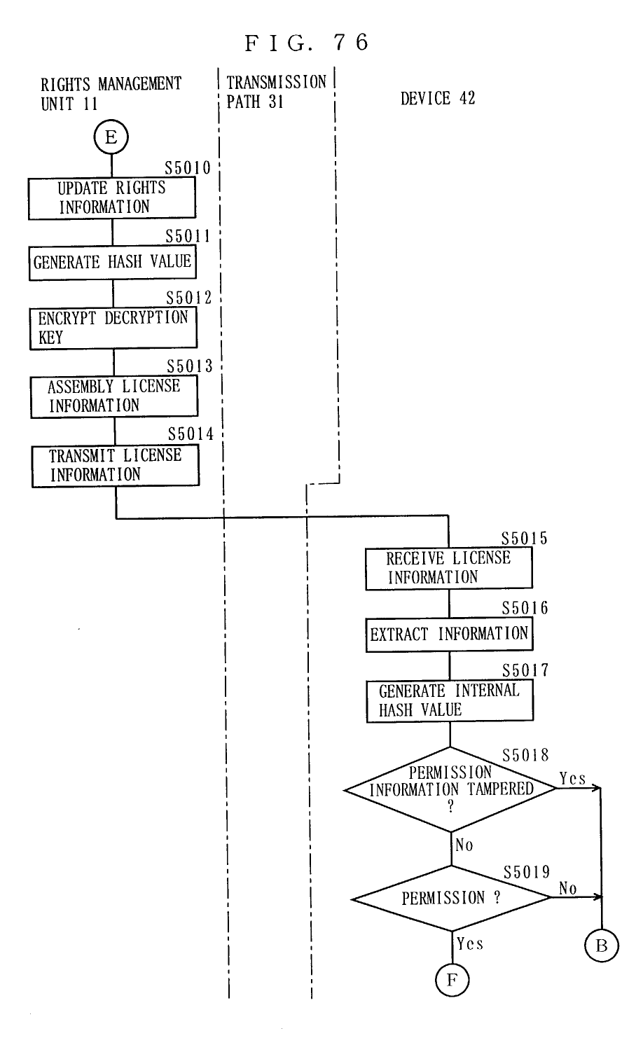

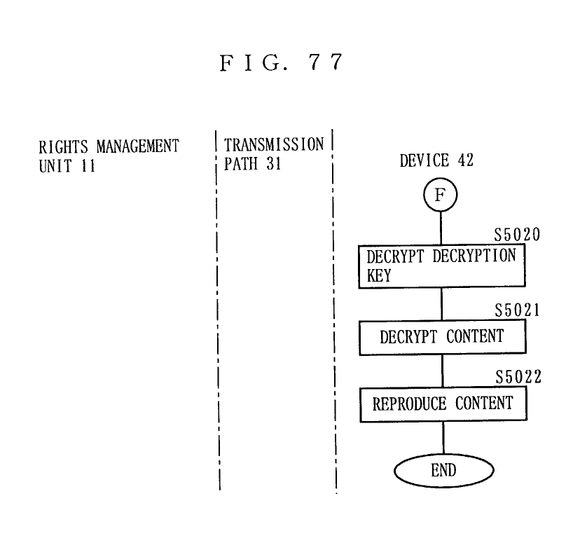

Here, instep S5018 of FIG. 76, there may be a case where the tampering determination section 8171 determines that the permission information Dlw has been tampered. Also, in step S5019, there may be a case where the permission determination section 8173 determines that the decrypting content data Decnt is not allowed for use. In these cases, the tampering determination section 8171 and the permission determination section 8173 execute step S3020 of FIG. 66, and discard the license information Dlc.

In step S507 of FIG. 75, the rights management section 717 may determine that the rights DB 714 (see FIG. 71B) does not carry the set of the device identifier Idv and the content identifier Icnt. In step S508, the rights management section 717 may determine that the device 201 being operated by the licensee β is not qualified for permission. If so, the rights management section 717 executes step S3021 of FIG. 66, and generates rejection information Drj for transmission to the communications section 715. The rejection information Drj is then transmitted from the communications section 715 to the device 201 over the transmission path 91. In this manner, similarly to the preceding embodiments, the decrypting content data Decnt is not decrypted by the device 201.

In step S507, if determining that the rights DB 714 (see FIG. 71B) carries no set of the user identifier Iusr and the content identifier Icnt, the rights management section 717 may generate the user identifier Iusr, the content identifier Icnt, and the rights information Drgt for registration into the rights DB 714.

In the present modified example, placed on the licensee side is the aforementioned device 81. This is not restrictive, and the device 201 will do.

Further, in the above, the device 201 is provided with the device identifier storing section 811. However, the device identifier storing section 811 is not necessarily included in the device 201 if the licensee γ himself or herself does not receive the content data Dcnt and the license information Dlc from the rights management unit 71.

Similar to the preceding embodiments, the processes of FIGS. 72, 73, and 75 to 77 are not necessarily executed by one rights management unit. Also, the license information Dlc may be acquired first, and then acquisition of the content data Dcnt may follow, or the acquisition processes may be carried out at the same time.

Further, in the above, the user information DB 713 expediently carries the user identifiers Iusr, the device identifiers Idv and/or the media identifiers Imd. Alternatively, the user information DB 713 may carry user information (e.g., address, phone number) with which the licensee β can be uniquely identified.

Still further, in the above, the content reproduction section 819 of the device 201 may be replaced, as in the preceding embodiments, with a constituent capable of image output for television programs, movies, books, printouts, and games, or audio output for radio programs. Further, instead of such a content reproduction section 819, the device 201 may be provided with an interface, with which the decrypted content data Dcnt can be transferred to any outer devices, e.g., television receivers, radios, music players, e-book readers, game machines, PCs, personal digital assistants, cellular phones, external storage.

In the present modified example, the license information Dlc may include the not-encrypted decryption key Kd as it is under the condition that a technology such as SSL is applied. For digital rights protection, the device 201 is preferably provided with an algorithm that encrypts the license information Dlc using the media identifier Imd stored in the portable recording medium 101.

Still further, the interface 2021 and the identifier extraction section 2022 of the sixth modified example may be incorporated into the device 51 of the second embodiment. If the device 51a or 51b is provided with both of those, the identifier extraction section 2022 generates the setting request Drr, as is instructed by the user, using any one of the device identifiers Idva and Idvb assigned to the devices 51a and 51b, respectively, and the media identifier Imd stored in the portable recording medium 101. The resulting setting request Drr is forwarded to the rights management unit 41. Therefore, the content data Dcnt becomes available for the user using any one of the devices 51a and 51b, and the portable recording medium 101, leading to the license information management system Sb with better usability.

While the invention has been described in detail, the foregoing description is in all aspects illustrative and not restrictive. It is understood that numerous other modifications and variations can be devised without departing from the scope of the invention.

What is claimed is:

1. A unit for managing rights information representing a right for a plurality of devices to use content data, the unit comprising:
a rights database (hereinafter, rights DB) including the rights information each assigned to the plurality of devices;
a rights management section operable to generate, in response to an issue request from any one of the plurality of devices, permission information which represents a permission for the device to use the content data, by using the rights information corresponding to the device in the rights DB;
a license information generation section operable to generate license information which at least includes the permission information generated by the rights management section; and
a communications section operable to transmit the license information generated by the license information generation section to the device from which the issue request is forwarded.

2. The rights management unit according to claim 1, wherein
the issue request forwarded from any one of the plurality of devices at least includes a usage rule of the content data, and
the rights management section at least registers in the rights DB, in response to the issue request from the device, the rights information corresponding to the device from which the issue request is forwarded.

3. The rights management unit according to claim 2, wherein
the plurality of devices are in a predetermined group, and
the rights management section registers in the rights DB the rights information shared by the plurality of devices in the group in response to a setting request forwarded from any one of the plurality of devices.

4. The rights management unit according to claim 2, further comprising a content database (hereinafter, content DB) operable to store distributing content data, wherein
the setting request forwarded from the device identifies acquiring content data,
the rights management unit further comprises:
a content management section operable to read the acquiring content data from the content DB in response to the setting request forwarded from the device;
a content encryption section operable to encrypt the content data read by the content management section; and
a transmission data generation section operable to generate transmission data including the content data encrypted by the content encryption section, and
the communications section further transmits the data generated by the transmission data generation section to the device from which the setting request is forwarded.

5. The rights management unit according to claim 1, further comprising a decryption key database (hereinafter, decryption key DB) including a decryption key for decrypting the content data encrypted by the content encryption section, wherein
the license information generation section generates the license information further including the decryption key in the decryption key DB.

6. The rights management unit according to claim 5, further comprising a decryption key encryption section operable to encrypt the decryption key in the decryption key DB using information relating to the device from which the issue request is forwarded, wherein
the license information generation section generates the license information further including the decryption key encrypted by the decryption key encryption section.

7. The rights management unit according to claim 1, wherein the license information generation section comprises:
a hash value generation section operable to generate, based on the permission information generated by the rights management section, a hash value which is a measure against tampering of the license information; and
a license information assembly section operable to assemble the license information by adding the hash value generated by the hash value generation section to the permission information generated by the rights management section.

8. The rights management unit according to claim 1, wherein
the rights management section generates rejection information when unable to generate the permission information with respect to the device from which the issue request is forwarded, and
the communications section further transmits the rejection information generated by the rights management section to the device from which the issue request is forwarded.

9. The rights management unit according to claim 1, further comprising:
a user information database (hereinafter, user information DB) including device identifiers which uniquely identify the plurality of devices, respectively, in a predetermined group; and
a user information management section operable to register in the user information DB, in response to a registration request from a device whose device identifier is not yet registered in the user information DB, the device identifier included in the received registration request.

10. The rights management unit according to claim 9, wherein
when the number of the device identifiers registered in the group is a predetermined maximum value or larger, the user information management section responds to the registration request, and generates a registration rejection notice to reject registration into the user information DB, and
the communications section further transmits the registration rejection notice generated by the user information management section to the device from which the registration request is forwarded.

11. The rights management unit according to claim 1, further comprising a user information database (hereinafter, user information DB) including device identifiers which uniquely identify the plurality of devices, respectively, in a predetermined group, wherein
any one of the plurality of devices registered in the user information DB transmits a provisional registration request in which the device identifier of its own is at least included as a registering identifier,
the rights management unit further comprises a user information management section operable to provisionally register the registering identifier included in the received provisional registration request into the user information DB, wherein
a device which is not yet registered in the user information DB transmits an actual registration request which at least includes the registering identifier, and a registered identifier as the device identifier of the device from which the provisional registration request is forwarded, and
the user information management section actually registers, based on the registering identifier and the registered identifier included in the received actual registration request, the registering identifier which is provisionally registered in the user information DB.

12. The rights management unit according to claim 1, further comprising a user information database (hereinafter, user information DB) including device identifiers which uniquely identify the plurality of devices, respectively, in a predetermined group, wherein
any one of the plurality of devices which is not yet registered in the user information DB includes the device identifier of its own as a registering identifier, and also transmits a password request including the registered device identifier,
the rights management unit further comprises a user information management section in which the registering identifier included in the received password request is provisionally registered in the user information DB, and a password is issued for the device which is not yet registered,
the device which is not yet registered in the user information DB transmits a registration request including the registering identifier, and the password issued by the user information management section, and
the user information management section actually registers the registering identifier which is provisionally registered in the user information DB based on the password and the registering identifier included in the received registration request.

13. The rights management unit according to claim 1, further comprising a user information database (hereinafter, user information DB) including device identifiers which uniquely identify the plurality of devices, respectively, in a predetermined group, wherein
any one of the plurality of devices which is not yet registered in the user information DB transmits a first registration request which at least includes the device identifier of its own as a registering identifier to the device which is registered in the user information DB,
the device which is registered in the user information DB includes the device identifier of its own as a registered identifier, and also transmits a second registration request including the registering identifier included in the received first registration request, and
the rights management unit further comprises a user information management section operable to register the registering identifier included in the received second registration request in the user information DB.

14. The rights management unit according to claim 1, wherein
the rights DB includes the rights information, and the device identifier of the device which is permitted to exercise the rights information, and
the rights management unit further comprises:
a user information database (hereinafter, user information DB) including device identifiers which uniquely identify the plurality of devices, respectively, in a predetermined group; and
in response to a deletion request from any one of the plurality of devices, a device identifier deletion section operable to delete the corresponding device identifier from the user information DB and the rights DB.

15. The rights management unit according to claim 2, wherein
the plurality of devices are in a predetermined group, and
the rights management section
registers, in response to the setting request from a first device in the group, rights information of the first device to the rights DB, and
registers, in response to the setting request from a second device in the group, the second device in the rights DB in a manner to make the rights information of the first device sharable.

16. A device which receives license information from a rights management unit connected thereto over a transmission path, the device comprising:
an interface operable to connect a portable recording medium for data communications, which stores a media identifier for unique identification;
an identifier extraction section operable to extract the media identifier from the portable recording medium connected to the interface;
an issue request generation section operable to generate, using the media identifier received from the identifier extraction section, an issue request needed to receive a permission to use content data; and
a first communications section operable to transmit the issue request received from the issue request generation section to the rights management unit over the transmission path,
the rights management unit
managing rights information of the content data provided to the portable recording medium, and
in response to the issue request provided from the device, generating and transmitting the license information to control the use of the content data in the device to which the portable recording medium is connected, and
the device further comprising a license information processing section operable to process the license information from the rights management unit, and control the use of the content data.

17. The device according to claim 16, wherein the rights management unit includes a rights management section operable to generate permission information, of a minimum level, to make the content data available for the device.

18. The device according to claim 17, wherein
the rights management unit includes:
a first hash value generation section operable to generate a first hash value based on the permission information generated by the rights management section to generate the license information; and
a license information assembly section operable to assemble the license information by adding the first hash value received from the first hash value generation section to the permission information received from the rights management section.

19. The device according to claim 18, wherein
the license information processing section includes:
a second hash value generation section operable to generate a second hash value based on the permission information included in the received license information; and
a tampering determination section operable to determine whether or not the permission information included in the license information received from the first communications section based on the first hash value in the license information and the second hash value received from the second hash value generation section is tampered.

20. The device according to claim 18, wherein
the content data is encrypted by the device using a predetermined encryption key before distribution,
the license information assembly section extracts the media identifier from the issue request received from the rights management section,
the rights management unit further includes:
a decryption key management section operable to manage a decryption key which can decrypt the content data encrypted by the encryption key; and
a decryption key encryption section operable to encrypt the decryption key managed by the decryption key management section using the media identifier extracted by the license information assembly section, and
the license information assembly section also adds the encrypted decryption key received from the decryption key decryption section to the permission information received from the rights management section to assemble the license information.

21. The device according to claim 20, wherein
the license information processing section further includes a decryption key decryption section operable to decrypt the encrypted decryption key included in the license information received from the first communications section.

22. The device according to claim 16, further comprising a device identifier storing section operable to store the device identifier assigned thereto, wherein
the identifier extraction section determines, depending on a user's operation, whether to extract the media identifier from the portable recording medium connected to the interface, or to extract the device identifier from the device identifier storing section.
